(19) United States
(12) Patent Application Publication
(10) Pub. No.: US 2025/0382844 A1
(43) Pub. Date: Dec. 18, 2025

(54) MULTI-POSITION LADDER AND PORTIONS THEREOF

(71) Applicant: Werner Co., Itasca, IL (US)

(72) Inventors: Fang Chen, Tennyson (AU); Slavisa Dacic, Hanover Park, IL (US); John H. Maher, Crystal Lake, IL (US); Juan Carlos Perez, Huntersville, NC (US); Jeffree M. Pons, Biñan Laguna (PH); David Pozgay, Wilmette, IL (US); Lucindo Sofronio DL. Valenciano, Barangay Kasilawan Makati City (PH)

(21) Appl. No.: 19/241,035

(22) Filed: Jun. 17, 2025

Related U.S. Application Data
(60) Provisional application No. 63/661,443, filed on Jun. 18, 2024.
(60) Provisional application No. 63/761,713, filed on Feb. 21, 2025.

(51) Int. Cl. E06C 1/32; E06C 7/02; E06C 7/08; E06C 7/42; E06C 7/50

(52) U.S. Cl. CPC E06C 1/32; E06C 7/02; E06C 7/08; E06C 7/42; E06C 7/50

(57) ABSTRACT

Components for multi-position ladders are provided. A ladder includes an outer ladder section with a first outer rail and a second outer rail, and an inner ladder section with a first inner rail and a second inner rail, the first inner rail extending within the first outer rail and the second inner rail extending within the second outer rail such that the outer ladder section and the inner ladder section are slidable relative to one another to change a position between the inner section and the outer section between a maximum contracted position and a maximum extended position. The ladder further includes a stop positioned on the first outer rail or the first inner rail, the stop positioned to stop relative movement of the inner ladder section and outer ladder section beyond the maximum contracted position. Braces for outer rails of a ladder are further provided.

### RELATED APPLICATIONS

This application claims the benefit of U.S. Provisional Application No. 63/761,713, filed Feb. 21, 2025, and U.S. Provisional Application No. 63/661,443, filed Jun. 18, 2024, the entire contents of each which are incorporated herein by reference.

### TECHNICAL FIELD

This disclosure relates to multi-position ladders, and, in particular, to components or accessories for multi-position ladders.

### BACKGROUND

Multi-position ladders are ladders that may be placed in multiple configurations to accommodate a variety of tasks and uses. These ladders typically comprise several sections that can be adjusted and locked into various configurations. For instance, multi-position ladders may have sections that are rotatable relative to one another, so that the ladder can be moved into positions such as a folded or leaning position, a stepladder or A-line position, or a straight (180°) position. Additionally, certain multi-position ladders are equipped with telescoping sections that slide to extend or reduce the ladder's overall height, offering customizable reach for various tasks. A multi-position ladder may also incorporate various accessories or components to improve stability and/or usability of the multi-position ladder. Indeed, some of these features may include accessories or components that are attached to or integrated within a multi-position ladder to assist or help the user by customizing the ladder for a particular task or location.

Designing multi-position ladders for a wide range of purposes and arrangements introduces several design challenges, especially regarding stability and ease of use. For instance, the hinge mechanism needs to be strong enough to sustain the ladder in all its various positions, including when the ladder is in a straight or fully extended configuration. The rungs must be designed to provide secure footing in different ladder positions. The ladder's feet also contribute to the stability of the ladder and must have a durable construction to provide stable support across different surfaces and conditions. Furthermore, the sliding and locking mechanisms need to be user-friendly, permitting easy adjustment and secure positioning of the ladder without compromising safety or sturdiness. Moreover, ensuring the components are both durable and cost-effective to manufacture presents a significant design challenge.

### BRIEF DESCRIPTION OF THE DRAWINGS

FIG. 1 is a front-side perspective view of a ladder according to various embodiments.

FIG. 2 is a rear-side perspective view of the ladder of FIG. 1.

FIG. 3A is a front-side perspective view of the ladder of FIG. 1 in a straight position of the ladder.

FIG. 3B is a front-side perspective view of the ladder of FIG. 1 in an extended straight position of the ladder.

FIG. 3C is a rear-side perspective view of the ladder of FIG. 1 in a folded or leaning position of the ladder.

FIG. 3D is a right-side elevation view of the ladder of FIG. 1 in the folded or leaning position of the ladder.

FIG. 3D is a rear-side elevation view of the ladder of FIG. 1 in a straight position of the ladder.

FIG. 4 is an enlarged front perspective view of a top portion of the ladder of FIG. 1.

FIG. 5 is an enlarged top perspective view of the top portion of the ladder of FIG. 1.

FIG. 6 is a first-end elevation view of a top step housing of the ladder of FIG. 1.

FIG. 7A is a front perspective view of the top step housing of FIG. 6.

FIG. 7B is a rear perspective view of the top step housing of FIG. 6.

FIG. 8A is a rear perspective view of a top step of the ladder of FIG. 1.

FIG. 8B is a left-side perspective view of the top step of FIG. 8A with a pivot guide removed.

FIG. 8C is a perspective view of an inner fixed plate of a hinge of the ladder of FIGS. 1.

FIG. 8D is an enlarged right-side perspective view of the top step of FIG. 8A.

FIG. 9A is a front perspective view of a pivot guide for the hinge of the ladder of FIG. 1.

FIG. 9B is a rear perspective view of the pivot guide of FIG. 9A.

FIG. 10 is an exploded view of the top step of FIG. 8A.

FIG. 11A is a front perspective view of a pad of the top step of FIG. 8A.

FIG. 11B is a rear perspective view of the pad of FIG. 11A.

FIG. 12A is a top perspective view of a first embodiment of a utility bracket of the top step of FIG. 8A.

FIG. 12B is a bottom perspective view of the first embodiment of the utility bracket of FIG. 12A.

FIG. 12C is a rear perspective view of the first embodiment of the utility bracket of FIG. 23A.

FIG. 13 is another enlarged top perspective view of the top portion of the ladder of FIG. 1.

FIG. 14A is a second embodiment of a top step of a ladder.

FIG. 14B is a top step housing of the second embodiment of the top step of FIG. 14A.

FIG. 14C is a second embodiment of a utility bracket of the second embodiment of the top step of FIG. 14A.

FIG. 15 is an enlarged rear perspective view of a top portion of a ladder including a third embodiment of a utility bracket.

FIG. 16 is an enlarged cross-sectional view of a lockable hinge assembly of the ladder of FIG. 1, taken along line 16-16 of FIG. 4.

FIG. 17 is an exploded view of the lockable hinge assembly of FIGS. 16.

FIG. 18A is a front perspective view of a portion of a sliding lock assembly of the lockable hinge assembly of FIG. 16.

FIG. 18B is a top perspective view of a lever handle of the sliding lock assembly of FIG. 18A.

FIG. 18C is a bottom perspective view of the lever handle of FIG. 18B.

FIG. 18D is a top perspective view of a sliding plate of the sliding lock assembly of FIG. 18A.

FIG. 18E is a bottom perspective view of the sliding plate of FIG. 18D.

FIG. 19A is an enlarged right-side perspective view of a top portion of the ladder of FIG. 1 in a stepladder position showing a first hinge with outer fixed plates removed.

FIG. 19B is an enlarged right-side perspective view of a top portion of the ladder of FIG. 1 in a straight positioning showing the first hinge with outer fixed plates removed.

FIG. 20 an enlarged right-side perspective view of a top portion of the ladder of FIG. 1 in a stepladder position showing the first hinge with outer fixed plates and a front rail removed.

FIG. 21 is an enlarged left-side perspective view of the first hinge of FIG. 19A with inner fixed plates and the front rail removed.

FIG. 22A is a first-side perspective view of a first inner fixed plate of the first hinge of FIG. 19A.

FIG. 22B is a first-side perspective view of a first outer fixed plate of the first hinge of FIG. 19A.

FIG. 23 is a first-side perspective view of a strengthening plate of the first hinge of FIG. 19A.

FIG. 24A is a second-side perspective view of the first inner fixed plate of FIG. 22A. FIG. 24B is a second-side perspective view of the first outer fixed plate of FIG. 22B.

FIG. 25 is another enlarged right-side perspective view of a top portion of the ladder of FIG. 1 in a stepladder position showing the first hinge with outer fixed plates and a front rail removed.

FIG. 26 is a perspective cross-sectional view of the first hinge of FIG. 19A taken along line 26-26 of FIG. 19A.

FIG. 27 is an enlarged perspective view of a portion of the cross-sectional view of FIG. 16.

FIG. 28A is a first-side perspective view of a bushing of the lockable hinge assembly of FIG. 16.

FIG. 28B is a cross-sectional view of the bushing of FIG. 28A taken along line 28B-28B of FIG. 28A.

FIG. 29A is a front, top perspective view of a first embodiment of a rung of the ladder of FIG. 1.

FIG. 29B is a rear, bottom perspective view of the rung of FIG. 29A.

FIG. 30 is a left-side elevation view of the rung of FIG. 29A.

FIG. 31 is an enlarged perspective view of the left side of the rung of FIG. 29A.

FIG. 32 is a perspective cross-sectional view of the ladder of FIG. 1 taken along line 32-32 of FIG. 2.

FIG. 33 is a front perspective view of a connection between the rung of FIG. 29A and a rail of the ladder of FIG. 1.

FIG. 34 is a perspective cross-sectional view of the connection of FIG. 33 taken along line 34-34 of FIG. 33.

FIG. 35 is a diagram of weld points for the connection of FIG. 33.

FIG. 36 is a diagram of weld points for a bottommost rung of the ladder of FIG. 1.

FIG. 37 is a front perspective view of a rung-to-rail connection with a second embodiment of a rung and a rail of the ladder of FIGS. 1.

FIG. 38 an exploded view of the rung-to-rail connection of FIG. 37.

FIG. 39 is a front perspective view of the rung of FIG. 37.

FIG. 40 is a side elevation view of the rung of FIG. 37.

FIG. 41 is a side perspective view of the rail of FIG. 37.

FIG. 42 is a rear perspective view of the rung of FIG. 37.

FIG. 43A is an enlarged rear perspective view of a bottom portion of the ladder of FIG. 1.

FIG. 43B is an enlarged front perspective view of a bottom portion of the ladder of FIG. 1.

FIG. 44 is a rear perspective view of a bottom rung of the ladder of FIG. 1.

FIG. 45 is a front perspective view of the bottom rung of FIG. 44.

FIG. 46 is a side elevation view of the bottom rung of FIG. 44.

FIG. 47 is a perspective cross-sectional view of the ladder of claim 1 taken along line 47-47 of FIG. 43B.

FIG. 48 is a perspective cross-sectional view of the ladder of claim 1 taken along line 48-48 of FIG. 43A showing a portion of a rail lock assembly.

FIG. 49 is a first-side perspective view of a sliding plate of the rail lock assembly of FIG. 48.

FIG. 50 is a second-side perspective view of the sliding plate of FIG. 49.

FIG. 51 is an enlarged perspective view of the rail lock assembly of FIG. 48 with the bottom rung removed.

FIG. 52 is an enlarged perspective view of rail locking hole of the ladder of FIG. 1.

FIG. 53 is a cross-sectional view of the ladder of FIG. 1 showing a locked state of the rail lock assembly taken along line 53-53 of FIG. 52.

FIG. 54A is front perspective view of a bushing in the rail locking hole of FIGS. 52.

FIG. 54B is a rear perspective view of the bushing of FIG. 54A.

FIG. 54C is a side elevation view of the bushing of FIG. 54A.

FIG. 54D is a cross-sectional view of the bushing of FIG. 54A taken along line 54D-54D of FIG. 54A.

FIG. 55 is a front perspective view of a bottom portion of the ladder of FIG. 1 showing a foot assembly.

FIG. 56 is an exploded view of the foot assembly of FIG. 55.

FIG. 57 is a top perspective view of a first embodiment of a foot of the foot assembly of FIG. 55.

FIG. 58 is a bottom perspective view of the foot of FIG. 57.

FIG. 59 is an inner-side perspective view of the foot of FIG. 57.

FIG. 60 is another inner-side perspective view of the foot of FIG. 57.

FIG. 61 is an outer-side perspective view of the foot of FIG. 57.

FIG. 62 is a front-side perspective view of the foot of FIG. 57.

FIG. 63 is a rear-side perspective view of the foot of FIG. 57.

FIG. 64 is an enlarged cross-sectional view of the foot assembly of FIG. 57 taken along line 64-64 of FIG. 43A.

FIG. 65 is another top perspective view of the foot of FIG. 57.

FIG. 66 is a perspective cross-sectional view of the foot of FIG. 57 taken along line 65-65 of FIG. 62.

FIG. 67 is an inner-side perspective view of a second embodiment of a foot that can be used with the ladder of FIG. 1.

FIG. 68 is an inner-side perspective view of a third embodiment of a foot that can be used with the ladder of FIG. 1.

FIG. 69 is an enlarged front perspective view of a portion of the ladder of FIGS. 1.

FIG. 70 is a perspective cross-sectional view of the ladder of FIG. 1 taken along line 70-70 of FIG. 69, showing a brace coupled to a rail.

FIG. 71 is a top perspective view of the brace of FIG. 70.

FIG. 72A is a ladder having a first height and a first brace configuration according to a first embodiment.

FIG. 72B is a ladder having a second height and a second brace configuration according to a second embodiment.

FIG. 72C is a ladder having a third height and a third brace configuration according to a third embodiment.

FIG. 73 is an enlarged partial view of the ladder of FIG. 1 in a fully extended straight position showing a position of the braces.

FIG. 74 is another enlarged partial view of the ladder of FIG. 1 in a fully extended

straight position showing a position of the braces.

FIG. 75 is an enlarged partial view of the ladder of FIG. 72C in a fully extended straight position showing a position of the braces.

FIG. 76 is a front-side perspective view of a ladder according to various embodiments.

FIG. 77 is an enlarged front-side perspective view of a bottom portion of the ladder of FIG. 76.

FIG. 78 is an enlarged rear-side, right-side perspective view of a bottom portion of the ladder of FIG. 76 in a fully extended straight position of the ladder.

FIG. 79 is an enlarged rear-side, left-side perspective view of a bottom portion of the ladder of FIG. 76 in a fully extended straight position of the ladder.

FIG. 80 is an enlarged view of a stop on a rail of the ladder of FIG. 76 in a fully extended straight position of the ladder.

FIG. 81 is a cross-sectional view of the ladder of FIG. 76 showing a locked state of a rail lock assembly and engagement of the rail lock assembly with the stop, taken along line 81-81 of FIG. 77.

FIG. 82 is a front-side perspective view of a main stop body of the stop of FIG. 80.

FIG. 83 is a rear-side perspective view of the main stop body of FIG. 82.

FIG. 84 is a perspective view of a multi-position ladder including a brace coupled thereto in accordance with various embodiments.

FIG. 85 is a perspective view of a brace for use with a multi-position ladder in accordance with various embodiments.

FIG. 86A is a perspective view of a brace coupled to a portion of a multi-position ladder in accordance with various embodiments.

FIG. 86B is a perspective view of a brace coupled to a portion of a multi-position ladder in accordance with various embodiments.

FIG. 86C is a perspective view of a brace coupled to a portion of a multi-position ladder in accordance with various embodiments.

FIG. 87 is a top perspective view of a top step of a multi-position ladder in a step ladder configuration in accordance with various embodiments.

FIG. 88A is a rear perspective view of a polymer extension coupled to a top step of a multi-position ladder in a step ladder configuration in accordance with various embodiments.

FIG. 88B is a side perspective view of a polymer extension coupled to a top step of a multi-position ladder in a step ladder configuration and a slidable accessory engaging therewith in accordance with various embodiments.

FIG. 89 is a perspective view of a top step of a multi-position ladder in a step ladder configuration in accordance with various embodiments.

FIG. 90A is a rear perspective view of a foot and a cup or strengthening member coupled to a portion of a multi-position ladder in accordance with various embodiments.

FIG. 90B is a bottom perspective view of a foot and a cup or strengthening member coupled to a portion of a multi-position ladder in accordance with various embodiments.

FIG. 90C is a perspective view of a foot of a multi-position ladder in accordance with various embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present disclosure. Also, common but well-understood elements that are useful or necessary in a commercially feasible embodiment may be omitted in order to facilitate a less obstructed view of these various embodiments of the present invention. Certain actions and/or steps may be described or depicted in a particular order of occurrence when such specificity with respect to sequence is not actually required. The terms and expressions used herein have the ordinary technical meaning as is accorded to such terms and expressions by persons skilled in the technical field as set forth above except where different specific meanings have otherwise been set forth herein.

Further, the following description of illustrative embodiments according to principles of the present disclosure is intended to be read in connection with the accompanying drawings, which are to be considered part of the entire written description. In the description of embodiments disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the disclosure are illustrated by reference to certain embodiments. Accordingly, the invention expressly should not be limited to such embodiments illustrating some possible non-limiting combination of features that may exist alone or in other combinations of features.

### DETAILED DESCRIPTION

The present disclosure relates to reconfigurable ladders with sections or portions that are movable relative to one another, referred to herein as “multi-position ladders”, as well as components or features of multi-position ladders that improve the stability, safety, or usability thereof. Components or features of the multi-position ladders described herein include, for instance, a top step that includes a utility bracket, a top step that is part of a lockable hinge assembly, I-shaped inner rungs, a bottom inner rung housing a rail lock assembly, various modes of rail-to-rung connection, a hinge with an inner strengthening plate for resisting lateral forces, a durable and stable foot, strengthening braces for ladder rails, and a bushing or grommet for rail locking pin holes.

In one illustrative approach, a multi-position ladder includes a first ladder section having a first rail, a second rail, and at least one rung connecting the first and second rails; a second ladder section having a third rail, a fourth rail, and at least one rung connecting the third and fourth rails; a first hinge between the first rail and the third rail; and a second hinge between the second rail and the fourth rail, the first hinge and the second hinge permitting relative rotation between the first ladder section and the second ladder section to change a position of the ladder.

In some aspects, the multi-position ladder includes a step extending between the first hinge and the second hinge. By some approaches, the step includes a metal housing. The metal housing may include a top wall with treading defining a stepping surface, a bottom wall, a first side wall, and a second side wall opposite the first side wall. The metal housing may also include a first open end, a second open end, and a channel extending through the housing between the first open end and the second open end. In some approaches, the housing includes a dividing wall within the channel dividing the channel into a first compartment between the dividing wall and the first side wall and a second compartment between the dividing wall and the second side wall, with the first and second compartments extending between the first open end and the second open end.

In some approaches, the step also includes a hinge lock assembly in the metal housing. In an illustrative approach, the hinge lock assembly is in the second compartment. In use, the hinge lock assembly may be actuatable between a first locked state in which relative rotation between the first ladder section and second ladder section is inhibited and a second unlocked state permitting relative rotation between the first ladder section and the second ladder section.

In some approaches, the step may also include an elongated bracket coupled to an exterior surface of the first side wall of the metal housing. In some examples, the elongated bracket includes a top surface with a plurality of compartments for holding items such as tools.

In another illustrative approach, a ladder rung includes a central web extending from a first end of the rung to a second side of the rung, the central web defining first and second opposing surfaces that are substantially flat. The ladder rung may further include a first step integrally formed with and extending along a top edge of the central web at a non-perpendicular angle relative to the central web and a second step integrally formed with and extending along a bottom edge of the central web at a non-perpendicular angle relative to the central web. In some approaches, wherein the central web bisects the first step and the second step. The first step and the second step may include treading. In some examples, the ladder rung is an inner rung disposed on an inner ladder section that is contained at least in part in an outer ladder section and telescopes or slides relative thereto.

In some approaches, a multi-position ladder includes one or more of the ladder rungs. The multi-position ladder may include a first ladder section having a first rail, a second rail, and a first plurality of first rungs extending between the first rail and the second rail and a second ladder section having a third rail, a fourth rail, and a plurality of second rungs extending between the third rail and the fourth rail. In such a configuration, the ladder may include a plurality of second rungs similar to those described above. The multi-position ladder may also include a third ladder section having a fifth rail, a sixth rail, and a plurality of third rungs extending between the fifth rail and the sixth rail and a fourth ladder section having a seventh rail, an eighth rail, and a plurality of fourth rungs extending between the seventh rail and the eighth rail. In such a configuration, the ladder may include at least one fourth rung that is similar to those described above.

In some approaches, the multi-position ladder includes at least one hinge between the second ladder section and the fourth ladder section permitting the first and second ladder sections to rotate relative to the third and fourth ladder sections. In addition, in illustrative examples, the first rail and the second rail may be outer rails and the third rail and the fourth rail may be inner rails, the third rail extending within the first rail and the fourth rail extending within the second rail such that the first section and the second section are slidable relative to one another to adjust a height of the ladder. Similarly, the fifth rail and the sixth rail may be outer rails and the seventh rail and the eighth rail may be inner rails, the seventh rail extending within the fifth rail and the eighth rail extending within the sixth rail such that the third section and the fourth section are slidable relative to one another to adjust a height of the ladder.

In another illustrative approach, a ladder, such as a multi-position ladder, may include a first ladder section and a second ladder section, each ladder section having first and second rails in parallel to one another and at least one rung connecting the first and second rails. The ladder, in some examples, includes a pivot assembly connecting the first and second ladder sections and permitting selective rotation of the second ladder section relative to the first ladder section to move the ladder between different positions, the different positions including at least a folded position of the ladder and a straight position or linear configuration of the ladder in which the first ladder section and the second ladder section are at an angle of about 180° relative to one another.

In some examples, the pivot assembly includes a first hinge that has a first fixed plate coupled to the first rail of the first ladder section, a second fixed plate coupled to the first rail of the first ladder section, and a first rotational plate coupled to the first rail of the second ladder section, the first rotational plate positioned between the first fixed plate and the second fixed plate and rotatable relative to the first fixed plate and the second plate to move the ladder between the different positions.

The first hinge may also include a strengthening plate extending in part between the first fixed plate and the second fixed plate. In illustrative approaches, the strengthening plate includes a surface positioned to engage the rotational plate when the rotational plate is moved to the straight position or linear configuration of the ladder and to thereby stop rotation of the rotational plate in a first direction, and to disengage the rotational plate when the rotational plate is rotated in a second direction and out of the straight position of the ladder.

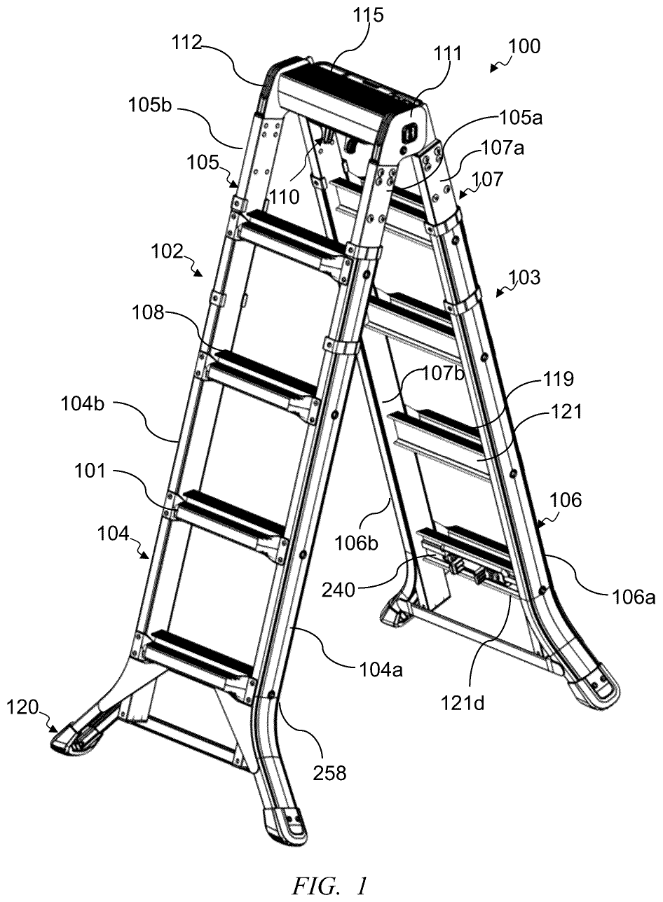

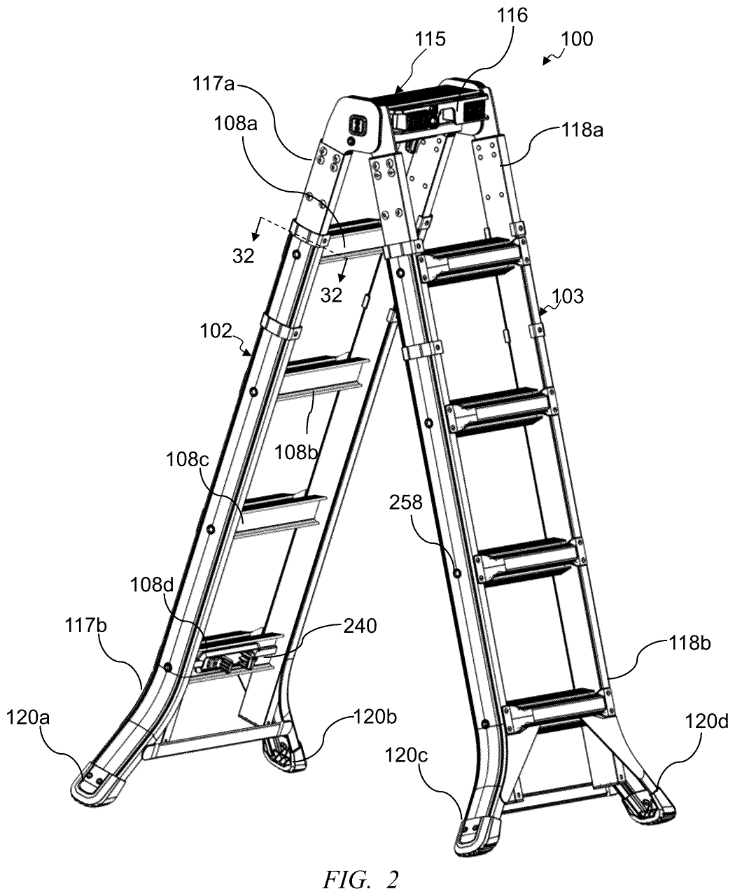

As shown generally in FIGS. 1-3D, there is an exemplary multi-position ladder 100. While a specific implementation of a multi-position ladder is illustrated, it will be appreciated by those skilled in the art that many of the components and features may also be used on a variety of configurations and on different types of ladder known in the art, including but not limited to stepladders and straight ladders, extension ladders, etc.

The illustrated ladder 100 includes a first ladder section 104 and a second ladder section 105 that may together define a front section 102 of the ladder and a third ladder section 106 and a fourth ladder section 107 that may together define a rear section 103 of the ladder 100. In some approaches, the ladder 100 includes a lockable hinge assembly 110 between and coupled to the second ladder section and the fourth ladder section, the lockable hinge assembly 110 permitting rotation of the front section 102 relative to the rear section 103. Though sections 102 and 103 are referred to herein as “front” and “rear” sections, it will be appreciated that the ladder 100 may also be used in an opposite orientation, with section 103 facing the front and section 102 facing the rear.

The first ladder section 104 may include a first rail 104a and a second rail 104b spaced from one another, and one or more steps or rungs 101 coupled to and extending between the first rail 104a and the second rail 104b.

The second ladder section 105 may include a first rail 105a and a second rail 105b spaced from one another, and one or more steps or rungs 108 coupled to and extending between the first rail 105a and the second rail 105b.

The third ladder section 106 may include a first rail 106a and a second rail 106b spaced from one another, and one or more steps or rungs 119 coupled to and extending between the first rail 106a and the second rail 106b.

The fourth ladder section 107 may include a first rail 107a and a second rail 107b spaced from one another, and one or more steps or rungs 121 coupled to and extending between the first rail 107a and the second rail 107b.

In some approaches, the second ladder section 105 is contained at least in part within the first ladder section 104 such that the first ladder section 104 and the second ladder section 105 telescope or slide relative to one another to change a length or height of the front section 102 of the ladder 100. For instance, the first rail 105a and the second rail 105b of the second ladder section 105 may be positioned at least in part within the first rail 104a and the second rail 104b of the first ladder section 104, respectively. Thus, the first ladder section 104 may be referred to herein as an “outer ladder section” and the rails 104a, 104b and rungs 101 of the first ladder section 104 may be referred to as “outer rails” and “outer rungs.” The second ladder section 105 may be referred to herein as an “inner ladder section” and the rails 105a, 105b and rungs 108 of the second ladder section 105 may be referred to as “inner rails” and “inner rungs.” The front section 102 may include a rail lock assembly 204 to permit a user to lock and unlock the first ladder section 104 and the second ladder section 105 to inhibit or allow sliding of the first ladder section 104 and the second ladder section 105 relative to one another. In some approaches, the rail lock assembly 240 is included within a bottom rung 108d of the second ladder section 105 and is configured to selectively engage and disengage locking pin holes 258 spaced along the first and second rails 104a, 104b of the first ladder section 104 to adjust the length of the front section 102.

As shown, the outer rungs 101 are configured to be positioned in front of the inner rungs 108 when portions of the second ladder section 105 are retracted within the first ladder section 104. In some approaches, the outer rungs 101 are attached to front surfaces of the first and second outer rails 104a, 104b and extend entirely in front of the outer rails 104a, 104b to allow room for the inner rungs 108 to extend behind the outer rungs 101.

Similarly, the fourth ladder section 107 may be contained at least in part within the third ladder section 107 such that the third ladder section 107 and the fourth ladder section 107 telescope or slide relative to one another to change a length or height of the rear section 103 ladder 100. For instance, the first rail 107a and the second rail 107b of the fourth ladder section 107 may be positioned at least in part within the first rail 106a and the second rail 106b of the third ladder section 106, respectively. Thus, the third ladder section 106 may be referred to herein as an “outer ladder section” and the rails 106a, 106b and rungs 119 of the third ladder section 106 may be referred to as “outer rails” and “outer rungs.” The fourth ladder section 107 may be referred to herein as an “inner ladder section” and the rails 107a, 107b and rungs 121 of the fourth ladder section 107 may be referred to as “inner rails” and “inner rungs.”

The rear section 103 may also include a rail lock assembly 240 to permit a user to lock and unlock the third ladder section 106 and the second ladder section 107 to inhibit or allow sliding of the third ladder section 106 and the second ladder section 107 relative to one another. In some approaches, the rail lock assembly 240 of the rear section 103 is included within a bottom rung 121d of the fourth ladder section 107 and is configured to selectively engage and disengage locking pin holes 258 spaced along the first and second rails 106a, 106b of the third ladder section 106 to adjust the length of the rear section 103.

As shown, the outer rungs 119 are configured to be positioned in front of the inner rungs 121 when portions of the fourth ladder section 107 are retracted within the third ladder section 10. In some approaches, the outer rungs 119 are attached to front surfaces of the first and second outer rails 106a, 106b and extend entirely in front of the outer rails 106a, 106b to allow room for the inner rungs 121 to extend behind the outer rungs 119.

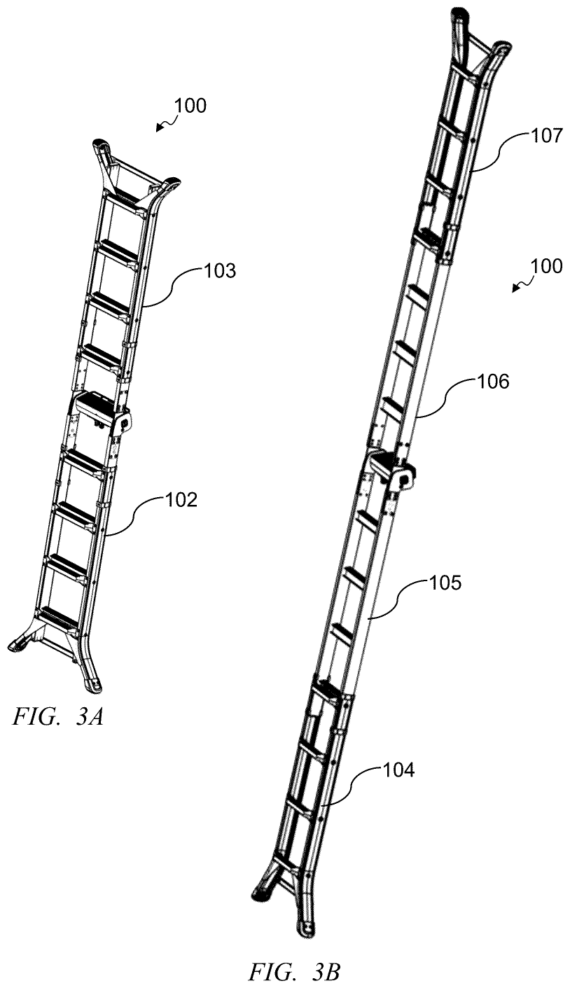

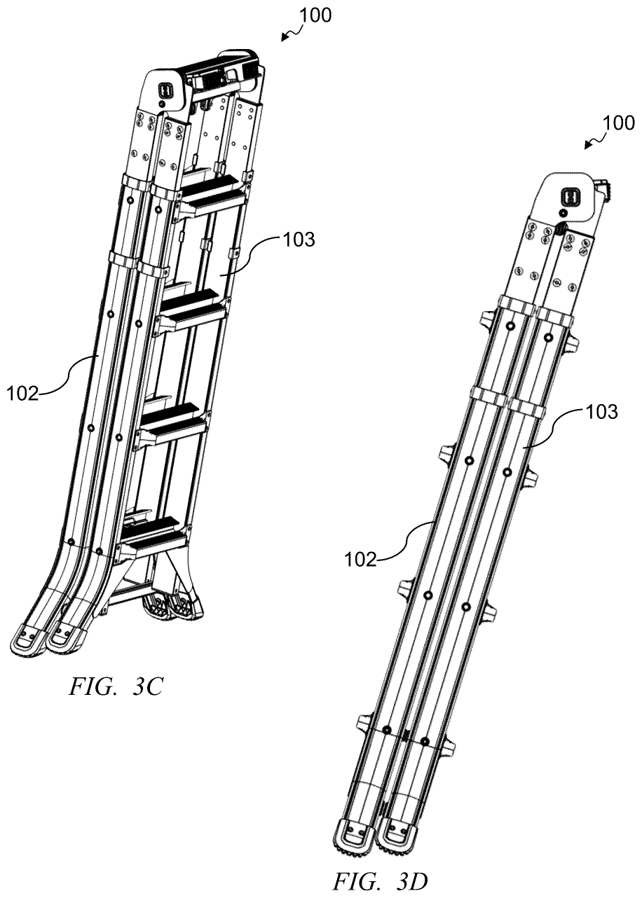

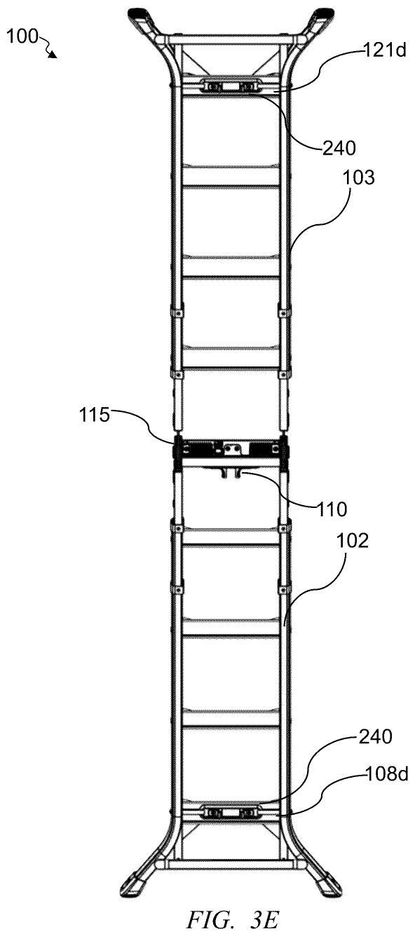

While FIG. 1 illustrates a stepladder or A-line configuration of the ladder 100, FIGS. 3A-3E illustrate other non-limiting positions of the ladder 100. For instance, FIGS. 3A and 3E illustrate a straight position or linear configuration of the ladder 100 in which the front section 102 and rear section 103 have been rotated to about a 180° angle relative to one another. The second ladder section 105 is in a maximum retracted position within the first ladder section 104 and the fourth ladder section 107 is in a maximum retracted position within the third ladder section 106. FIG. 3B illustrates a fully extended straight position of the ladder 100 in which the second ladder section 105 has been extended a maximum amount relative to the first ladder section 104 and the fourth ladder section 107 has been extended a maximum amount relative to the third ladder section 106. It will be appreciated that extended and retracted states between the maximum retracted position and the maximum extended position are also possible. Further, while not shown, the ladder 100 may also be extended to various amounts in the stepladder position to provide stepladder configurations of varying heights.

FIG. 3C illustrates a folded or storage position of the ladder 100, which, in some embodiments, may also be a leaning position of the ladder. In this configuration, the front section 102 and the rear section 103 are disposed generally parallel to one another. Advantageously, as discussed further below, the ladder 100 may include pads 140a, 140b adjacent a top of the ladder 100 to provide grip and protection when leaning on surfaces. In some approaches, the multi-position ladder 100 may also be rotated to other angles such as a 90 degree angle to achieve an L-shape configuration.

In some approaches, the front section 102 and the rear section 103 may be substantially identical below the hinges so that climbing can occur on both sides of the ladder. Furthermore, as shown, all of the ladder sections 104, 105, 106, 107 may be configured to be usable in different orientations, for instance when the ladder section is right-side up or upside down. To this end, each rung may have opposing stepping surfaces so that each rung can be used when the ladder 100 is shifted to both stepladder and straight positions.

As discussed in further detail below, the ladder 100 further includes ladder feet assemblies 120 positioned at a distal or bottom end 117b of the front section 102 and at a distal or bottom end 118b of the rear section 103. For instance, two front foot assemblies 120 may be attached to the outer rails 104a, 104b of the first ladder section 104 and two rear foot assemblies 120 may be attached to the outer rails 106a, 106b of the third ladder section 106. In some approaches, the outer rails 104a, 104b, and the outer rails 106a, 106b are substantially parallel for most of their length. However, as illustrated, the bottoms of the outer rails 104a, 104b, 106a, 106b may angle outwardly to define outwardly angled legs 260 to which the feet assemblies 120 are attached.

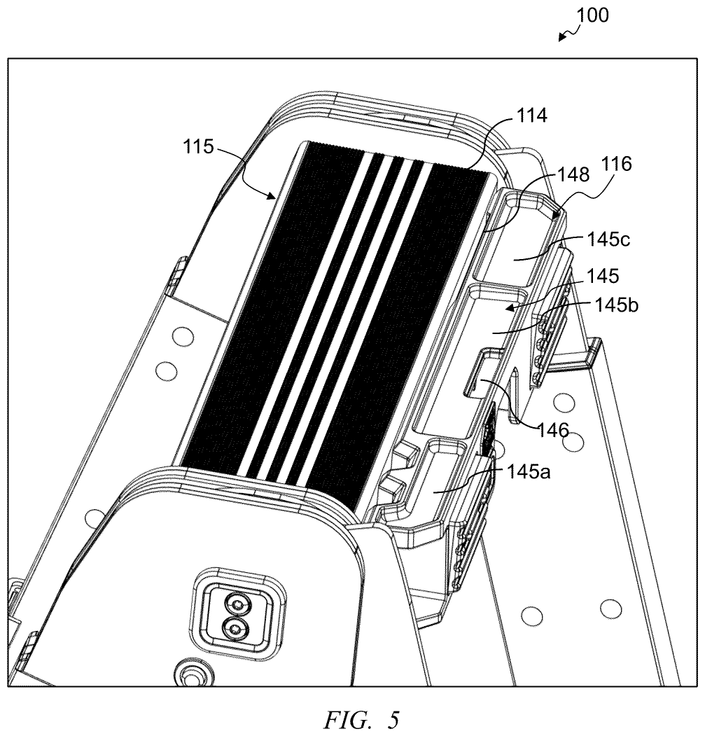

With references to FIGS. 1, 4, and 5, the ladder 100 may include a top step 115 coupled to a top end 117a of the front section 102 and a top end 118a of the rear section 103. The term “top step” is used herein to describe the step that is the uppermost step or rung when the multi-position ladder is in the stepladder configuration, though in a straight or extended straight configuration this step may be centrally located among the steps. Advantageously, the top step 115 fulfills a variety of different functions. For instance, in the illustrated embodiment, the top step 115 not only functions as a stable step in both stepladder and straight positions of the ladder, but further functions as part of the lockable hinge assembly 110. In addition, in some illustrative embodiments, the top step 115 includes a utility bracket 116 with a number of storage compartments 145 and may include other features for facilitating handling of tools and other items when using the ladder, as well as pads 140a, 150b that contribute to an improved leaning position of the ladder 100.

In some configurations, the top step 115 includes a housing 114 that is particularly designed to achieve all of the above-noted functions. The housing 114 may be an integrally formed metal (e.g., aluminum) extrusion, while the utility bracket 116 may be formed from a plastic polymer and attached to a flat outer side surface of the housing 114 and out of the way of an upper stepping surface. This configuration for a top step is advantageous. Conventional ladders that have top steps with storage or utility features are typically formed from plastic. However, a plastic top step has a different visual appearance from other metal rungs of the ladder and may be perceived by a user as less robust or unsafe. Further, in a multi-position ladder, when the “top step” ends up being a central step when the ladder is in the straight position, the discontinuity in steps when the user is climbing may be jarring and distracting. The illustrated top step 115, however, resolves this issue by being primarily formed of metal with a metal upper stepping surface 114b, while having a plastic utility bracket 116 that is out of the way of the metal upper stepping surface 114b.

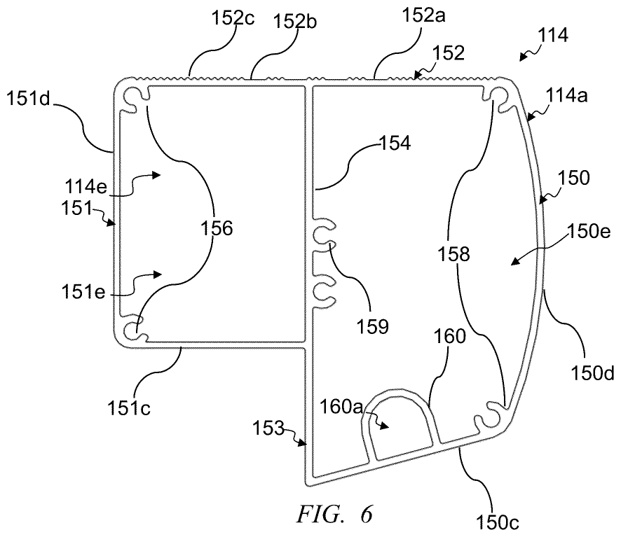

With reference to FIGS. 6-8B, the housing 114 may have an elongated body 114a with a first open end 114c, a second open end 114d, and an interior 114e extending therebetween. In some approaches, the housing is divided into a plurality of compartments, such as a first compartment 150 and a second compartment 151. The first compartment 150 and the second compartment 151 may each extend lengthwise an entire length of the housing 114 from the first open end 114c to the second open end 114d of the housing. Thus, the first compartment 150 may have a first open end 150a and a second open end 150b and the second compartment 151 may have a first open end 151a and a second open end 151b.

The housing 114 may include a top wall 152 that extends over and provides a top to both the first compartment 150 and the second compartment 151. For instance, a first portion 152a or half of the top wall 152 may serve as a top to the first compartment 150 and a second portion 152b or half of the top wall 152 may serve as a top to the second compartment 151. The top wall 152 may be substantially flat and define an upper stepping surface 114b of the top step 115. The upper stepping surface 114b may include treading 152c on at least a portion thereof. In some approaches, the treading 152c is integrally formed with the body 114a of the housing 114.

The housing 114 may also have a bottom wall 153. In some approaches, the bottom wall 153 provides a stepped bottom to the housing 114. For instance, the first compartment 150, in some approaches, may have a greater height than the second compartment 151, extending in part below the second compartment 151 to provide the stepped bottom of the housing 114. The bottom wall 153, thus, may have a first bottom portion 150c defining a bottom to the first compartment and a second bottom portion 151c defining a bottom to the second compartment 151.

A dividing wall 154 may also be present within the housing 114, dividing the housing 114 into the first compartment 150 and the second compartment 151. In some approaches, the dividing wall 154 extends from the first open end 114c to the second open end 114d of the housing 114. The dividing wall 154 may, in some approaches, bisect the top wall 152 and may be perpendicular thereto.

The housing 114 may also include a first side wall 150d and a second side wall 151d that each extend between the top wall 152 and the bottom wall 153 to provide lateral sides to the housing 114. Thus, the first compartment 150 may be defined by the first side wall 150d, the first bottom portion 150c of the bottom wall 153, the dividing wall 154, and the first top portion 152a of the top wall 152. The second compartment 151 may be defined by the second side wall 151d, the second bottom portion 151c of the bottom wall 153, the dividing wall 154, and the second top portion 152b of the top wall 152. Respective interiors 152e, 151e of the first compartment 150 and the second compartment 151 may extend from the first open end 114c of the housing 114 to the second open end 114d of the housing 114.

As noted above, in exemplary configurations the first compartment 150 may have a greater height than the second compartment 151, extending in part below the second compartment 151. For instance, the first compartment 150 may have a maximum height that is at least 20%, or in some approaches, at least 30% a maximum height of the second compartment 151. The first compartment 150 may be used to house a portion of the lockable hinge assembly 110, specifically a sliding hinge lock assembly 113 thereof, described further below. In some approaches, the first compartment 150 faces a front side of the ladder (e.g., the front section 102) so that the sliding hinge lock assembly 113 is easily accessed from the front of the ladder 100 to lock and unlock the lockable hinge assembly 110 and change the angle of the ladder 100. The second compartment 151, on the other hand, may face a rear side of the ladder (e.g., the rear section 103) and provides extra width to the housing 114 to expand and support the stepping surface 114b and provides a side surface (i.e., second side wall 151d) for attaching the utility bracket 116.

More specifically, the first side wall 150d of the first compartment 150 may be curved to provide a rounded or convex exterior side surface of the housing 114. Since the first compartment 150 may face the front side of the ladder 100, the rounded surface provided by the first side wall 150d improves the comfort of the user who may be standing or leaning against the top step 115 to perform work.

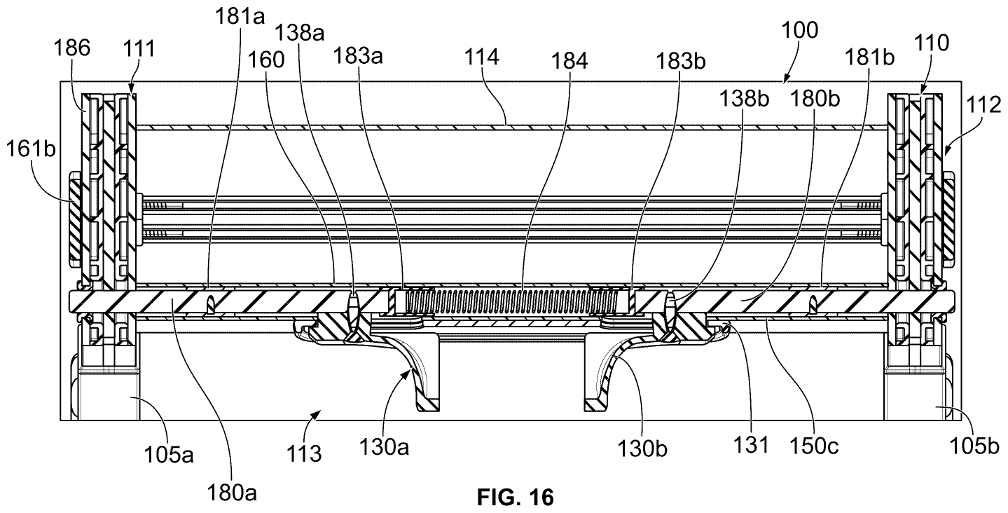

The bottom 150c of the first compartment 150 may support a portion of the sliding hinge lock assembly 113. For instance, in one approach, locking pins 180a, 180b (FIG. 16) may be positioned to directly or indirectly contact the bottom 150c of the first compartment. As illustrated, the first compartment 150 may include a guide wall 160 that, together with the bottom 150c, defines a channel 160a open on both ends extending at the bottom of the first compartment 150 from the first end 150a of the first compartment 150 to the second end 150b. In some approaches, the guide wall 160 is rounded, and a profile of the channel 160a has a half-circle or half-oval shape. The guide wall 160 may be sized for a close fit with the locking pins 180a, 180b and may help guide sliding movement of the locking pins 180a, 180b during unlocking and locking of the hinges. As discussed in more detail below (and shown in FIG. 16), the channel 160a may include other components of the sliding hinge lock assembly 113 such as one or more biasing elements 184 to bias the locking pins 180a, 180b in the locked position.

The bottom 150c of the first compartment 150, in some approaches, may be angled relative to the top 152 of the housing 114. For instance, the bottom 150c and the dividing wall 154 may define an angle that is less than 90 degrees, such as between about 45 degrees and about 85 degrees, or, in some approaches between about 50 degrees and about 80 degrees. The angle of the bottom 150c results in an angling of the channel 160a and the sliding hinge lock assembly 113, which in turn results in the lever handles 130a, 130b (FIG. 16) (also referred to as pinch lock or squeeze lock handles) being angled towards the front of the ladder 100 for easier handling and access.

The bottom 150c of the first compartment 150 also includes two colinear, spaced, elongated holes 157, 157b directly under the channel 160a to permit mechanical connection between the lever handles 130a, 130b and the locking pins 180a, 180b (FIG. 16).

The second compartment 151, in some approaches, has a substantially rectangular profile. The second side wall 151d may have a generally planar exterior surface to facilitate attachment to the utility bracket 116. In some embodiments, the utility bracket 116 may be attached to the second side wall 151d via fasteners such as rivets, screws, or bolts. To this end, there may be a plurality of holes 155 in the second side wall 151d to secure the utility bracket 116 to the housing 114. For instance, as illustrated, there may be four colinear spaced holes 155. Other amounts of holes 155 and configurations of the holes 155 are possible.

The housing 114 may also contain a plurality of bosses 156, 158 for screws or other fasteners 156a, 158a to connect opposite ends 114c, 114d of the housing 114 to a first hinge 111 and a second hinge 112 of the lockable hinge assembly 110. In some approaches, the bosses 156, 158 are integrally formed with the housing extrusion and are disposed within the interior 114e of the housing 114 at corner edges thereof. In an illustrative approach, the bosses 156, 158 define open ended channels for receiving parts of the fasteners 156a, 158a and have a circular or partial circle profile. In some approaches, the bosses 156, 158 extend an entire length of the housing 114 from the first open end 114c of the housing 114 to the second open end 114d. In one example, a boss 158 is positioned along the corner edge between the top wall 152 and the first side wall 150d, a boss 158 is positioned along the corner edge between the first side wall 150d and the bottom 150c of the first compartment 150, a boss 156 is positioned along the corner edge between the bottom 151c of the second compartment 151 and the second side wall 151d, and a boss 156 is positioned along the corner edge between the second side wall 151d and the top wall 152. An innermost hinge plate, for example first inner fixed plate 185, may include a plurality of corresponding holes 185d positioned to receive fasteners extending from the bosses 156, 158 of the housing 114 for a flush coupling of the housing 114 to the fixed plate 185.

In other approaches, the bosses 156, 158 may not extend all the way through the housing 114. In this approach, a first set of bosses 156, 158 may be adjacent the first end 114c of the housing 114 and a second set of bosses 156, 158 may be adjacent the second end 114d of the housing 114.

While FIG. 6 illustrates a left-side elevation view of the housing 114, it will be appreciated that the right-side elevation view of the housing 114 is substantially the same to achieve equivalent engagement with both the first hinge 111 and the second hinge 112.

In some approaches, the dividing wall 154 includes one or more additional bosses 159 that may be formed integrally with the housing 114 for attaching to respective pivots 161 of each of the hinges 111, 112. Thus, the housing 114 is further configured to support a pivot point of the hinges 111, 112. More specifically, in some approaches the one or more additional bosses 159 may define open ended channels for receiving parts of one or more hinge fasteners 159a and have a circular or partial circle profile. In some approaches, there are two bosses 159 which may, for instance, extend an entire length of the housing 114 from the first open end 114c of the housing 114 to the second open end 114d along the dividing wall 154. In some embodiments, the bosses 159 are disposed on a side of the dividing wall 154 within the first compartment 150. The bosses 159 may be positioned at about a center point of the housing 114. In other approaches, the bosses 159 may not extend all the way through the housing 114. In this approach, a first set of one or more bosses 159 may be adjacent the first end 114c of the housing 114 and a second set of one or more bosses 159 may be adjacent the second end 114d of the housing 114. Other amounts and configurations of bosses and fasteners are possible for the pivot 161 at the dividing wall 154.

In an illustrative configuration, the pivot 161 of each hinge 111, 112 is coupled to the one or more bosses 159 via one or more hinge fasteners 159a. For instance, there may be two hinge fasteners 159a that couple the first hinge 111 to the bosses 159 at the first end 114c and there may be two hinge fasteners 159a that couple the second hinge 112 to the bosses 159 at the second end 114d.

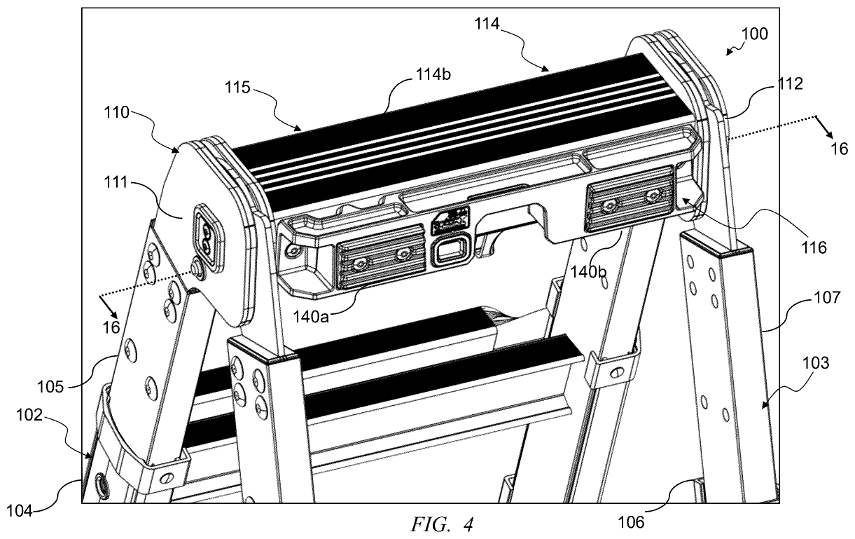

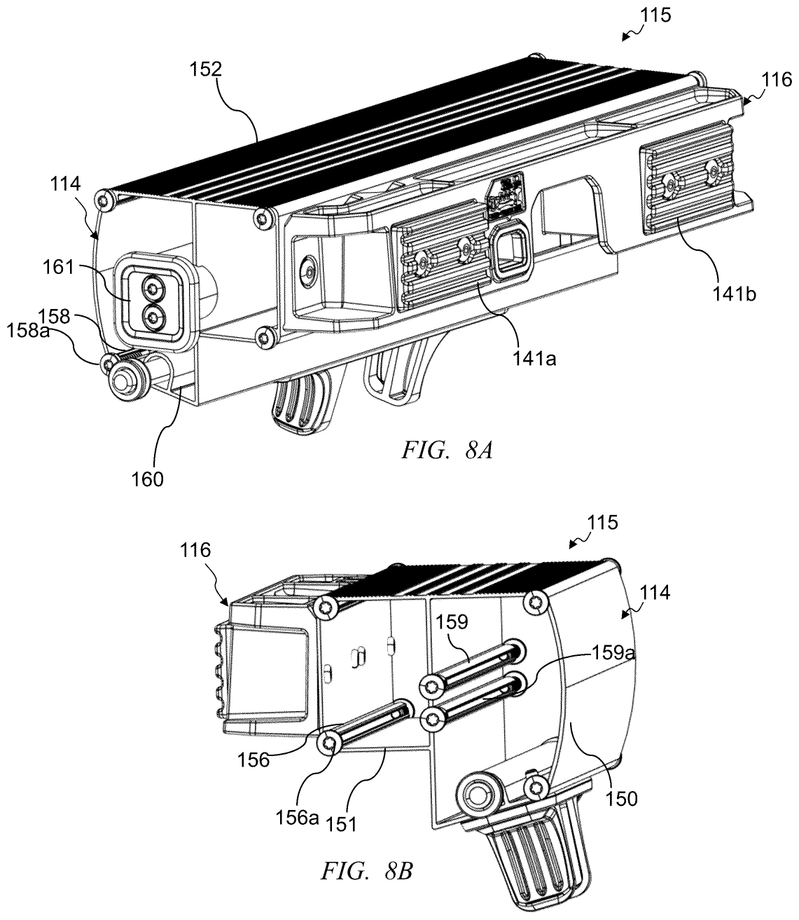

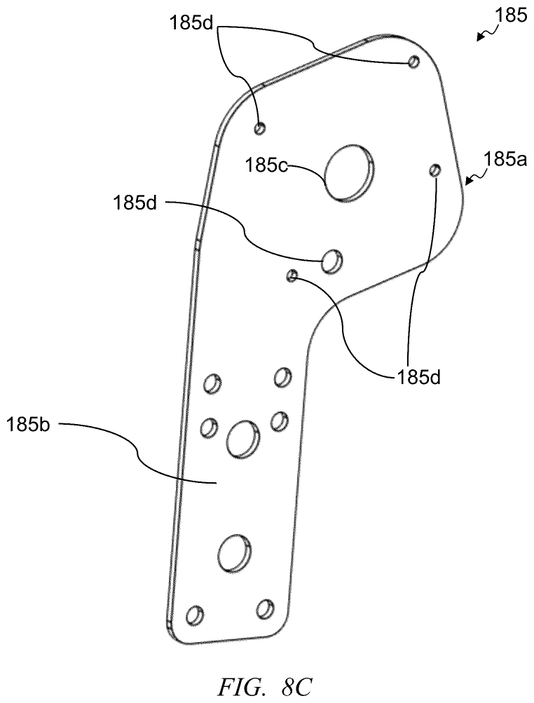

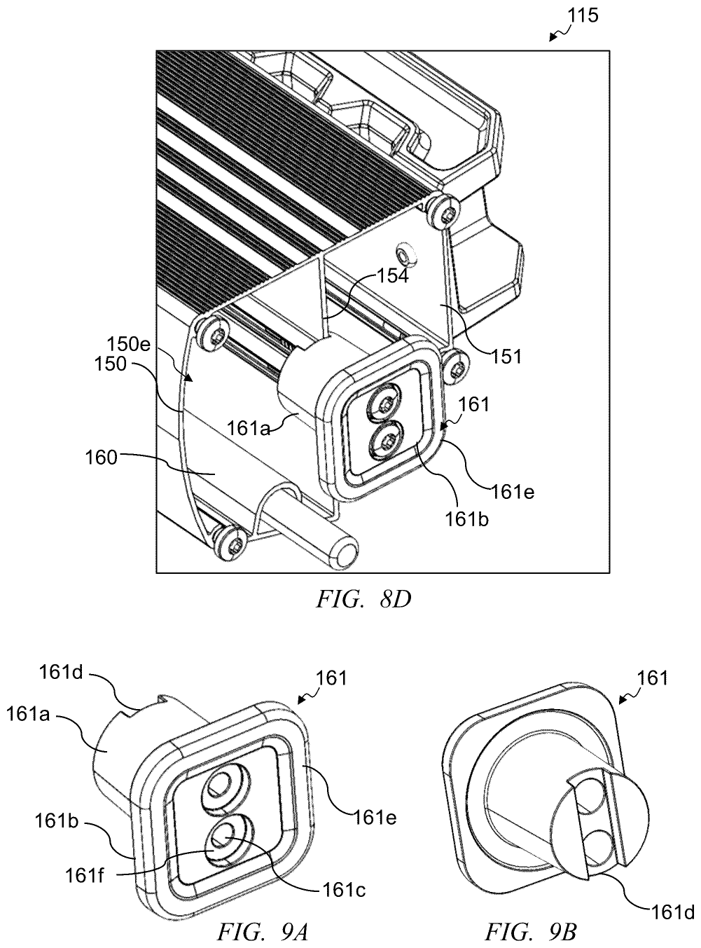

With reference to FIGS. 8C-9B, the pivot 161 may have a generally cylindrical main body 161a and a plate or flange 161b at one end thereof extending radially outwardly from the main body 161a . The flange 161b, in some approaches, has a rounded square shape, though may also have other shapes. One or more holes 161c (e.g., two holes) extend through the main body 161a and the flange 161b. The main body 161a is sized to fit within and extend all the way through each of the pivot holes (e.g., hole 185c of the innermost fixed plate 185) of the plates of the respective hinge (e.g., first hinge 111 or second hinge 112) to rotatably couple the plates together. Meanwhile, the flange 161b is sized to not extend into the pivot holes. Instead, as illustrated in FIG. 4, the flange 161b is on the other side of the first hinge 111, engaging an exterior surface of the outermost hinge plate 186 of the first hinge 111 (with an equivalent configuration at the second hinge 112). In some approaches, the flange 161b includes a raised rim 161e.

The main body 161a may include an elongate recess 161d or trough extending a diameter of the main body 161a at a distal end thereof. The one or more holes 161c may be disposed within the recess 161d. The recess 161d, in some approaches, may be present to facilitation engagement between the main body 161a and the dividing wall 154. For instance, the dividing wall 154 may be received in part within the recess 161d to stabilize the pivot 161 against the dividing wall 154.

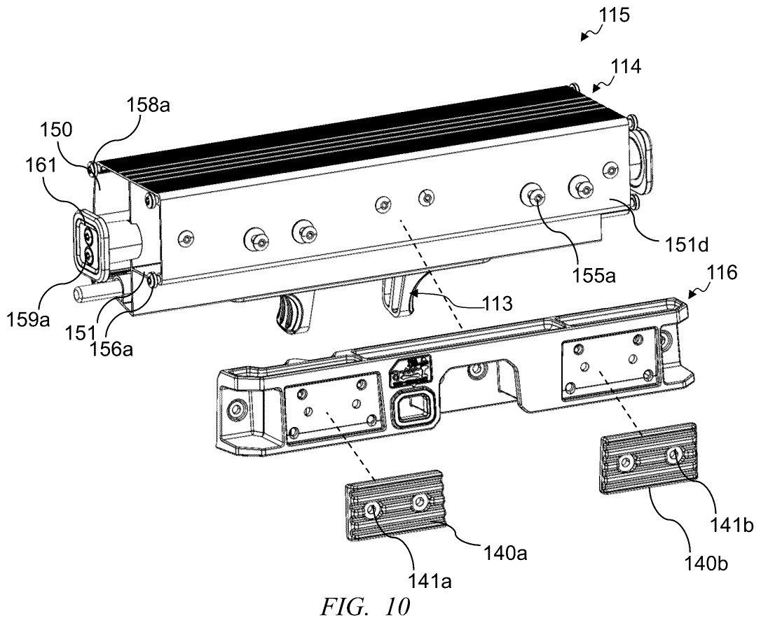

With reference to FIGS. 10-13, the utility bracket 116 (or utility strip) may have an elongated body 142 with a length sized so that the utility bracket 116 extends about the entire length of the second side wall 151d of the top step housing 114 and a height so that the utility bracket 116 extends about a height of the second side wall 151d. The utility bracket 116 may have a lateral depth that is less than a corresponding depth of the housing 114. For instance, the depth of the utility bracket 116 may be less than 70%, less than 60%, or less than 50% of the depth of the housing 114 in various non-limiting embodiments. As noted above, the utility bracket 116 may extend laterally from a rear side of the top step 115 so as not to interfere with climbing at the front section 102 of the ladder 100.

Further, as noted above, the body 142 of the utility bracket 116 may be formed integrally from a molded plastic or polymer. In yet other configurations, the utility bracket may be formed of multiple pieces or brackets.

In one illustrative configuration, the utility bracket 116 includes a top side 142a, a front side 142c, a rear side 142d, a first end 142e, and a second end 142f. The utility bracket 116 further has a generally open bottom 142b, such that a hollow interior 116a is generally defined between the top side 142a, the front side 142c, the rear side 142d, the first end 142e, and the second end 142f.

The top side 142a may be defined by a top wall 143 and, as noted above, may define a plurality of compartments 145 or recesses for holding items. In some approaches, the compartments 145 include a first compartment 145a adjacent the first end 142e, a second compartment 145b in about the middle of the top side 142a, and a third compartment 145c adjacent the second end 142f. some of these compartments may have a generally rectangular shape (e.g., the second compartment 145b), while others may have varied polygonal geometries.

One or more elongated slots 144a, 144b may also be accessed from the top side 142a of the utility bracket 116. The slots 144a, 144b may be sized to hold long and slim tools. More specifically, the slots 144a, 144b are defined by recesses extending along a wall 147 defining the rear side 142d of utility bracket 116 from the top side 142a to the bottom 142b in combination with the second side wall 151d of the top step housing 114.

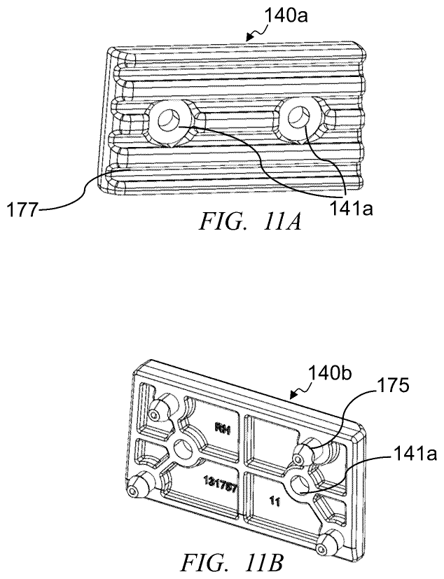

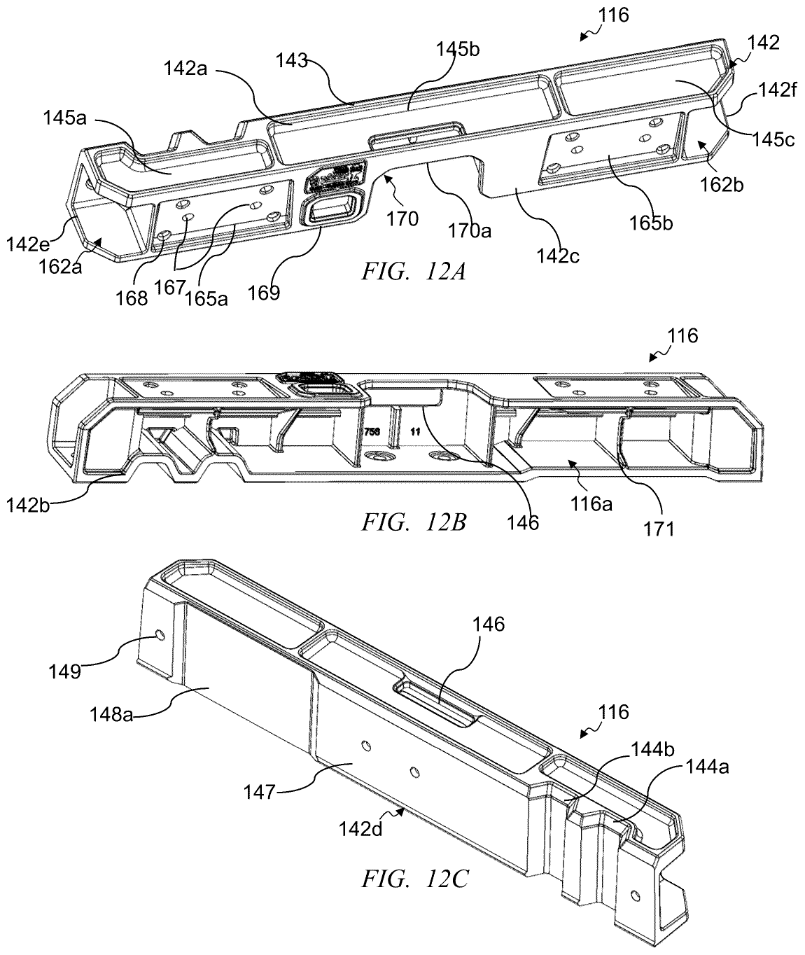

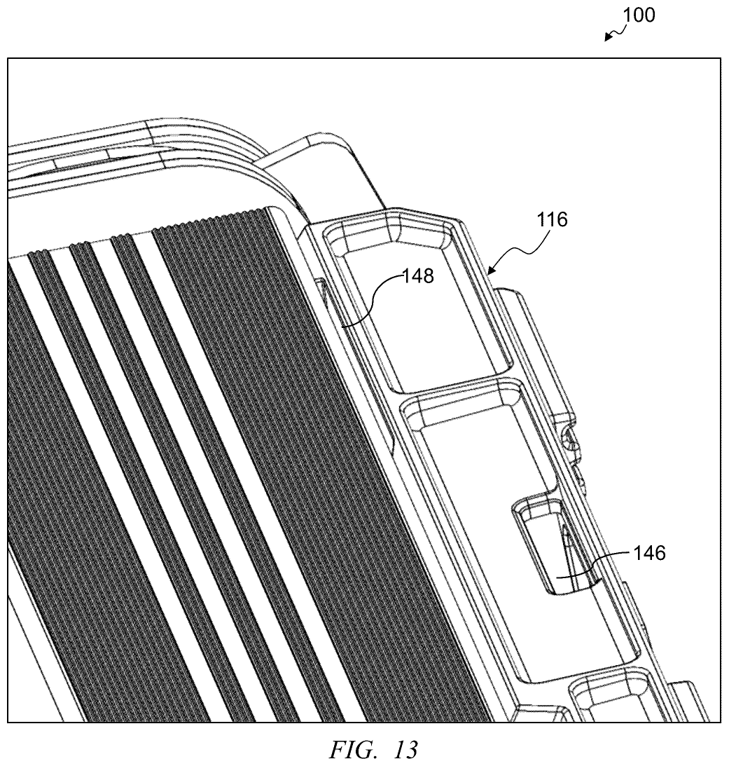

In some approaches, the wall 147 of the rear side 142d also includes an indentation 148a (see FIG. 12C). The indentation 148a, in combination with the second side wall 151d of the top step housing 114, may define a pocket 148 (see, e.g., FIG. 13) having a thin depth though relatively long length for holding thin or flat items such as a putty knife. The rear side 142d may also include a plurality of holes 149 spaced in the wall 147 for fasteners to fasten the rear side 142d of the utility bracket 116 to the second side wall 151d of the top step housing 114. The positioning of the holes 149 may align with positioning of the holes 155 in the second side wall 151d. The second side wall 151d may have an entirely planar or flat exterior surface for flush engagement with planar portions of the rear wall 147.

The top side 142a may also include an elongated hole 146 that may, for instance, be positioned centrally along the length of the second compartment 145b. The elongated hole 146 may, in some approaches, be disposed on a front portion of the second compartment 145b. A front wall 164 of the front side 142c may include a cutout 170 disposed centrally along the length of the front side 142c in front of and below the elongated hole 146. The cutout 170, in some approaches, may be a U-shaped or rectangular cutout extending from a bottom of the front side 142c to almost the top of front wall 164, such that a strip 170a of connecting front wall 164 is present at a top of the front side 142c connecting adjacent portions of the front wall 164 on either side of the cutout 170. In some approaches, items may be hooked on or otherwise attached around strip 170a and through the elongated hole 146. In some approaches, the elongated hole 146 may be used to clip on a tape measure.

By some approaches, the front wall 164 may further include one or more additional openings 169 sized to attach a hook or other form of attachment (e.g., lanyard) to hang items from the utility bracket 116.

In one exemplary embodiment, the front wall 164 also includes one or more pads 140a, 140b that are positioned to engage a surface when the ladder 100 is in the leaning position leaning against the surface. The pads 140a, 140b typically provide grip against the surface, increasing the safety of the leaning position and preventing damage to the surface. In some approaches, two pads 140a, 140b are positioned on the front wall 164 on opposites sides of the cutout 170. In some embodiments, the front wall 164 includes two recesses 165a, 165b having a size and shape generally corresponding to the pads 140a, 140b which partially receive the pads 140a, 140b.

The pads 140a, 140b may, in non-limiting approaches, have a generally rectangular shape and include treading 177 such as rows of longitudinal grooves. The pads 140a, 140b may be made formed from a plastic, rubber, or other suitable material that exhibits some flexibility, compressibility, and/or softness. The pads may be attached in a variety of manners such as via fasteners, adhesives or adhesion, snapfit connection, and/or corresponding geometry.

In one exemplary approach, one or more holes 141a may extend through each pad 140a, 140b for receiving fasteners to attach the pads to the front wall 164 of the utility bracket 116. For instance, in some non-limiting approaches, there are two holes 141a. The holes 141a may be sunken in or recessed from a front surface of the pad 140a, 140b. The recessing provides extra space for a head of a fastener so that the fastener is sunken in and does not come in contact with the surface. The front wall 164 may include one or more holes 167 corresponding in position with the holes 141a of the pads 140a, 140b to receive fasteners such as rivets, screws, or bolts to couple the pads 140a, 140b to the utility bracket 116. The pads 140a, 140b may also be coupled in other ways, such as by gluing, welding, co-molding, over-molding, etc.

A rear side of the pads 140a, 140b may include one or more interlocking features which help to maintain contact between the pads 140a, 140b and the utility bracket 116. For instance, in one approach, there may be one or more projections that are integrally formed with the pads 140a, 140b sized to be received in corresponding holes 168 in the front wall 164 of the utility bracket 116. In an illustrative embodiment, the projections include flexible, conical barbs that are inserted through the holes 168 and help keep the pads 140a, 140b in place. These may be incorporated in addition to or in place of other fastening measures described herein.

The first end 142e of the utility bracket 116 may include a front and side-facing pocket 162e. Similarly, the second end 142f may also include a front and side-facing pocket 162b. These pockets allow clearance for a riveting tool to apply rivets to attach the utility bracket 116 to the top housing.

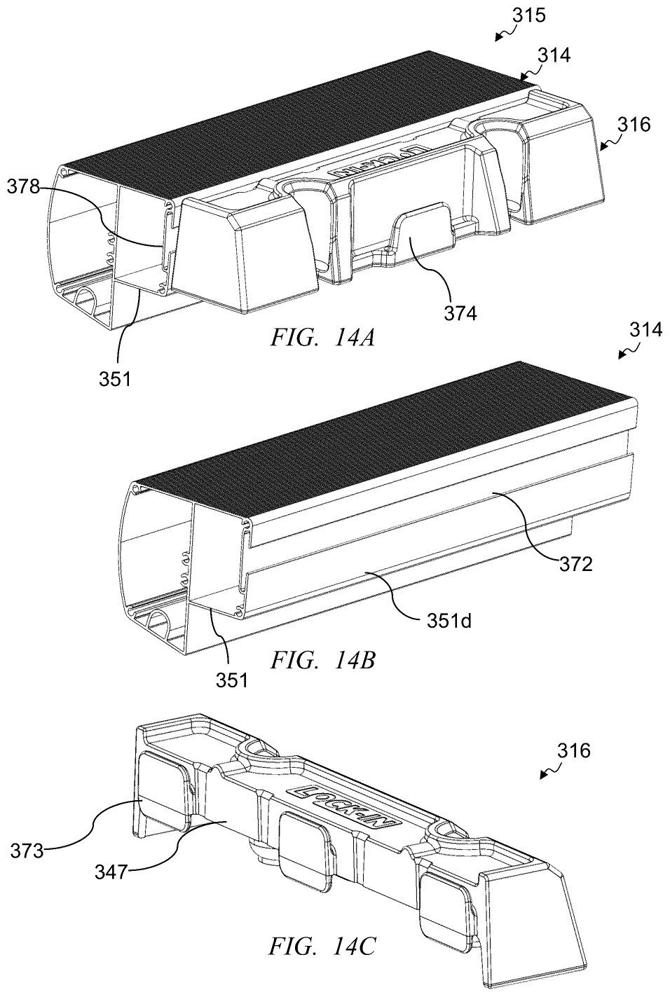

FIGS. 14A-14C illustrate another embodiment of a utility bracket 316 that may share some features of the utility bracket 116 described above. The utility bracket 316 employs a dovetail-type joint 378 to couple the utility bracket 316 to the top step housing 314 without separate fasteners. More specifically, the top step housing 314 may include a slot 372 having a T-shape integrated into the wall 351d of the second compartment 351. The utility bracket 316 may include a plurality of corresponding T-shaped bosses 373 on a rear side thereof which can be slid into the slot 372 to couple the utility bracket 316 to the top step housing 114. Instead of a T-shape, other geometries for the connection are possible, such as a tapered slot and one or more tapered bosses sized to slide into the tapered slot. It will be appreciated that the utility bracket 116 can be modified to also have these types of coupling. In yet other configurations, the utility bracket may be secured via both geometry (such as a dovetail-type joint) and one or more fasteners.

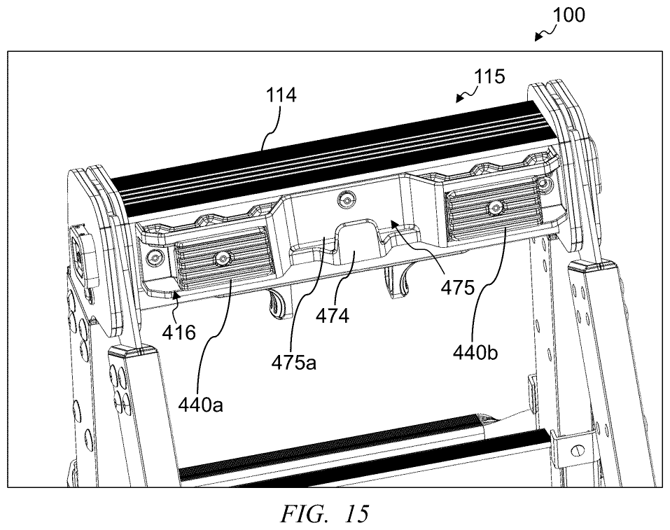

FIG. 15 illustrates another embodiment of a utility bracket 416 that may share some features of the utility brackets 116, 316 described above. The utility bracket 416 further includes a hook 474. In this case, the utility bracket 416 includes a laterally extending recess 475 defining a central recessed wall 475a that is recessed relative to the pads 440a, 440b. The hook 474 extends laterally outward from a bottom of the central recessed wall 475a about as far as the pads. A rear side of the central recessed wall 475a may engage and be fastened to the top step housing 114.

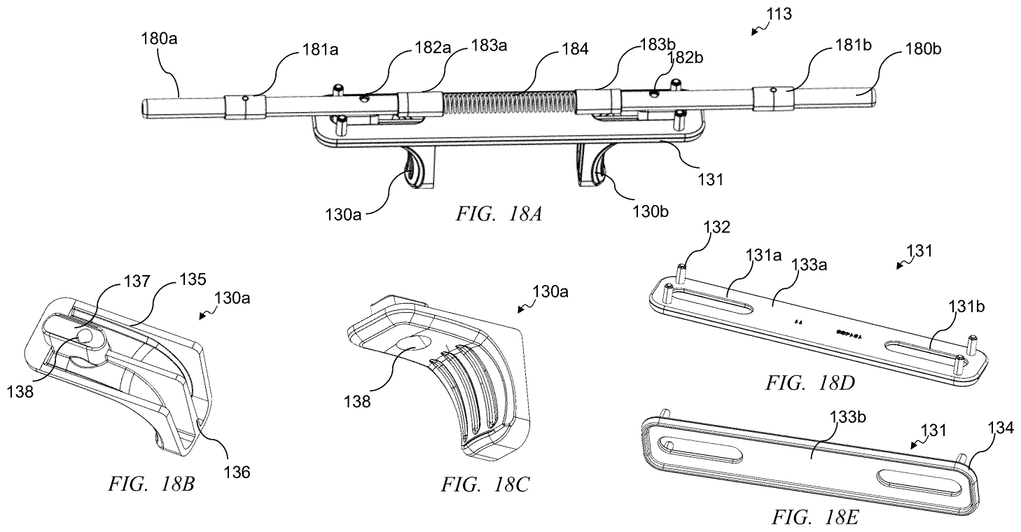

With reference to FIGS. 16-18E, the lockable hinge assembly 110 includes a sliding hinge lock assembly 113. The sliding hinge lock assembly 113 is used to lock and unlock the first and second hinges 111, 112 to respectively prevent and permit rotation of the front section 102 relative to the rear section 103. More specifically, first and second locking pins 180a, 180b are positioned within the first compartment 150 of the top step housing 114 to move axially into the locking holes (e.g., hole 185d in FIG. 8C) in all of the hinge plates to lock the hinges 111, 112 and to move axially out of the locking holes to unlock the hinges 111, 112. The first locking pin 180a may slide within the guide wall 160 of the first compartment 150 and may be positioned to engage the first hinge 111 while the second locking pin 180b may slide within the guide wall 160 of the first compartment 150 and may be positioned to engage the second hinge 112.

The sliding hinge lock assembly 113 may have a “pinch lock” or “squeeze lock” configuration that includes first and second actuating lever handles 130a, 130b. The locking pins 180a, 180b may each be mechanically coupled to respective lever handles 130a, 130b. The lever finger projection or lever handles 130a, 130b, as noted above, extend below the top step housing 114 so they can be accessed by the user. The locking pins 180a, 180b may be biased by one or more biasing elements 184 (e.g., a spring) within the guide 160 of the first compartment away from one another and into a locked position and locked state of the hinges 111, 112. When the lever handles 130a, 130b are forced towards each other (or “squeezed together”), the biasing forces of the biasing elements 184 are overcome, drawing the locking pins 180a, 180b out of the hinges 111, 112 and entirely into the top step housing 114 to an unlocked position and unlocked state of the hinges 111, 112. More specifically, in the locked state, rotational plates 190, 190′ of the hinges 111, 112 fixed to the rear section 103 of the ladder 100 are locked in position with respect to fixed plates (e.g., plates 185, 185′, 187, 187′, 188, 188′, 186, 186′) of the hinges 111, 112 that are attached to the front section 102 of the ladder. In the unlocked state, the rotational plates 190, 190′ are movable with respect to the fixed plates to change a position of the rotational plates 190, 190′ with respect to the fixed plates to ultimately change a position of the ladder 100.

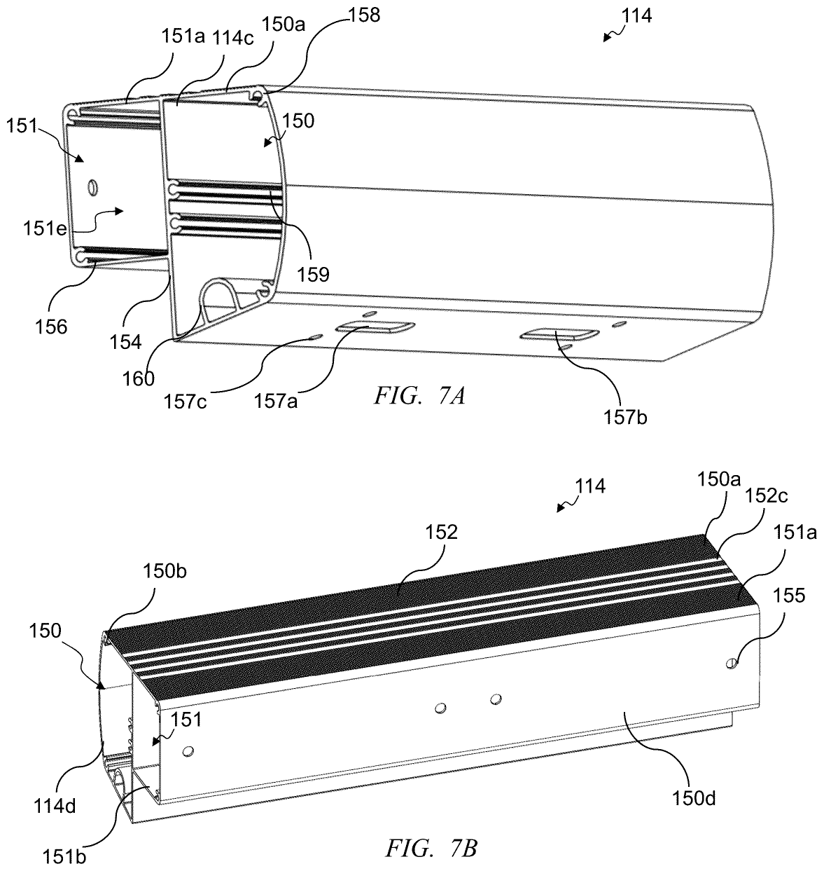

The sliding hinge lock assembly 113 may have a sliding plate 131 that is positioned outside the top step housing 114 and coupled thereto. Specifically, the sliding plate 131 is coupled to an exterior surface of the bottom wall 150c of the first compartment 150 in some approaches. The sliding plate 131 may include two elongated slots 131a, 131b that are sized and positioned to align with the elongated holes 157a, 157b (FIG. 7A) in the bottom wall 150c of the first compartment 150. As described below, portions of the lever handles 130a, 130b extend through respective slots 131a, 131b and respective elongated holes 157a, 157b to mechanically couple the lever handles 130a, 130b to the locking pins 180a, 180b. In some approaches, the sliding plate 131 includes a plurality of projections 132 projecting from a first side 133a of the sliding plate that extend through corresponding holes 157c in the bottom wall 150c to hold the sliding plate 131 in correct alignment with respective to the housing bottom wall 150c. In some approaches, a second side 133b of the sliding plate 131 includes a peripheral upstanding rim 134 to define a sliding track of the lever handles 130a, 130b therewithin.

Each lever handle 130a, 130b may include a base 135 and a handle portion 136 extending substantially perpendicularly thereto. The base 135 may include an elongated post 137 extending substantially perpendicular to the base 135 on an opposite side of the base 135 from the handle portion 136. The elongated post 137 is positioned and sized to extend within a respective one of the elongated slots 131a, 131b of the sliding plate 131 and a respective one of the elongated holes 157a, 157b of the top step housing 114. The length of the elongated post 137 may be shorter than a corresponding length of the slot 131a, 131b and hole 157a, 157b so that the post 137 has room to slide within the slot 131a, 131b and hole 157a, 157b so that the lever handle 130a, 130b can be moved. Each lever handle 130a, 130b may further include a hole 138 extending through the elongated post 137. The hole 138 may receive a fastener 138a, 138b that is also received in a hole 182a, 182b of one of the locking pins 180a, 180b to mechanically couple the respective lever handle 130a, 130b thereto.

The lever handles 130a, 130b may be a variety of materials, such as, e.g., a metal including die cast aluminum. Extending the lever handles 130a, 130b into the top step housing 114 to be directly coupled to the locking pins 180a, 180b permits smooth and direct drive execution of the mechanism.

In some approaches, one or more cylindrical sleeves or bushings may be included within the guide 160. For instance, the locking pin 180a may extend through a first cylindrical sleeve or bushing 181a and be coupled thereto via a fastener (or via a friction fit). The locking pin 180b may extend through a second cylindrical sleeve or bushing 181b and coupled thereto via a fastener. The sleeves 181a, 181b may have a slightly smaller diameter than the guide 160 and may be sized for sliding engagement therewith. The sleeves 181a, 181b may have a length that is significantly shorter than the length of the locking pins 180a, 180b to decrease friction of the sliding mechanism against the guide 160 while also serving to keep the locking pins 180a, 180b in proper alignment. Additional cylindrical sleeves or bushings 183a, 183b may each be attached (e.g., via friction fit) to an end of a respective locking pin 180a, 180b and an end of the biasing element 184 for similar purposes and also capture and retain the biasing element 184. The cylindrical sleeves may be formed from a plastic material.

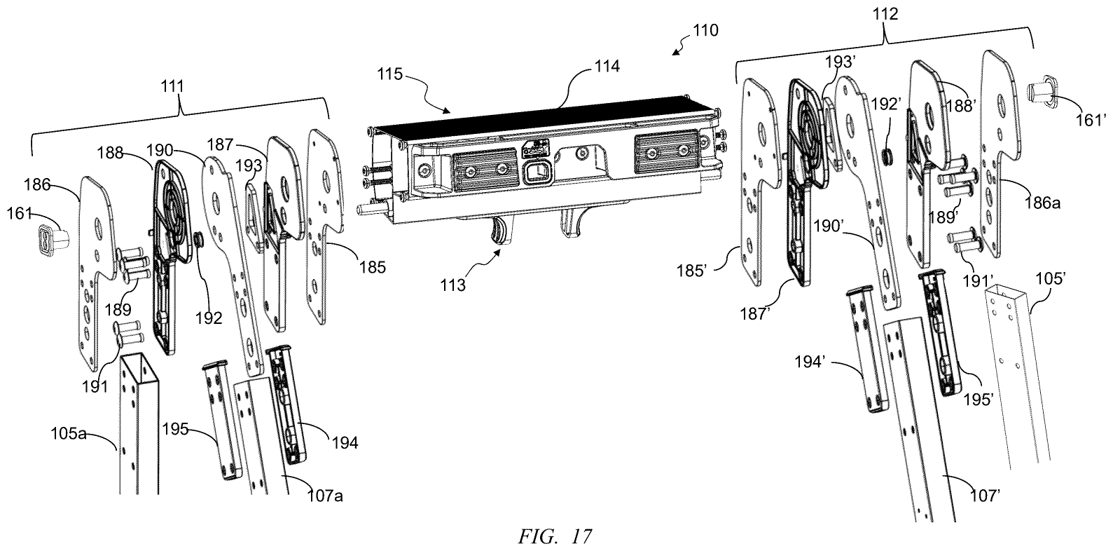

With reference to FIG. 17, the lockable hinge assembly 110 includes, as noted above, a first hinge 111 and a second hinge 112. The first hinge 111 is attached to the first end 114c of the top step housing 114 while the second hinge 112 is attached to the second end 114d of the top step housing 114. The first hinge 111 rotatably couples the first rail 105a of the second ladder section 105 to the first rail 107a of the fourth ladder section 107 while the second hinge 112 rotatably couples the second rail 105b of the second ladder section 105 to the second rail 107b of the fourth ladder section 107.

Only the first hinge 111 will be described in detail below, with the understanding that the second hinge 112 has the same configuration, with like components referred to in the figures as the reference numeral for the first hinge 111 followed by a prime.

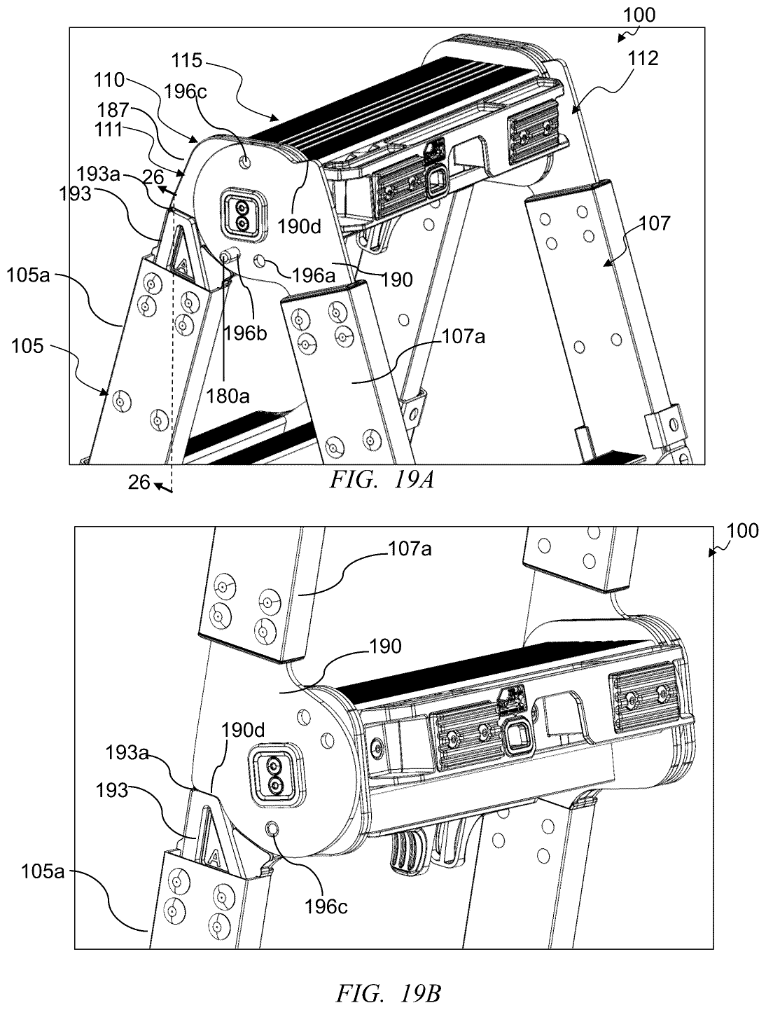

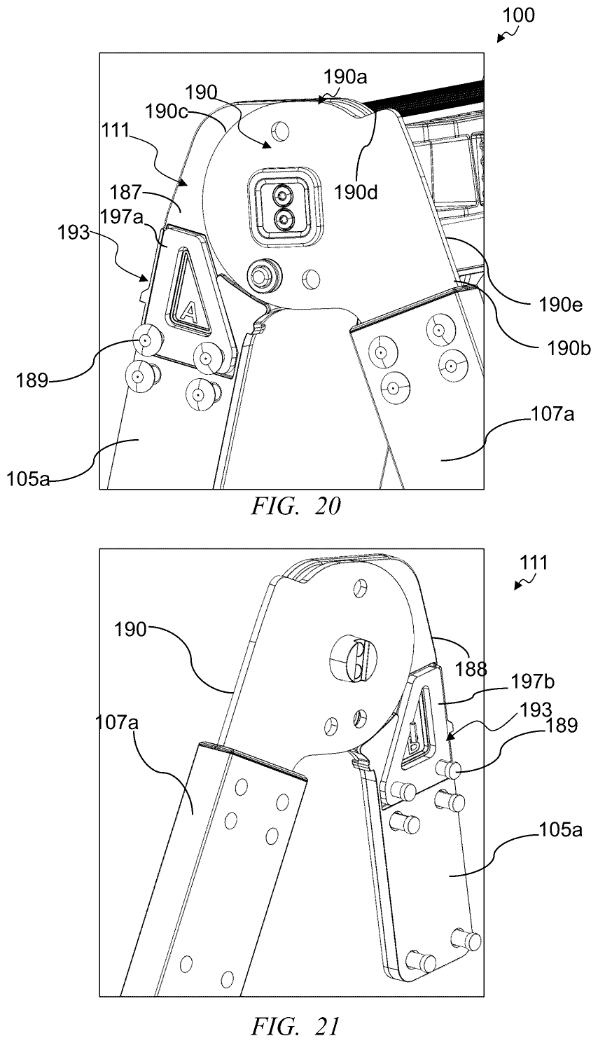

The first hinge 111 includes a plurality of slim hinge plates, including a rotational plate 190, first and second inner fixed plates 185, 187 inward from the rotational plate 190, and first and second outer fixed plates 186, 188 outward from the rotational plate 190. Each of the plates has a disc-like hinge portion through which the pivot 161 extends and an elongated rail insert portion sized to be received in the rails. Thus, as shown, the hinge plates may generally have a “P” shape. As an example, FIG. 8C illustrates one of the hinge plates (specifically, the first inner fixed hinge plate 185), showing the hinge portion 185a and the rail insert portion 185b. The hinge portion 185a has a generally rounded polygonal shape with a central pivot hole 185c for the pivot 161 and a locking pin hole 185d positioned radially outward of the pivot hole 185c. The other fixed plates 187, 186, 188 may have these same holes and the same shape. The rotational plate 190 (See FIGS. 19A and 20) has a hinge potion 190a that is partially circular, a rail insert portion 190b, a central pivot hole (not shown), and three locking pin holes 196a, 196b, 196c that correspond respectively to the folded/leaning ladder position, the stepladder position, and the straight ladder position.

With reference again to FIG. 17, the inner and outer fixed plates 185, 187, 186, 188 are coupled to the first rail 105a of the second ladder section 105. For instance, the rail insert portions thereof may be inserted at least in part within the first rail 105a. A plurality of fasteners 191 may extend through respective holes in the first rail 105a and the fixed plates to fix the fixed plates 185, 187, 186, 188 to each other and to the rail 105a.

The rotational plate 190 is coupled to the first rail 107a of the fourth ladder section 107, with the rail insert portion 190b (FIG. 20) received at least in part within the first rail 107a. In some approaches, rail spacer plates 194, 195 are also included within the first rail 107a flanking the rotational plate 190. Fasteners may extend through holes in the rail insert portion 190b, the first rail 107a, and the rail spacer plates 194, 195.

In the illustrated approach, the first inner fixed plate 185 and the first outer fixed plate 186 (positioned as the innermost and outermost plates of the hinge 111, respectively) may be a metal material such as aluminum. The second inner fixed plate 187 and the second outer fixed plate 188 may function at least in part as spacer plates and, may be formed from, e.g., a metal (such as aluminum) or a plastic. In an illustrative embodiment, the second inner fixed plate 187 and the second outer fixed plate 188 are formed from polypropylene or another molded polymer. The rotational plate 190 may be formed from a metal such as steel or aluminum.

In certain approaches, there may only be one inner fixed plate and only one outer fixed plate.

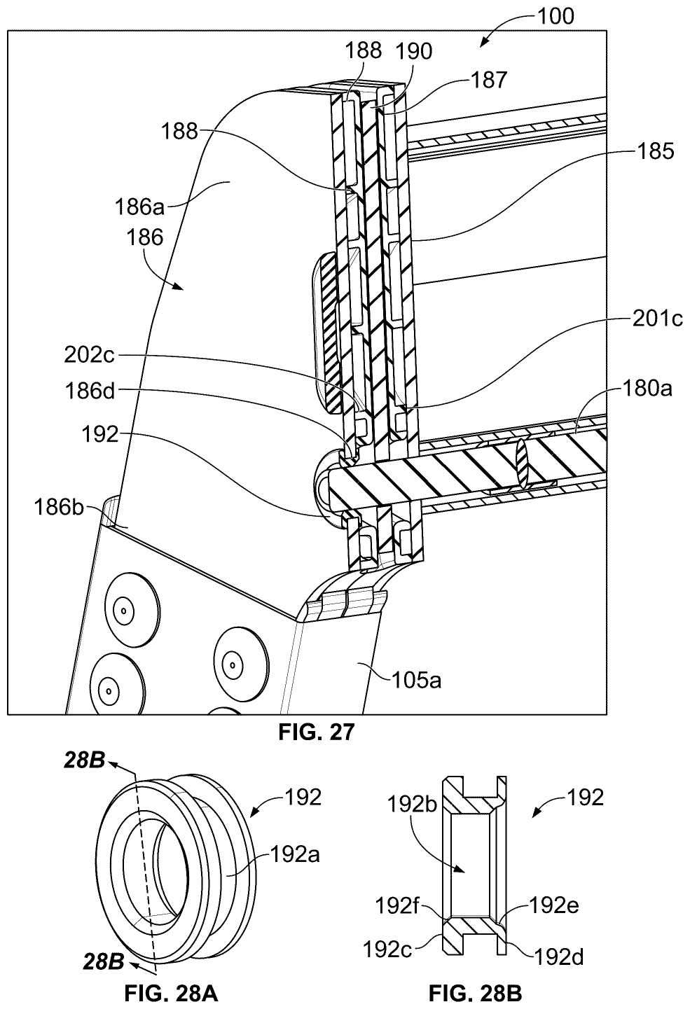

With reference to FIGS. 27-28B, a bushing 192 may be included in the hinge 111. In some approaches, the bushing 192 is installed within the locking pin hole 186d of the first outer fixed plate 186. The bushing 192, in some approaches, is formed from a hard metal such as machined steel and serves to strengthen the locking pin hole 186d to prevent deformation thereof over time and use of the ladder. For instance, locking pin holes can experience considerable straight and impact when the ladder 100 is dropped down from a straight position to the stepladder position, which can distort the shape of the hole 186d, leading to increased slack in the hinge 111. With the bushing 192 in the locking pin hole 186d, the locking pin hole 186d is reinforced and experiences reduced deformation over time. For instance, in an illustrative embodiment, the locking pin hole 186d with the bushing 192 installed can undergo at least 6,000 cycles before deformation occurs, wherein a “cycle” includes configuring a ladder from a closed position to a stepladder position, to a straight position, back to the stepladder position, and then back to the closed position.

Specifically, the bushing 192 may have an annular body 192a defining a hole 192b, a first annular flange 192c extending radially outwardly at one end thereof, and a second annular flange 192d extending radially outwardly at the opposite end thereof. In some approaches, the first and second annular flanges 192c, 192d extend a similar or the same radial width from the body 192a. The flanges 192c, 192d are sized to remain outside the locking pin hole 186d in engagement with the outer surfaces of the plate 186. A distance between the first and second annular flanges 192c, 192d is selected to generally correspond to a thickness of the plate 186 so that the plate 186 fits tightly with a friction fit between the first and second annular flanges 192c, 192d. In some approaches, the first annular flange 192c, positioned at the exterior side of the plate 186, is more than double the thickness of the second annular flange 192d.

As shown in FIG. 28B, the hole 192b of the bushing 192 may also include an angled inboard portion 192e and an angled outboard portion 192f, so that the hole 192b angles outwardly at each end of the bushing 192. This angling permits smoother operation of the locking pin. For instance, the angled inboard portion 192e of the bushing 192 provides a wider, gradual lead-in into the hole 192b from the inside of the hinge 111 to guide the locking pin towards the center.

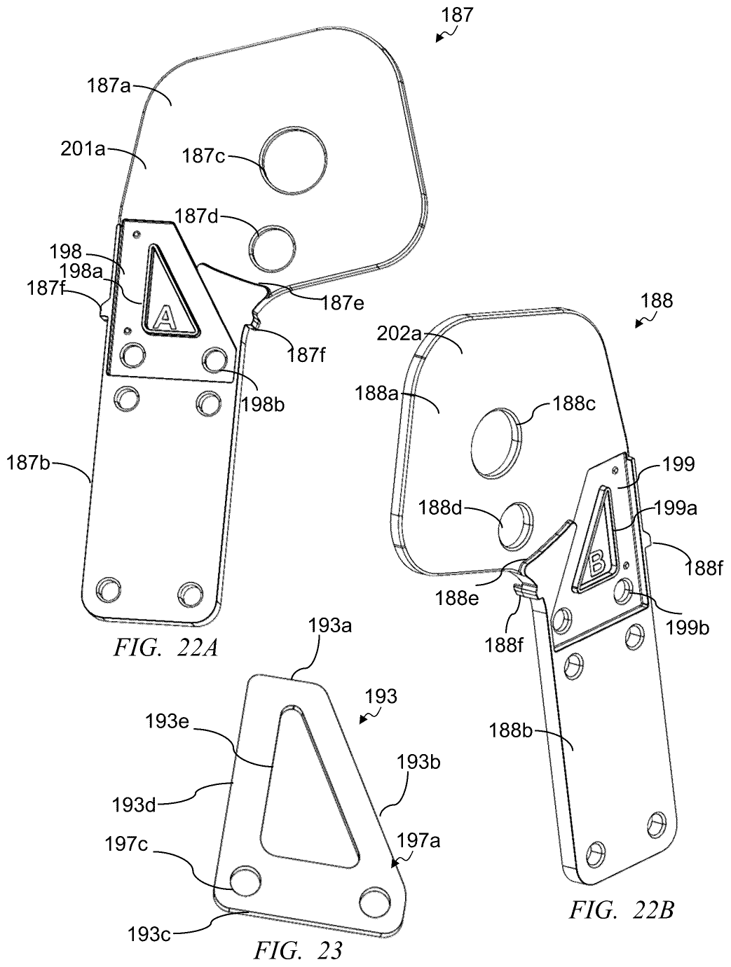

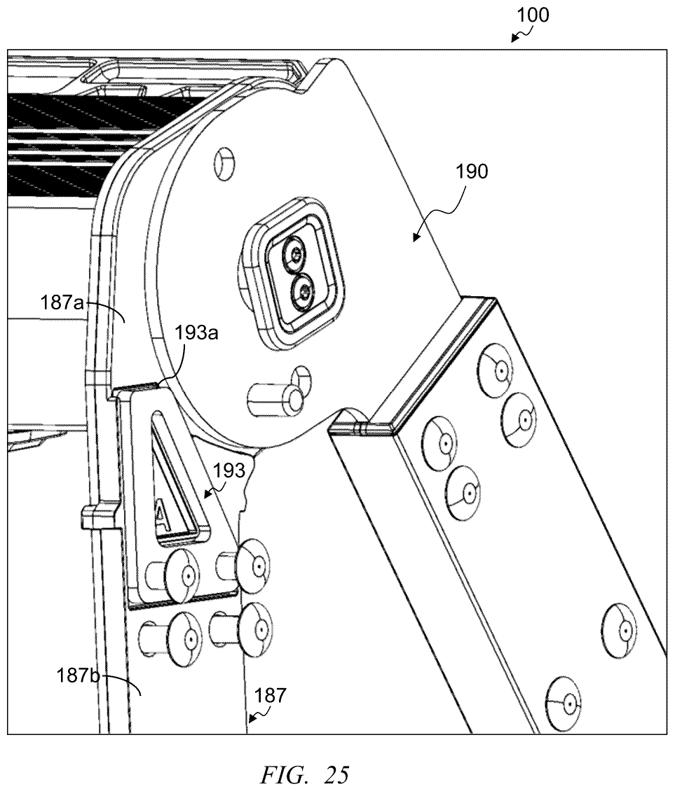

With reference to FIGS. 19A-26, the hinge 111 further includes an inner strengthening or stiffening plate 193. The strengthening plate 193 functions to engage the rotational plate 190 when the rotational plate 190 is moved to the straight position of the ladder 100 and to stop further rotation of the rotational plate in the direction of the strengthening plate 193. The engagement between the rotational plate 190 and the strengthening plate 193 provides resistance against lateral forces to the hinge 111 when the ladder 100 is in the straight position.

For instance, the ANSI (American National Standards Institute) Horizontal Ultimate Load Bend Test simulates the forces a ladder might experience during normal use. This test can be part of determining the ultimate load capacity of the ladder. In the test, the ladder is positioned horizontally and securely supported at both ends to simulate the lateral stresses it would encounter during typical use. A force is progressively applied to the middle or designated points along the ladder's length to mimic side loads that could cause bending. Instruments measure the force and deflection until the ladder reaches its ultimate load capacity or fails, ensuring it meets safety standards. For a multi-position ladder in the straight position (in which the front section 102 and rear section 103 are positioned at about a 180 degree angle relative to one another), the hinge 111 is at the middle of the ladder's length and can be particularly vulnerable to lateral forces and consequent bending or swinging out of the front section 102 and rear section 103. The strengthening plate 193, however, improves the performance of the ladder 100 with respect to the Horizontal Ultimate Load Bend Test. Specifically, analytic FEA testing found minimized stress concentrations on the hinge plates during analytic testing when the strengthening plate 193 is present compared to when the strengthening plate 193 is absent.

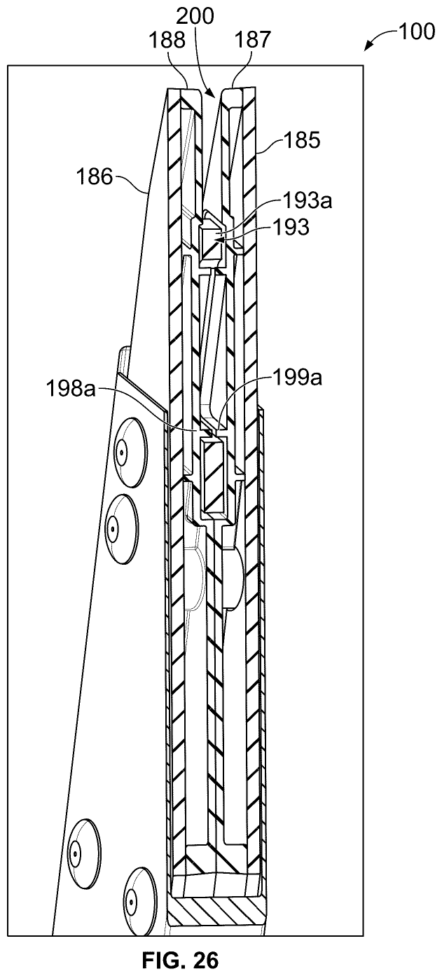

As shown in FIG. 26, the strengthening plate 193 is typically positioned, at least in part, within a gap 200 between the second inner fixed plate 187 and the second outer fixed plate 188 that is also occupied by the rotational plate 190. Specifically, the strengthening plate 193 may be positioned at an interface between the respective hinge portions 187a, 188a and the respective rail insert portions 187b, 188b of the second inner fixed plate 187 and the second outer fixed plate 188. A top surface 193a of the strengthening plate 193, in some approaches, is radially positioned to be engaged by the rotational plate 190 when the rotational plate 190 is rotated to the straight position of the ladder 100 and to be disengaged by the rotational plate 190 when the rotational plate 190 is rotated in the opposite direction and away from the straight position of the ladder 100.

FIG. 19A shows the ladder 100 in a stepladder position, with the first and second outer fixed hinge plates 186, 188 removed to see inside the hinge 111. When the rotational plate 190 is in the stepladder position, with the locking pin 180a inserted in the locking pin hole 196b corresponding to the stepladder position, a radially protruding surface 190d of the rotational plate 190 is disengaged from the top surface 193a of the strengthening plate 193. When the ladder is in the straight position, as shown in FIG. 19B, with the locking pin 180a inserted in the locking pin hole 196c corresponding to the straight position, the radially protruding surface 190d of the rotational plate 190 is engaged by the top surface 193a of the strengthening plate 193. When the hinge 111 is subjected to lateral forces that may cause bending of the front section 102 and the rear section 103 of the ladder 100, the top surface 193a of the strengthening plate 193 acts as a stop that prevents additional movement of the rotational plate 190 in the direction of the strengthening plate 193 and thus alleviates strain on the locking pin holes of the hinge 111.

More specifically, the rotational plate 190, as described above, includes a hinge portion 190a and a rail insert portion 190b. The hinge portion 190a includes a rounded or circular portion 190c and a shoulder 190f extending outwardly from the circular portion 190c. The shoulder 190f defines the radially protruding surface 190d positioned to engage the top surface 193a of the strengthening plate 193. The rotational plate 190 may further include a straight edge 190e extending from the rail insert portion 190b up towards the shoulder 190f. The radially protruding surface 190d may be substantially perpendicular to the straight edge 190e.

The distance between the straight position locking pin hole 196c and the radially protruding surface 190d is about the same as the distance between the top surface 193a of the strengthening plate 193 and the locking pin holes 187d, 188d of the second inner fixed plate 187 and the second outer fixed plate 188. A length of the radially protruding surface 190d may be about the same as a length of the top surface 193a of the strengthening plate 193. The radially protruding surface 190d and the top surface 193a of the strengthening plate 193 may both be linear surfaces and squarely engage one another. A thickness of the top surface 193a of the strengthening plate 193 may be about the same as or slightly larger than a thickness of the radially protruding surface 190d. In some approaches, the thickness of the entire strengthening plate 193 may be about the same or slightly larger than a thickness of the entire rotational plate 190.

In some approaches, the strengthening plate 193 has a generally triangular outer shape. A first side 193c of the plate 193 may be about 90 degrees with respect to a second side 193d of the plate 193 and a third side 193b of the plate may be extend between the first side 193c and the second side 193d and at an angle with respect to each. Instead of a triangular angle between the first side 193c and the third side 193b and between the second side 193d and the third side 193b, these portions may instead be squared off. Specifically, the squared off portion between the second side 193d and the third side 193b defines the top surface 193a of the strengthening plate 193.

In some approaches, the strengthening plate 193 includes a triangular hole 193e. Other shapes of the hole are possible. In the illustrated approach, the triangular hole 193e is an interlocking feature that engages corresponding triangular ribs 198a 199a of the second inner fixed plate 187 and the second outer fixed plate 188 for proper registration of the plate 193. The strengthening plate 139 may also include one or more holes 197c (e.g., two) for fasteners, the one or more holes aligned with corresponding holes of the inner and outer fixed plates 185, 187, 186, 188 and the rail 105a to couple the strengthening plate 193 to the inner and outer fixed plates 185, 187, 186, 188 and the rail 105a. For instance, the second inner fixed plate 187 and the second outer fixed plate 188 may each include a plurality of holes 198b, 199b. The holes and fasteners may be positioned in the rail insert portions 185b, 187b, 186b, 188b of the inner and outer fixed plates 185, 187, 186, 188.

The second inner fixed plate 187 and the second outer fixed plate 188 each have a first side 201a, 202a and a second side 201b, 202b. On the first side 201a, 202a of each is a respective recess 198, 199 sized and shaped to partially receive the strengthening plate 193 so that the strengthening plate 193 is sandwiched between the second inner fixed plate 187 and the second outer fixed plate 188 within the recesses 198, 199, with a first side 197a of the strengthening plate 193 engaging the second outer fixed plate 188 and a second side 197b engaging the second inner fixed plate 187. For instance, about half the thickness of the strengthening plate 193 may be disposed in the first recess 198 and about half the thickness of the strengthening plate 193 may be disposed in the second recess 199. The plurality of holes 198b, 199b for fasteners may be disposed within the respective recesses 198, 199.

As noted above, the triangular ribs 198a, 199a may be disposed in the recesses 198, 199. As shown in FIG. 26, the triangular ribs 198a, 199a may engage one another when the hinge 111 is assembled. The second inner fixed plate 187 and the second outer fixed plate 188 typically do not engage one another above the top surface 193a of the strengthening plate 193. As noted above, this gap 200 between the second inner fixed plate 187 and the second outer fixed plate 188 provides space for rotation of the rotational plate 190 and, more specifically, allows the radially protruding surface 190d of the rotational plate 190 to engage the exposed top surface 193a of the strengthening plate 193.

The second inner fixed plate 187 and the second outer fixed plate 188 may further include a raised guide 187e, 188e positioned under the hinge portion 190a of the rotational plate 190.

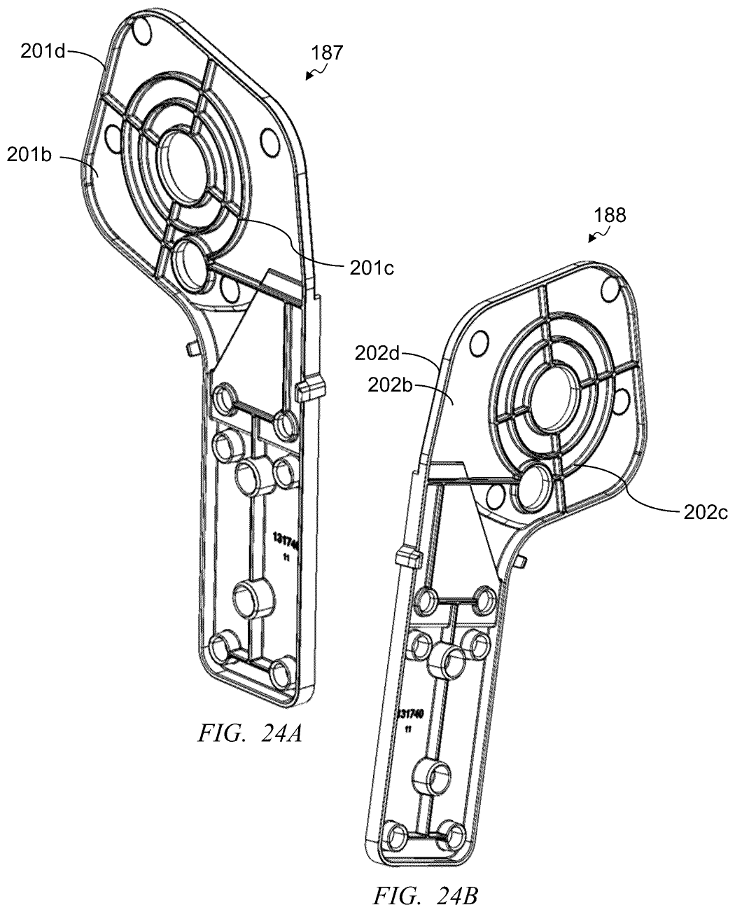

A second side 201b, 202b of each of the second inner fixed plate 187 and the second outer fixed plate 188 may have a peripheral upstanding rim 202d (see, e.g., FIG. 24A, 24B) which engages the first inner fixed plate 185 and the first outer fixed plate 186, respectively, and spaces the main body of the second inner fixed plate 187 and the second outer fixed plate 188 respectively from the first inner fixed plate 185 and the first outer fixed plate 186. A plurality of strengthening or support ribs 202c are also present in the second side 201b, 202b for various purposes, such as to support the various holes and other structures.

The second inner fixed plate 187 and the second outer fixed plate 188 may each have one or more protrusions 187f, 188f positioned to stop further insertion of the rail insert portions 187b, 188b into the rail 105a to maintain the second inner fixed plate 187 and the second outer fixed plate 188 properly positioned.

Other geometries of the strengthening plate 193 are possible besides the illustrated geometry. In addition, in some approaches the strengthening plate 193 may not be a separate plate 193 and may be an integral part of one or both of the second inner fixed plate 187 and the second outer fixed plate 188.

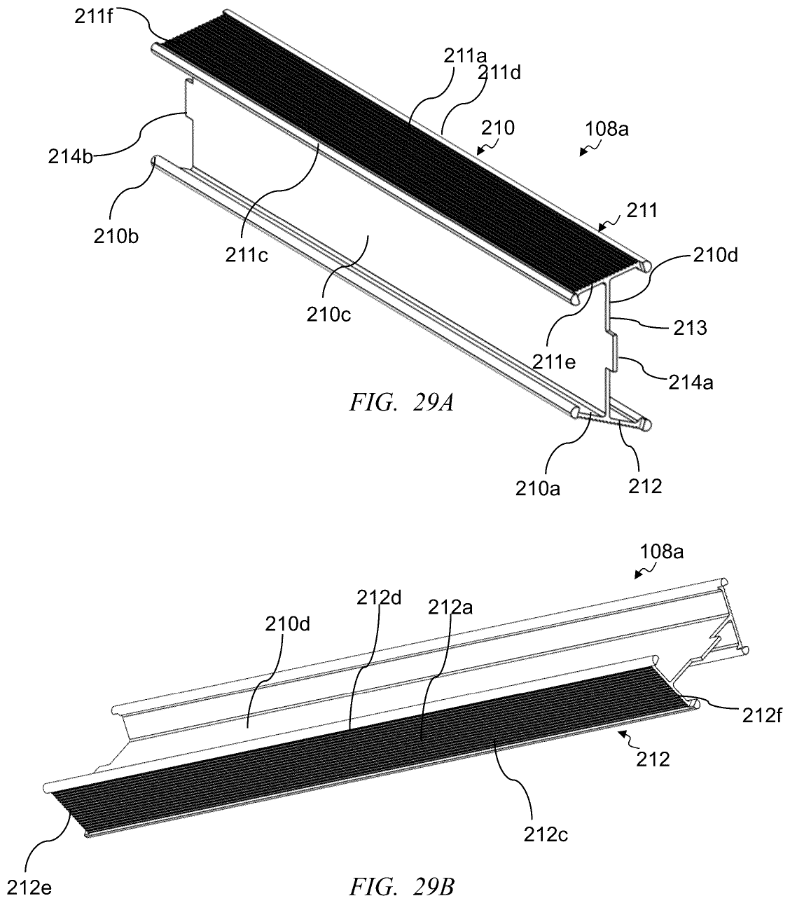

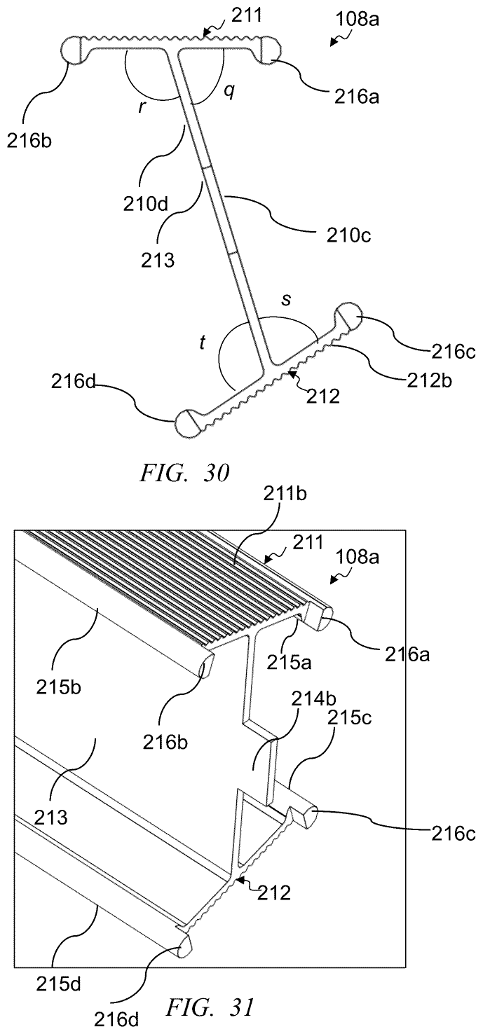

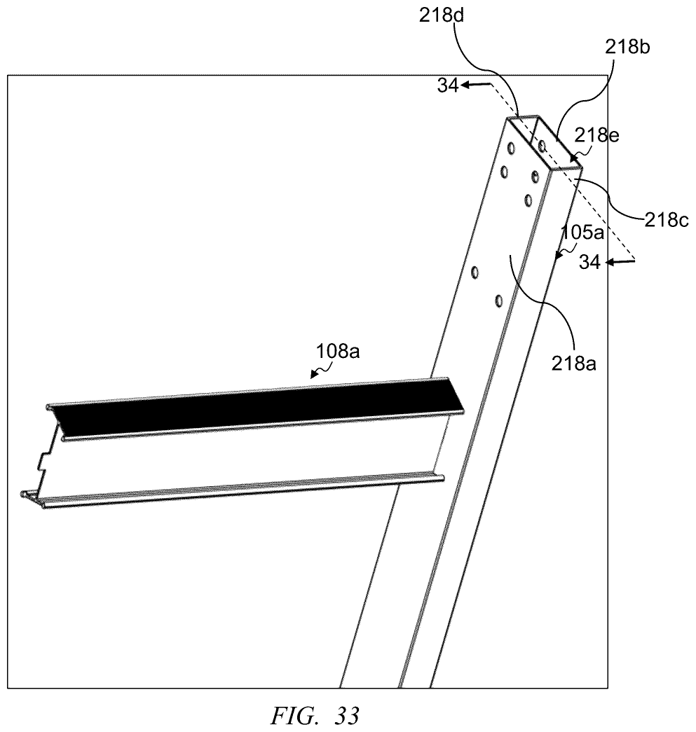

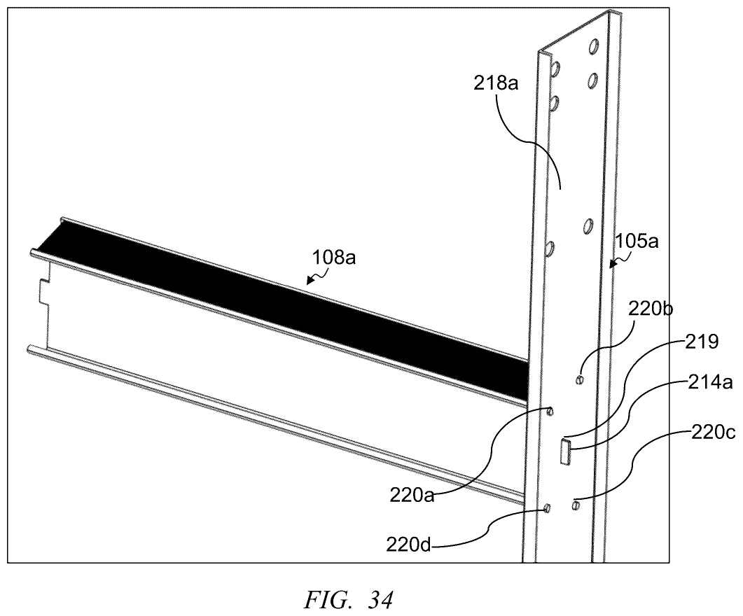

The rungs employed with the ladders described herein may have a variety of configurations and may be uniform or distinct from one another. One such rung is shown in FIGS. 1, 2, and 29A-35, which illustrates an inner rung 108a of the second ladder section 105 of the ladder 100 that may have a generally “I” shape or profile. While the inner rung 108a is specifically shown, which is the topmost inner rung 108 of the second ladder section 105, it will be appreciated that the rest of the inner rungs (e.g., 108b, 108c, 108d) of the second ladder section 105 may also have the same configuration, as well as the inner rungs 121 of the fourth ladder section 107. However, in an illustrative approach, all of the inner rungs 108, 121 of the ladder 100 have the same configuration except for the bottommost inner rungs (e.g., in this case, 108d and 121a) of the second ladder section 105 and the fourth ladder section 107, which are modified to incorporate a rail lock assembly 240 (described further below).

The inner rung 108a has a generally I-shaped body 210. The inner rung 108a includes a first step 211 that has a generally rectangular, flat shape, a second step 212 below the first step 211 that has a generally rectangular, flat shape, and a central web 213 extending vertically between the first step 211 and the second step 212, also having a generally rectangular, flat shape. As illustrated, the central web 213 may bisect the first step 211 and the second step 212.

As shown, the first step 211 has a main outer surface 211a that includes treading 211b, as well as a first lengthwise side 211c, a second lengthwise side 211d opposite the first lengthwise side 211c, a first end side 211e, and a second end side 211f opposite the first end side 211e. The second step 212 has a main outer surface 212a that also includes treading 212b, as well as a first lengthwise side 212c, a second lengthwise side 212d opposite the first lengthwise side 212c, a first end side 212e, and a second end side 212f opposite the first end side 212e.

The first step 211 is positioned to be used when the second ladder section 105 is right-side up, while the second step 212 is positioned to be used when the second ladder section 105 is upside-down. Thus, the main outer surface 211a of the first step 211 and the main outer surface 212a of the second step 211 are positioned generally away from one another.

The central web 213 may extend an entire length of the first step 211 and the second step 212 and its side surfaces may be entirely smooth and flat (e.g., planar faces). For instance, the central web 213 may not include any channels or non-coplanar projections.

The central web 213 may engage or intersect the first step 211 and the second step 212 at oblique angles so that the first step 211 and the second step 212 are not parallel to one another. Instead, the first step 211 is angled in a first direction relative to the central web 213 and the second step 212 is angled in a second direction relative to the central web 213.

For instance, on a first side 210c of the inner rung 108a, an angle q defined between the first step 211 and the central web 213 may be less than 90 degrees and an angle s defined between the second step 212 and the central web 213 may also be less than 90 degrees. In some embodiments, q is equal to s. In some approaches, the angle of q and s is at most 80 degrees, at most 75 degrees, or at most 70 degrees. In some approaches, the angle of q and s is at least 50 degrees, at least 55 degrees, or at least 60 degrees.

On the second side 210d of the inner rung 108a, an angle r defined between the first step 211 and the central web 213 may be greater than 90 degrees and an angle/defined between the second step 212 and the central web 213 may be greater than 90 degrees. In some embodiments, r is equal to t. In some approaches, the angle of r and/is at least 100 degrees, at least 105 degrees, or at least 110 degrees. In some approaches, the angle of r and/is at most 130 degrees, at most 125 degrees, or at most 120 degrees.

The inner rung 108a may further include a plurality of flanges. For instance, a first flange 215a may extend from an entirety of the first lengthwise side 211c of the first step 211, projecting inwardly towards the second step 212. A second flange 215b may extend from an entirety of the second lengthwise side 211d of the first step 211, projecting inwardly towards the second step 212. A third flange 215c may extend from an entirety of the first lengthwise side 212c of the second step 212, projecting inwardly towards the first step 211. A fourth flange 215d may extend from an entirety of the second lengthwise side 212d of the second step 212, projecting inwardly towards the first step 211. In some approaches, the flanges are rod shaped with a rounded profile.

The flanges 215a, 215b, 215c, 215d may extend axially slightly past the length of the steps 212, 212 at both a first end 210a of the rung 208a and a second end 210b of the rung 208a. As a result, each of the first end 210a and the second end 210b includes four protrusions 216a, 216b, 216c, and 216d defined by the portions of the flanges 215a, 215b, 215c, 215d extending outwardly past the steps 212, 212. The protrusions 216a, 216b, 216c, and 216d function as locating or alignment pins for coupling the inner rung 108a to the rails, as described further below. In some non-limiting approaches, the protrusions have a semi-circular or circular profile, though other shapes are possible.

In some configurations, the inner rung 108a further includes a first tab 214a projecting axially from the central web 213 at the first end 210a of the rung 108a and a second tab 214b like the first tab 214a projecting axially from the central web 213 at the second end 210a of the rung 108a. The tabs 214a, 214b may be the same thickness as the central web 213 and have opposing surfaces that are coplanar with and extend continuously from the side surfaces of the central web 213. In some approaches, the tabs 214a, 214b have a generally rectangular shape and are sized to extend through a respective slot 219 in each of the rails to help maintain the rung 108a attached to the rails and provide extra points of attachment in case of welding failure.

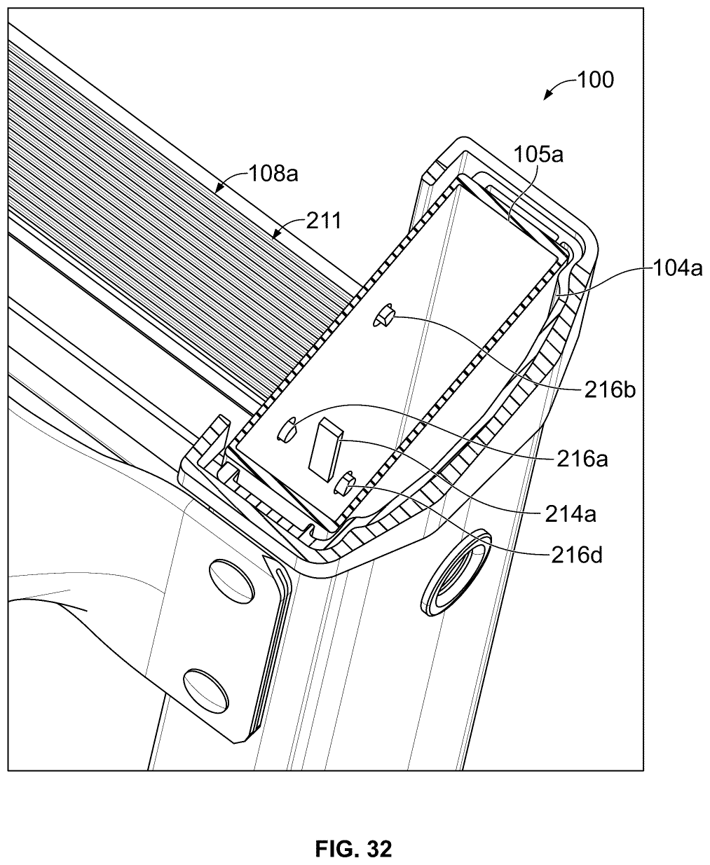

For instance, with specific reference to FIGS. 32-34, an exemplary rail 105a may have a rectangular profile and include a first inner wall 218a, a second outer wall 218b opposite the first inner wall, a third front wall 218c, and a fourth rear wall 218d opposite the third front wall 218c. A rectangular channel 218e of the rail 105a may be defined between the walls 218a, 218b, 218c, 218d. Four holes 220a, 220b, 220c, 220d may extend through the first inner wall 218a of the rail, sized and positioned to correspond to the protrusions 216a, 216b, 216c, 216d of the rung 108a. In addition, a slot 219 is present in the first inner wall 218a sized and positioned to correspond to the first tab 214a. When the rung 108a is assembled with the rail 105a, the first tab 214a at the first end 210a of the rung 108a extends through the slot 219 into the channel 218e of the rail 105a and the protrusions 216a, 216b, 216c, 216d extend through the four holes 220a, 220b, 220c, 220d into the channel 218e of the rail 105a so that the first step 211, second step 212, and central web 213 are flush against the exterior surface of the first inner wall 218a.

Though not shown, it will be appreciated that an opposing rail (e.g., rail 105b in FIG. 1) may have the same configuration as described for rail 105a yet in a mirror image, and may be coupled to the second end 210b of the rung 108a in the same manner as described above for the first end 210a.

The inner rung 108a may also be welded to the rail 105a. FIG. 35 illustrates a diagram of welding points of the second end 210b of the rung 108a to the rail 105b. In some approaches, a first weld 221 may be present at the connection between the rail 105b and the top of the first step 211, a second weld 222 may be present at the connection between the rail 105b and the top of the second step 212, and a third weld 223 may be present at the connection between the rail 105b and one side of the central web 213. The weld points of the inner rung 108a to the opposing rail 105a may be the same.

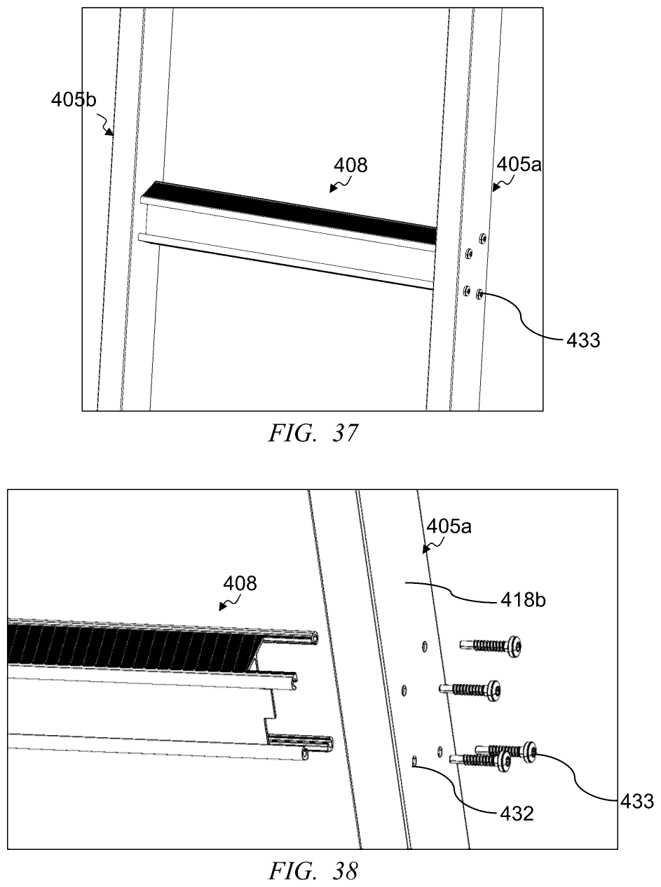

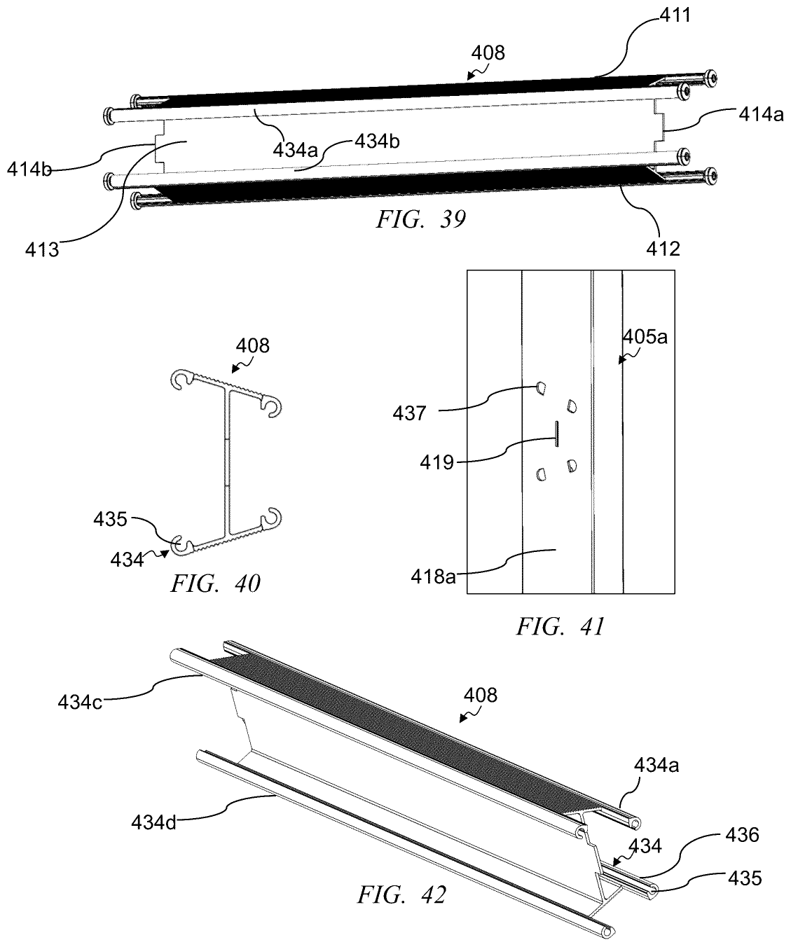

With reference to FIGS. 37-42, another embodiment of an inner rung 408 is illustrated. The inner rung 408 may not be welded to the rail, but may instead employ fasteners such as screws 433 to securely attach the rung 408 to the rails 405a, 405b. (In yet other configurations a combination of fasteners and weld points may be employed.) In the configuration of FIG. 37, the inner rung 408 may be the same as the inner rung 108a described above except for the structure of the flanges. For instance, instead of flanges 215a, 215b, 215c, 215d which are rod shaped, the flanges 434a 434b 334b 434d may each define a channel 435. In some approaches, the channel 435 extends an entire way through the flange, or at the very least, at a sufficient distance at each end of the flange to receive the end of a screw 433. Each of the flanges 434a 434b 334b 434d may also have a protruding channel portion 436 that extends past the steps 411, 412 and central web 413 to be inserted into corresponding holes 437 in the first inner wall 418a of the rails 405a, 405b. The protruding channel portions 436 may be sized to extend through the first inner wall 418a of the rail 405a, 405b into the channel of the rail 405a, 405b until the protruding channel portions 436 abuts an interior surface of the second outer wall 418b of the rail 405a, 405b. Additional holes 432 in the second outer wall 418b of the rail 405a, 405b, aligned with the protruding channel portions 436, may be present so that screws 433 may be inserted through the holes 432 and into each of the protruding channel portions 436 within the rails 405a, 405b.

As illustrated, the channels 435 defined by the flanges 434a 434b 334b 434d may have a partial circle shape. In other approaches, there may be a circular shape. The protruding channel portions 436 may have threading for engaging threading of the screws 433. The inner rung 408 may also include tabs 414a, 414b similar to the tabs 214a, 214b described above that are inserted through a respective slot 419 of the respective rails 405a, 405b.

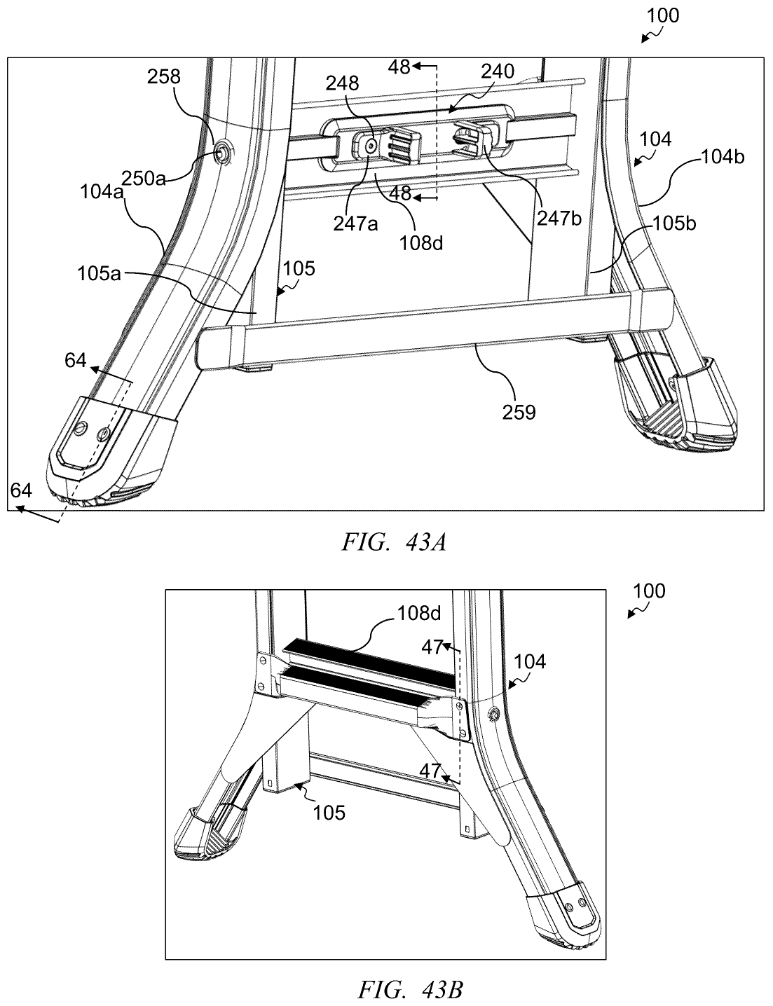

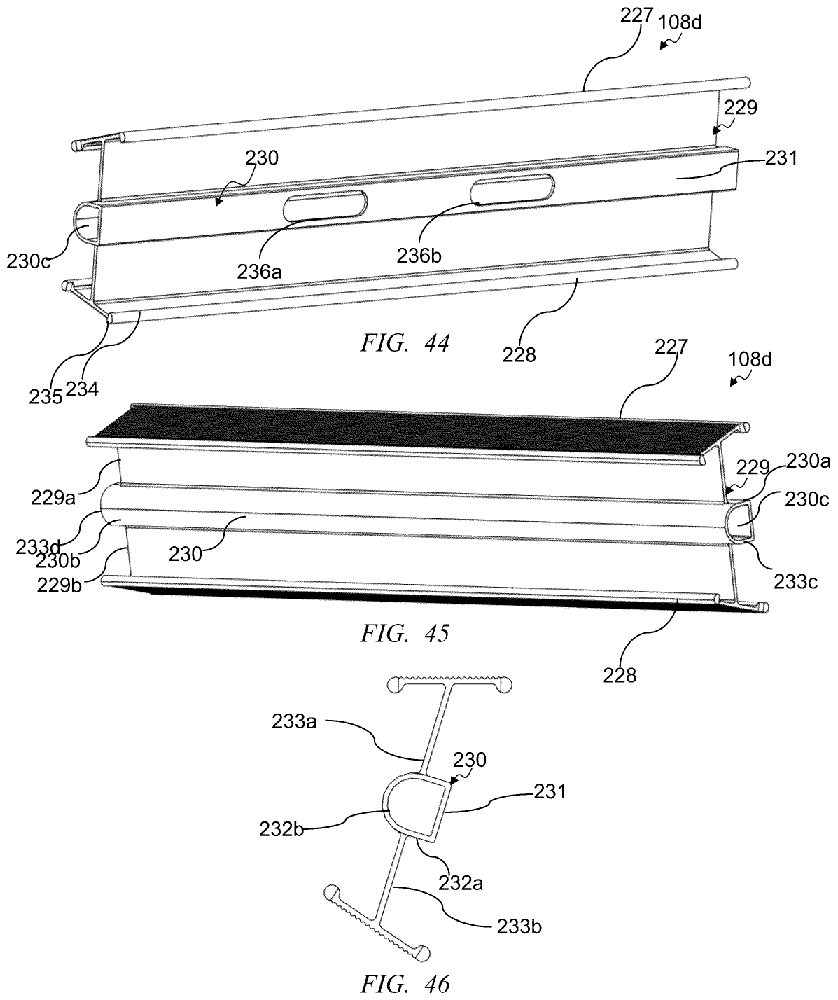

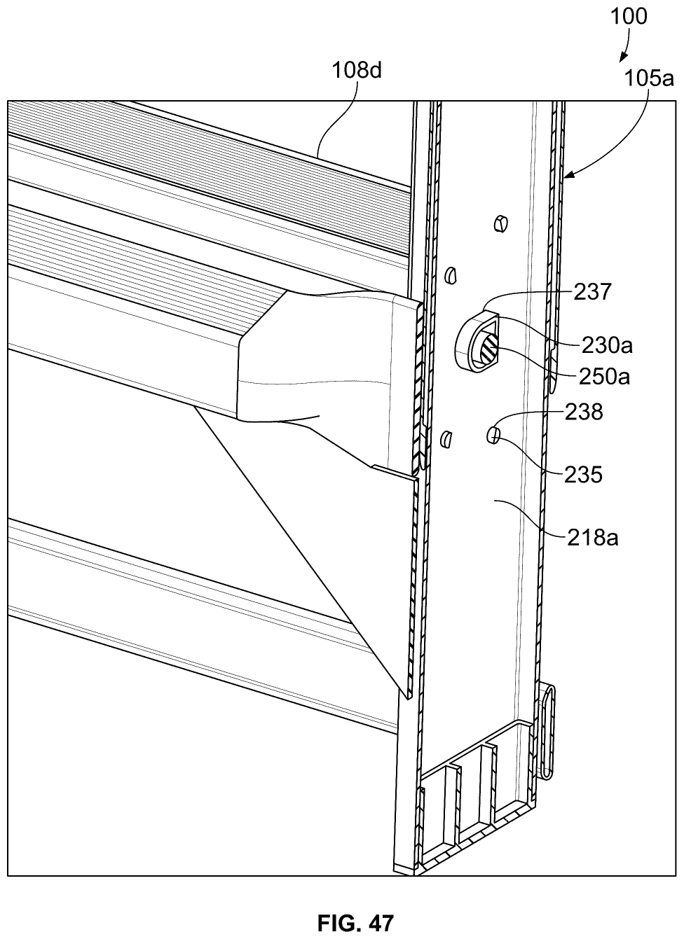

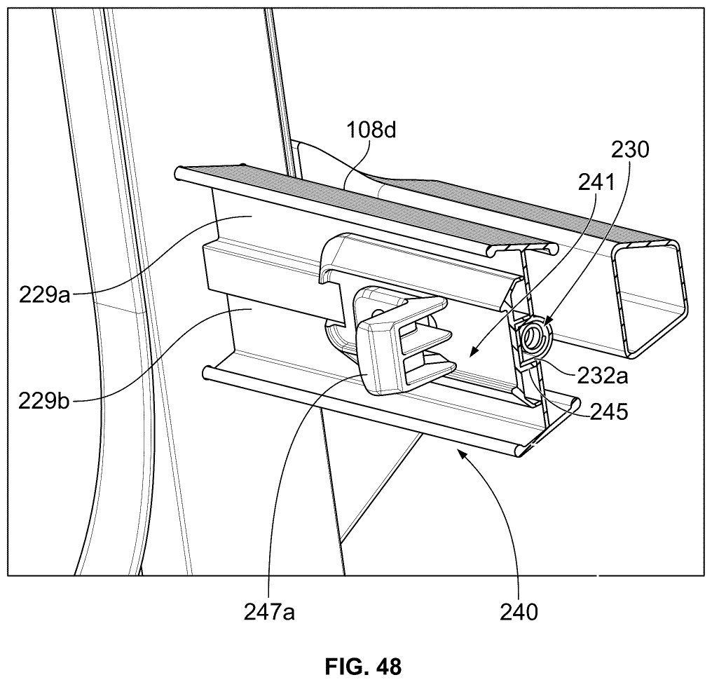

With reference to FIG. 43A and FIGS. 44-48, a bottommost inner rung 108d of the second ladder section 105, also referred to herein as a “locking inner rung”, may be designed to house a rail lock assembly 240 and thus may have a different configuration from the inner rungs 108a and 408 described above. It will be appreciated that the below description of the rail lock assembly 240 described for the second ladder section 105 also applies to a rail lock assembly in a bottommost “locking inner rung” that may be present in the fourth ladder section 107.

The locking inner rung 108d may be entirely the same as the inner rung 108a except for the absence of tabs 214a, 214b and instead the presence of an elongated channel or lock housing 230 extending an entire length of the rung 108d.

More specifically, instead of a completely flat or planar central web extending between a first step 227 and a second step 228, the central web 229 includes a first upper portion 229a, a second lower portion 229b, and the elongated channel or lock housing 230 extending between the first upper portion 229a and the second upper portion 229b, approximately at a midpoint between the first step 227 and the second step 228. The lock housing 230 may also protrude from the rung 108d relative to the steps 227, 228 and the central web 229. For instance, a first protruding portion 230a of the lock housing 230 may protrude from a first end of the central web 229 to be received within a respective hole 237 of a first rail 105a and a second protruding portion 203b of the lock housing 230 may protrude from a second end of the central web 229 to be received within a respective hole 237 of a second rail 105b.

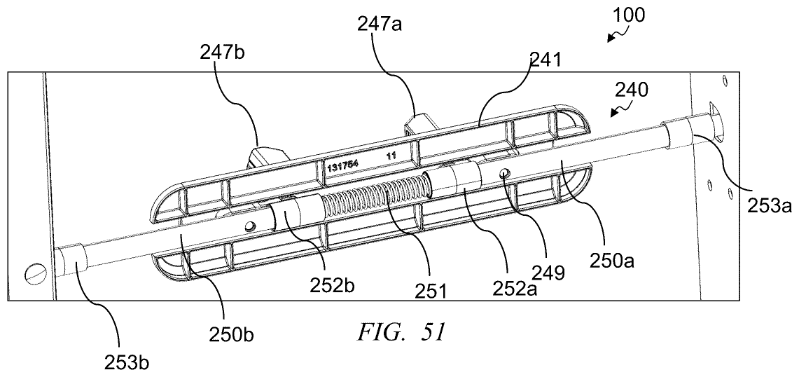

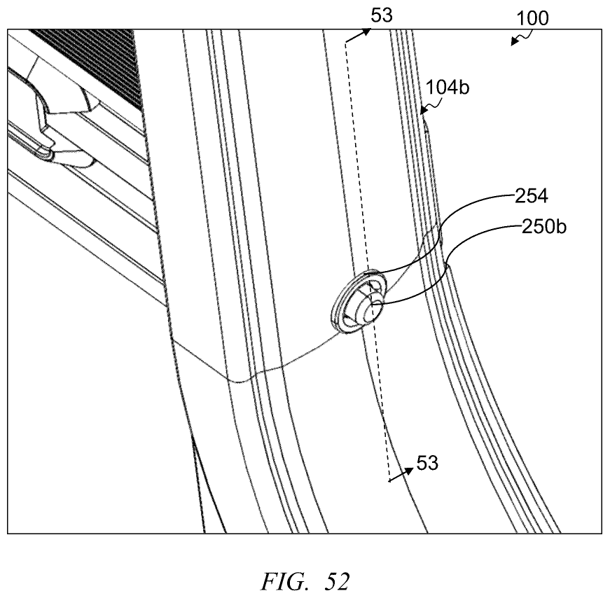

As shown in FIG. 45, the lock housing 230 includes an internal cavity 230c extending between a first end 233c of the lock housing 230 and a second end 233d of the lock housing 230. The first end 233c at the first protruding portion 230a may be open and the second end 233d of the lock housing 230 at the second protruding portion 230b may also be open to allow movement of respective locking pins 250a, 250b therethrough (FIG. 51) to lock and unlock the ladder rails. In some approaches, the lock housing 230 may project laterally outwardly relative to a first side 233a (e.g., a front side) of the central web 213 and to a second side 233b (e.g., a rear side) of the central web 213. At the first side 233a, the lock housing 230 may have a rounded portion 232a with a rounded profile. At the second side 233b, the lock housing may have a rectangular portion 232a with a squared off profile having a planar wall 231 that is substantially parallel to the central web 213. Thus, the lock housing 230 may, as a whole, have a half-oval shape. The curved shape of the lock housing 230 in the rung 108d allows the lock housing 230 to serve as a guide for the cylindrical locking pins 250a, 250b while the planar wall 231 serves as a mount for a sliding pinch lock, as described further below.

The locking inner rung 108d may be coupled to the inner rails 105a, 105b of the second ladder section 105 in a similar manner to that described about for inner rung 108a. The locking inner rung 108d typically includes flanges 234 and protrusions 235 like those of inner rung 108a. The protrusions 235 are received within a plurality of corresponding holes 238 in the first inner wall 218a of the inner rails 105a, 105b for proper alignment. Instead of the tab described above with respect to inner rung 108a, the locking housing 230 has the first and second protruding portions 230a, 230b which serve a similar purpose. The first and second protruding portions 230a, 230b are received within respective holes 237 of the first inner wall 218a of the inner rails 105a, 105b for alignment and to help maintain the rung 108d coupled to the inner rails 105a, 105b.

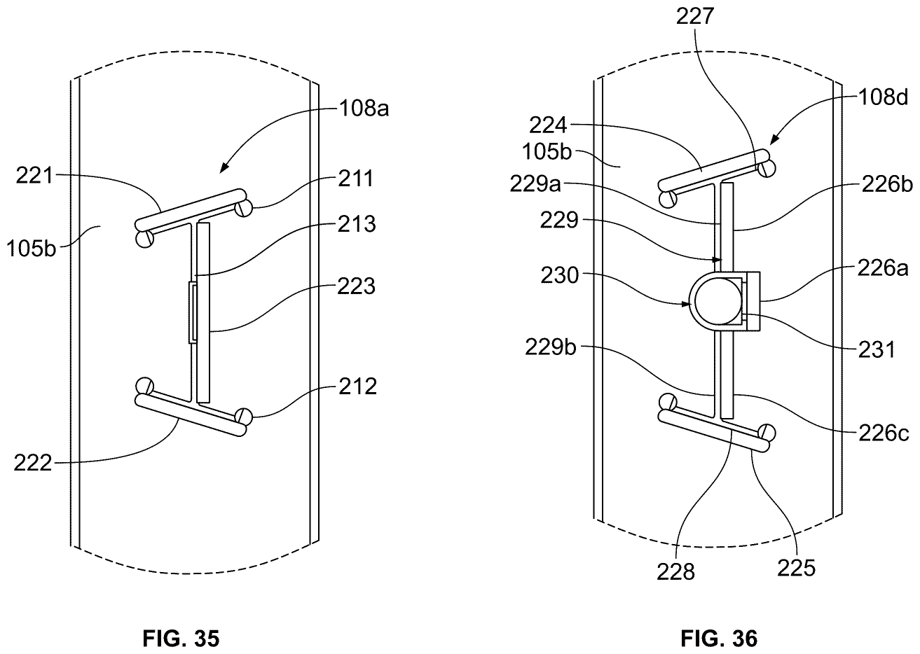

A diagram of the weld points of the locking inner rung 108d, according to one approach, is shown in FIG. 36. A first weld 224 may be present at the connection between the rail 105b and the top of the first step 227, a second weld 225 may be present at the connection between the rung rail and the top of the second step 228, and a third weld 226a may be present at the connection between the rail 105b and the planar wall 231 of the locking housing 230, a fourth weld 226b may be present at the connection between the rail 105b and one side of the upper portion 229a of the central web 229, and a fifth web 226c may be present at the connection between the rail 105b and one side of the lower portion 229b of the central web 229. The weld points of the locking inner rung 108d to the opposing rail 105a may be the same.

In other approaches, the locking inner rung 108d may use screws for connection with the rails 105a, 105b such as in the manner described above with respect to inner rung 408.

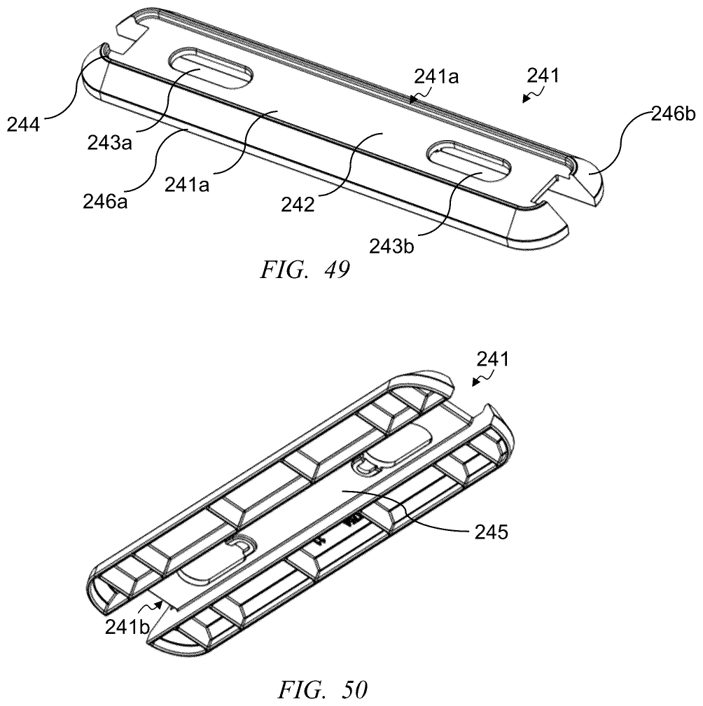

With reference to FIGS. 43A-45, and 48-51, the rail lock assembly 240 has a similar pinch or squeeze lock mechanism to the sliding hinge lock assembly 113 described above. The lever handles 247a, 247b, for instance, may be the same as the lever handles 130a, 130b described above. The locking pins 250a, 250b within the lock housing 230 may each be mechanically coupled to respective lever handles 247a, 247b. The lock housing 230 includes two colinear, spaced elongated holes 236a, 236b in the planar wall 231 to permit mechanical connection between the locking pins 250a, 250b inside the lock housing 230 and the lever handles 247a, 247b outside the lock housing 230 where they can be accessed by the user. Specifically, the lever handles 247a, 247b extend laterally from a rear side of the rung 108d. The locking pins 250a, 250b may be biased by one or more biasing elements 251 (e.g., a spring) within the lock housing 230 away from one another and into a locked position and locked state of the inner rails 105a, 105b with respect to the outer rails 104a, 104b (or the second ladder section 105 with respect to the first ladder section 104). When the lever handles 247a, 247b are forced towards each other (or “squeezed together”), the biasing forces of the one or more biasing elements 251 are overcome, drawing the locking pins 250a, 250b out of respective holes 258 in the outer rails 104a, 104b to an unlocked state in which the inner rails 105a, 105b may be moved relative to the outer rails 104a, 104b to extend or retract the length of the ladder 100. Specifically, the rail lock assembly 240 can selectively engage and disengage locking pin holes 258 spaced along the first and second rails 104a, 104b of the first ladder section 104 to adjust the length of the front section 102. In some approaches, the rear section 103 has the same configuration and capability, with another rail lock assembly 240.

In some embodiments, the rail lock assembly 240 includes a sliding plate 241 coupled to an exterior surface of the planar wall 231 of the lock housing 230. The sliding plate 241 has an outwardly-facing first side 241a with a flat surface 242 and two elongated holes 243a, 243b aligned with the elongated holes 236a, 236b in the planar wall 231. There is a raised rim 244 around the lengthwise sides of the surface 242. Two lengthwise flange portions 246a, 246b extend downwardly from the rim 244 at an angle and at a second, opposite side 241b of the sliding plate 241 to respectively engage the upper portion 229a of the central web 229 and the lower portion 229b of the central web 229. The second side 241b of the sliding plate 241 includes a rectangular slot 245 defined in part and flanked by the two flange portions 246a, 246b, sized for snug engagement with the rectangular portion 232a of the lock housing 230. Portions of the lever handles 247a, 247b may extend into the two elongated holes 243a, 243b and slide therewithin, with fasteners 248 coupling the lever handles 247a, 247b to the respective locking pins 250a, 250b by a fastener 248 extending into respective holes 249 in the locking pins 250a, 250b. Similar to the sliding hinge lock assembly 113, there may also be one or more cylindrical sleeves or bushings 253a, 253b, 252a, 252b within the lock housing 230 to keep the locking pins 250a, 250b properly aligned, optimize sliding, and/or to retain the biasing element 251. For instance, these may be the same as described above with respect to sliding hinge lock assembly 113.

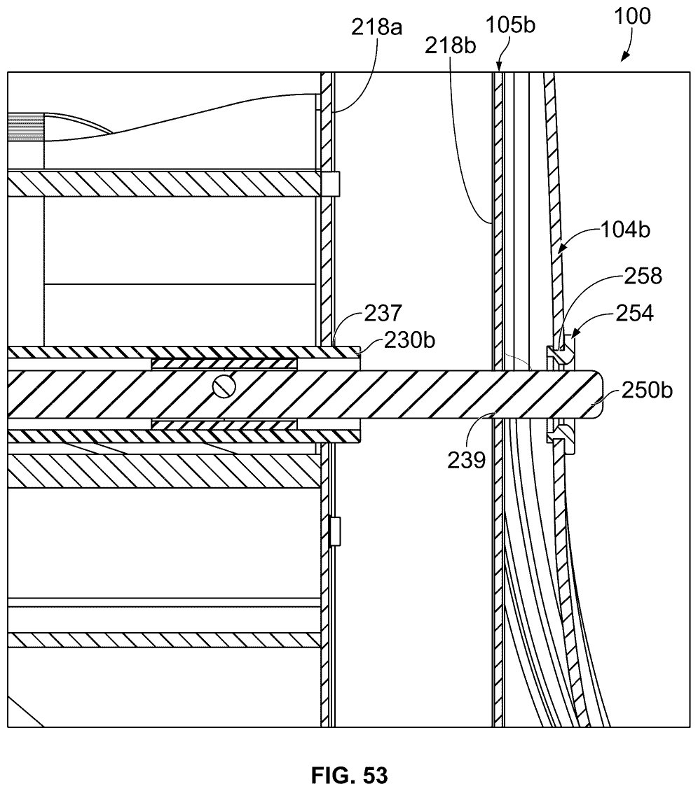

FIG. 53 shows locking pin 250b in a locked position of the rails 105b, 104b. The locking pin 250b extends through a hole 239 in the second outer wall 218b of the inner rail 105b and through a locking pin hole 258 in the outer rail 104b to lock the inner rail 105b with respect to the outer rail 104b.

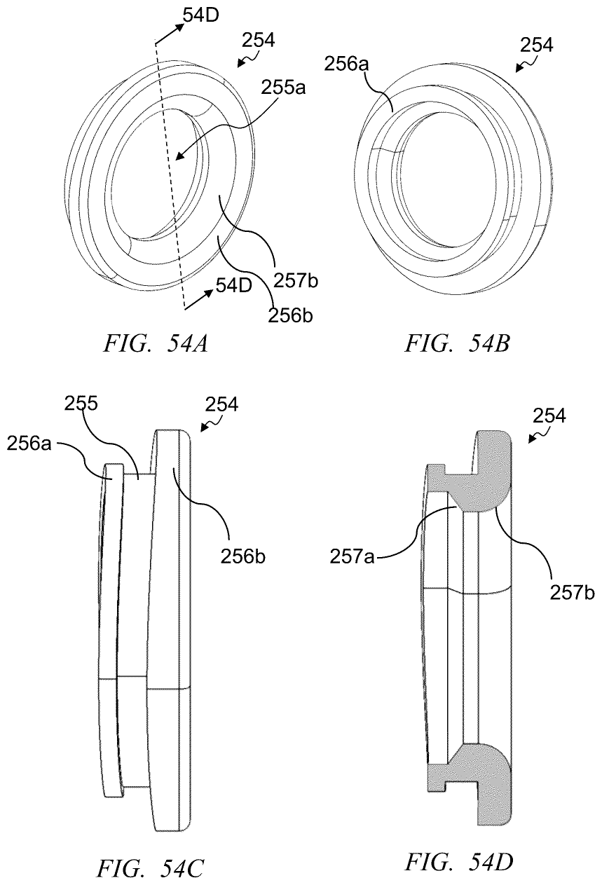

With reference to FIGS. 52-54D, a bushing 254 in a locking pin hole 258 of outer rail 104b is shown. It will be appreciated that this same bushing 254 may also be disposed in locking pin holes 258 of the other outer rails of the ladder 100, such as outer rail 104a, outer rail 106a, and outer rail 106b. The bushing 254 may have an annular body 255 defining a hole 255a, a first annular flange 256a extending radially outwardly at one end thereof, and a second annular flange 256b extending radially outwardly at the opposite end thereof. In some approaches, the second annular flange 256b has a greater radial extent than the first annular flange 256a. The flanges 256a, 256b are sized to remain outside the locking pin hole 258 of the outer rail 204b, with the first annular flange 256a hugging an inner side of the outer rail 104b and the second annular flange 256b hugging an outer side of the outer rail 104b. A distance between the first and second annular flanges 256a, 256b is selected to generally correspond to a thickness of the outer rail 104b so that the rail 104b fits tightly with a friction fit between the first and second annular flanges 256a, 256b. In some approaches, the second annular flange 256b, positioned at the outer side of the rail 104b, is about double or more than double the thickness of the first annular flange 256a.

The hole 255a of the bushing 254 may also include an angled inboard portion 257a and an angled outboard portion 257b, so that the hole 255a angles outwardly adjacent each end of the bushing 254. This angling permits smoother operation of the locking pins 250a, 250b (FIG. 51). For instance, the angled inboard portion 257a of the bushing 254 provides a wider, gradual lead-in into the hole 255a from the inside of the outer rail 104b to guide the locking pin 250b towards the center.

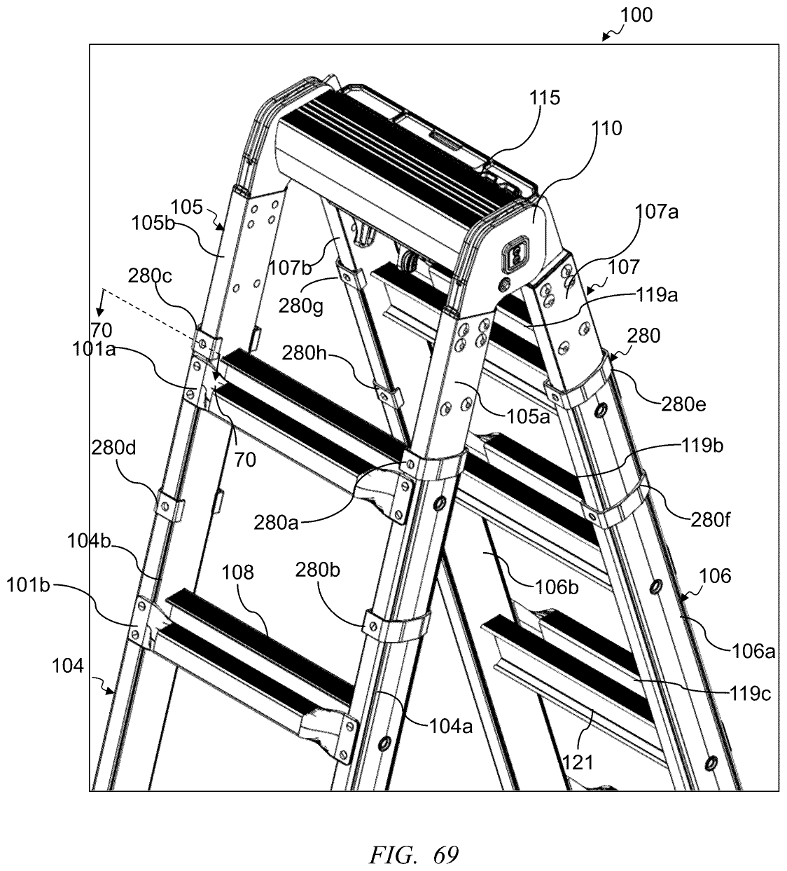

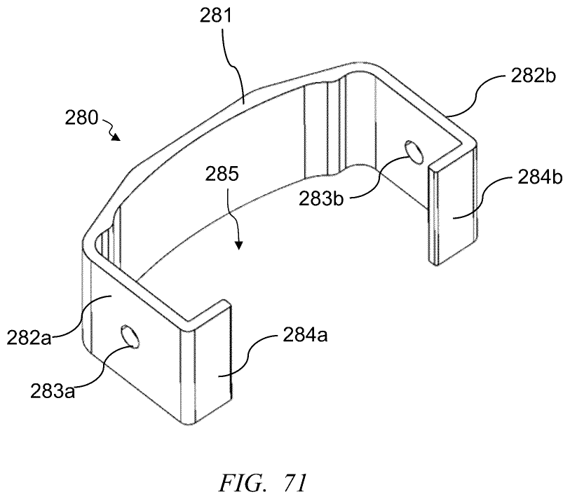

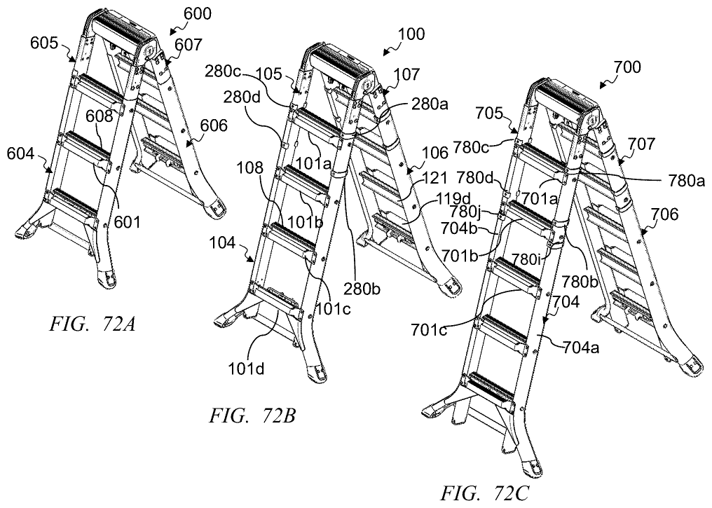

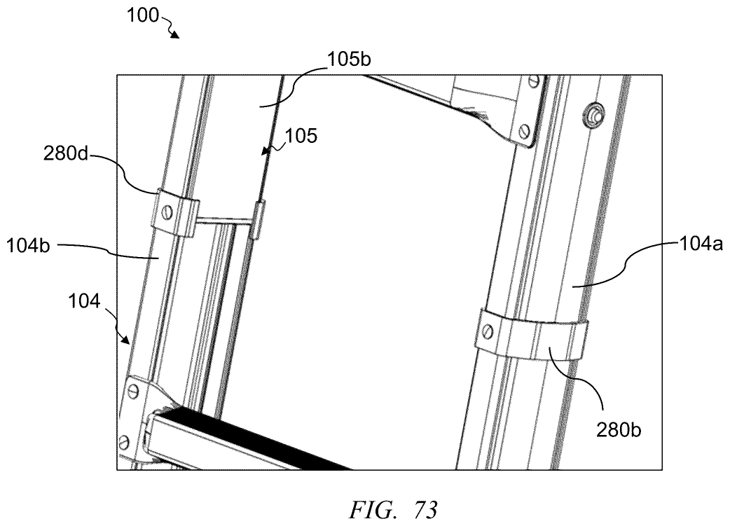

With reference to FIGS. 69-73, the ladder 100 may also include one or more braces 280. These braces 280 may be leveraged to reinforce and support the outer rails 104a, 104b, 106a, 106b of the ladder 100 when the inner rails 105a, 105b, 107a, 107b are extended from the outer rails 104a, 104b, 106a, 106b. For a medium-sized multi-position ladder 100 that has four rungs on each ladder section 104 105, 106, 107, as shown in FIGS. 69 and 72B, two braces 280 on each outer rail 104a, 104b, 106a, 106b may provide excellent reinforcement and protection against bending and deformation of the outer rails. In an illustrative configuration, a first brace 280a is positioned at the top of the first outer rail 104a of the first ladder section 104 just above the topmost rung 101a. A second brace 280b is positioned on the first outer rail 104a of the first ladder section 104 between the topmost rung 101a and the next rung 101b. A third brace 280c is positioned at the top of the second outer rail 104b of the first ladder section 104 just above the topmost rung 101a. A fourth brace 280d is positioned on the second outer rail 104b of the first ladder section 104 between the topmost rung 101a and the next rung 101b. Fifth, sixth, seventh, and eighth braces 280e, 280f, 280g, 280h may be positioned on the first and second outer rails 106a, 106b of the third ladder section 106 in the same configuration.

Advantageously, the use of the braces 280 reinforce the outer rails 104a, 104b, 106a, 106b sufficiently so that horizontal braces may not be needed between opposing outer rails 104a, 104b and between opposing outer rails 106a, 106b to prevent bending out and deformation of the outer rails. In an illustrative approach, only one horizontal brace 259 is present on each of the first ladder section 104 and the third ladder section 106, at the very bottoms of each, just above the feet. The lack of horizontal braces connecting higher portions of the 104a, 104b, 106a, 106b is important for a multi-position ladder having the bottom rail lock assembly 240 as described herein. When squeezing the lock and moving to extend the inner ladder sections 105, 107 along the length of the outer ladder sections 104, 106, there are no horizontal braces hindering the path and getting in the way of a hand that is clutching the lever handles 247a, 247b.

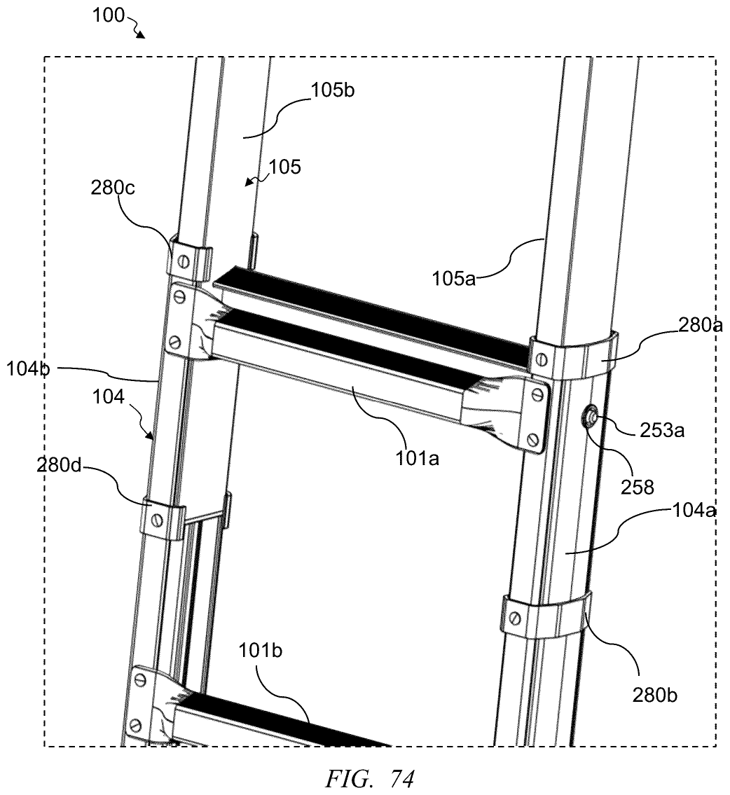

As shown in FIGS. 73 and 74, the second brace 280b and the fourth brace 280d may specifically be positioned on the respective outer rails 104a, 104b so that in an extended position of the ladder (e.g., extended straight or extended stepladder), when the inner ladder section 105 is extended its maximal extent with respect to the outer ladder section 104, the braces 280b, 280d support the transition between the terminal ends of the inner rails 105a, 105b and the adjacent portions of the outer rails 104a, 104b that are empty. This transition point along the length of the ladder when the ladder is fully extended is particularly subject to bending and deformation. For some configurations, a particularly located brace may provide reinforcement without unnecessary or excessive weight (e.g., without thickening the entire rail). For instance, as illustrated, an upper half or portion of the brace 280d wraps around the outer rail 104b and the terminal end of the inner rail 105b and a lower half or portion wraps only around the outer rail 104b. The brace 280b may have the same positioning.

In some approaches, braces 780b and 780d in the ladder 700 shown in FIG. 72C (described further below) may have the same positioning, supporting the transition from the ends of the inner rails when the inner section 705 is maximally extended from outer section 704. The braces on the rear sections of ladders 100 and 700 may also have this positioning. While the braces 280b, 280d are shown as extending over the end or terminus of the inner rails (e.g., having at least a portion above and below the terminal end of the inner rail), the braces 280b, 280d may also be adjacent to the terminus of the inner rails as well.

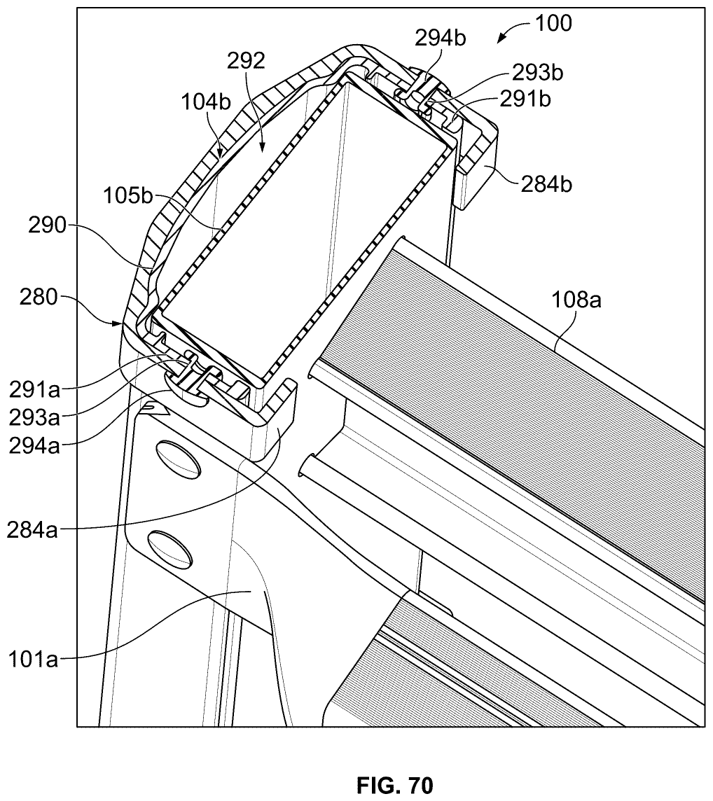

The brace 280 may be a collar brace with a C shape, having a main web 281, a first flange 282a extending from one end of the web 281, and a second flange 282b extending from an opposite end of the web 281, the first and second flanges 282a, 282b generally facing one another. The main web 281, first flange 282a, and second flange 282b may have a shape that generally corresponds to the outer rail 104a, 104b, 106a, 106b, which may, as shown in FIG. 70, may be a C-shaped rail having a main web 290, a first flange 291a, a second flange 291b, and a C-shaped channel 292 defined therewithin. A C-shaped channel 285 is also defined by brace 280, sized to receive the outer rail 104a, 104b, 106a, 106b.

A first retaining wall 284a may extend partially inwardly from a distal end of the first flange 282a and a second retaining wall 284b may extend partially inwardly from a distal end of the second flange 282b so that the brace slightly wraps around the inner rail 105a, 105b, 107a, 107b at its inner side, as shown in FIG. 70.

The brace 280, in some approaches, may be coupled to the outer rail 104a, 104b, 106a, 106b by fasteners such as rivets, screws, or bolts, among other options. For instance, there may be a first hole 283a in the first flange 282a of the brace 280 and a corresponding first hole 293a in the first flange 291a of the outer rail 104a, 104b, 106a, 106b, and a first fastener 194a may extend through both holes. There may also be a second hole 283b in the second flange 282b of the brace 280 and a corresponding second hole 293b in the second flange 291b of the outer rail 104a, 104b, 106a, 106b, and a second fastener 194b may extend through both holes.

As shown in FIGS. 72A, 72B, and 72C, multi-position ladders of different sizes may require more or less of the braces 280. For instance, a multi-position ladder 600 with only three rungs (e.g., 601, 608) on each section 604, 605, 606, 607 may not need any braces 280. As noted above, the multi-position ladder 100 with four rungs on each ladder section 104, 105, 106, 107 may have four braces 280 on each outer section, as described above. Multi-position ladder 700, with five rungs on each ladder section 704, 705, 706 707, may need additional braces. For instance, ladder 700 includes three braces on each outer rail to provide excellent reinforcement and protection against bending.

In some approaches, a ladder with at least four rungs on each ladder section (e.g., on an outer section 104 and an inner section 105) includes two or more braces 280 on each of the two outer rails 104a, 104b of the outer section 104, and a ladder with at least five rungs on each ladder section (e.g., on an outer section 104 and an inner section 105) includes three or more braces 280 on each of the two outer rails 104a, 104b of the outer section 104.

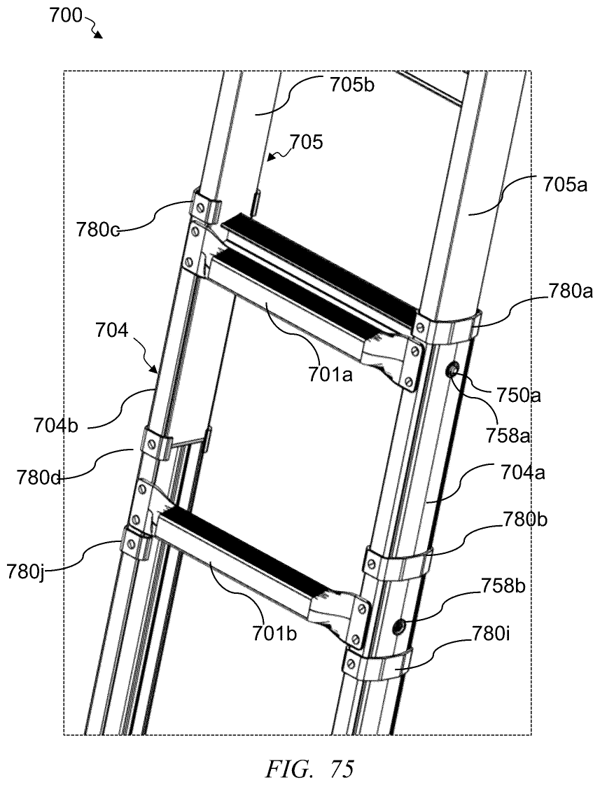

For instance, with reference to FIGS. 72C and 75, in an illustrative configuration of ladder 700, a first brace 780a is positioned at the top of the first outer rail 704a of the first ladder section 704 just above the topmost rung 701a. A second brace 780b is positioned on the first outer rail 704a of the first ladder section 704 between the topmost rung 701a and the next highest rung 701b, such as just above the next rung 701b. A third brace 780c is positioned at the top of the second outer rail 704b of the first ladder section 704 just about the topmost rung 701a. A fourth brace 780d is positioned on the second outer rail 704b of the first ladder section 704 between the topmost rung 701a and the next rung 701b, such as just above the next rung 701b. A fifth brace 780i is positioned on the first outer rail 704a of the first ladder section 704 between the rung 701b and the subsequent rung 701c, such as just below the rung 701b. A sixth brace 780j is positioned on the second outer rail 704b of the first ladder section 704 between the rung 701b and the subsequent rung 701c, such as just below the rung 701b. The same brace configuration may also be on the third ladder section 706.

As shown in FIG. 75, the second brace 780b and fourth brace 780d may be positioned so that they support the transition between the terminal ends of the inner rails 705a, 705b and the adjacent portions of the outer rails 704a, 704b that are hollow, empty, or not further supported by the inner rail section when the ladder 700 is disposed in the fully extended position, with the inner section 705 extended its maximal extent from the outer section 704. This transition point along a length of the ladder, when the ladder is in the fully extended position, is particularly subject to bending and deformation. For some configurations, a particularly located brace may provide reinforcement without unnecessary or excessive weight (e.g., without thickening the entire rail). For example, as illustrated, an upper half or portion of the brace 780d wraps around the outer rail 704b and the terminal end of the inner rail 705b and a lower half or portion wraps only around the outer rail 104b directly below the terminal end of the inner rail 705b. The brace 780b may have the same positioning on another outer ladder rail. While the braces 780b, 780d are shown as extending over the end or terminus of the inner rails (e.g., having at least a portion above and below the terminal end of the inner rail), the braces 780b, 780d may also be adjacent to the terminus of the inner rails as well.

In some approaches, braces may be placed at one or more other points on the outer rails 704a, 704b (in ladder 700 or other extendable ladders of differing lengths) to support the transitions between the ends of the inner rails 705a, 705b and the adjacent hollow or empty portions of the outer rails 704a, 704b when the inner section 705 is locked at different positions with respect to the outer section 704. For instance, while braces 780b and 780d support a transition when the ladder is fully extended with the inner rails locked to the outer rails at the topmost locking position (e.g., with the locking pins (e.g., locking pin 750a) of the lock engaging the topmost locking holes (e.g., 758a) of the outer rails 704a, 704b), in some configurations braces may be positioned to support a transition at one or more other locking positions of the ladder when the ladder is not fully extended. For instance, additional braces may be positioned to support a transition when the ladder is locked at the second highest locking position, with the locking pins (e.g., locking pin 750a) of the lock engaging the second highest locking holes (e.g., 758b) of the outer rails 704a, 704b. In some approaches, similar placement of braces may be present for the third highest locking position, a fourth highest locking position, and so forth, to minimize any bending or deformation that could occur in those areas when the inner rails 704a, 704b are locked in these locking positions.

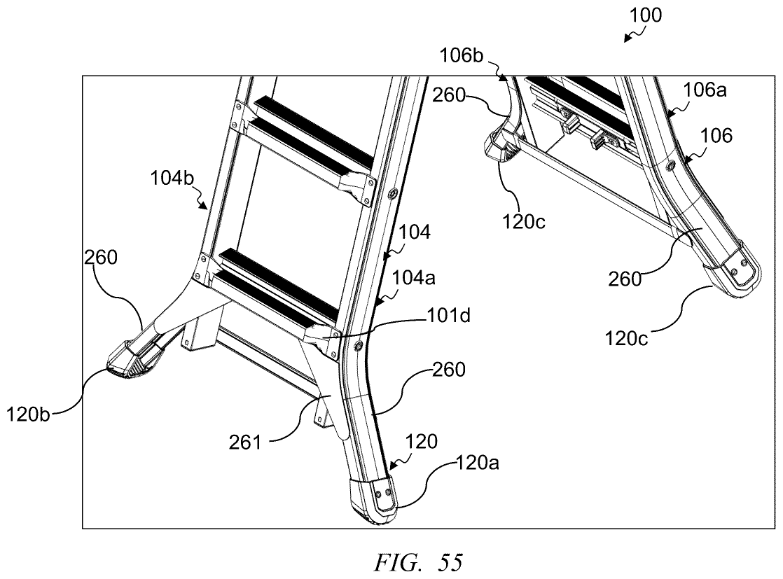

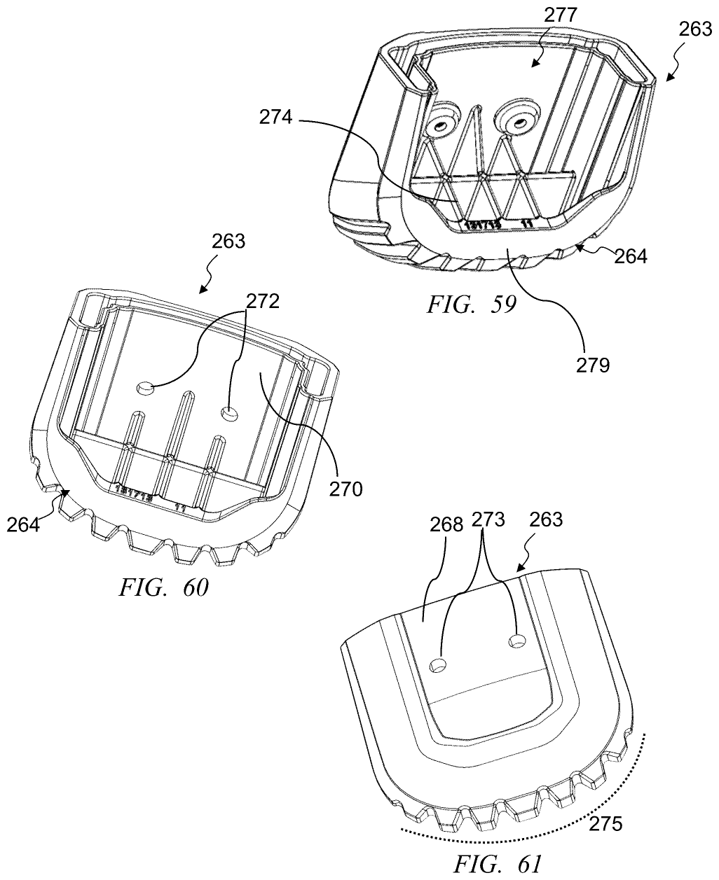

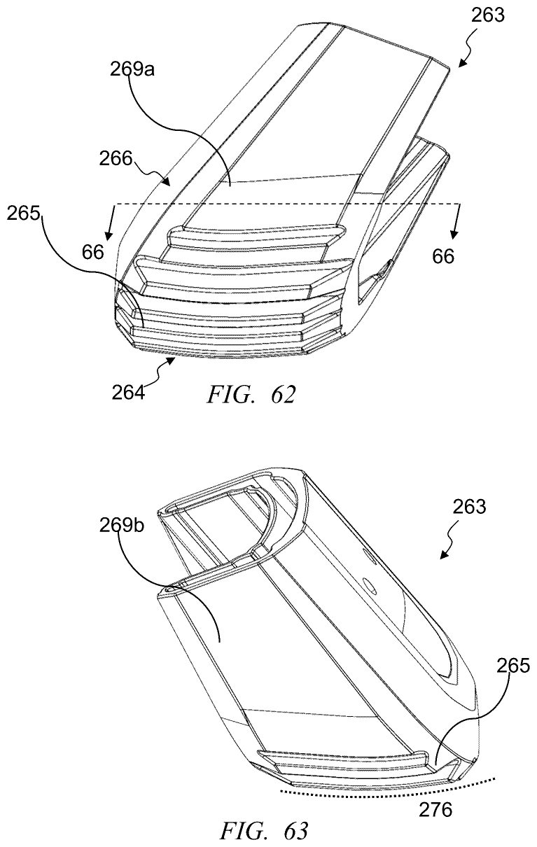

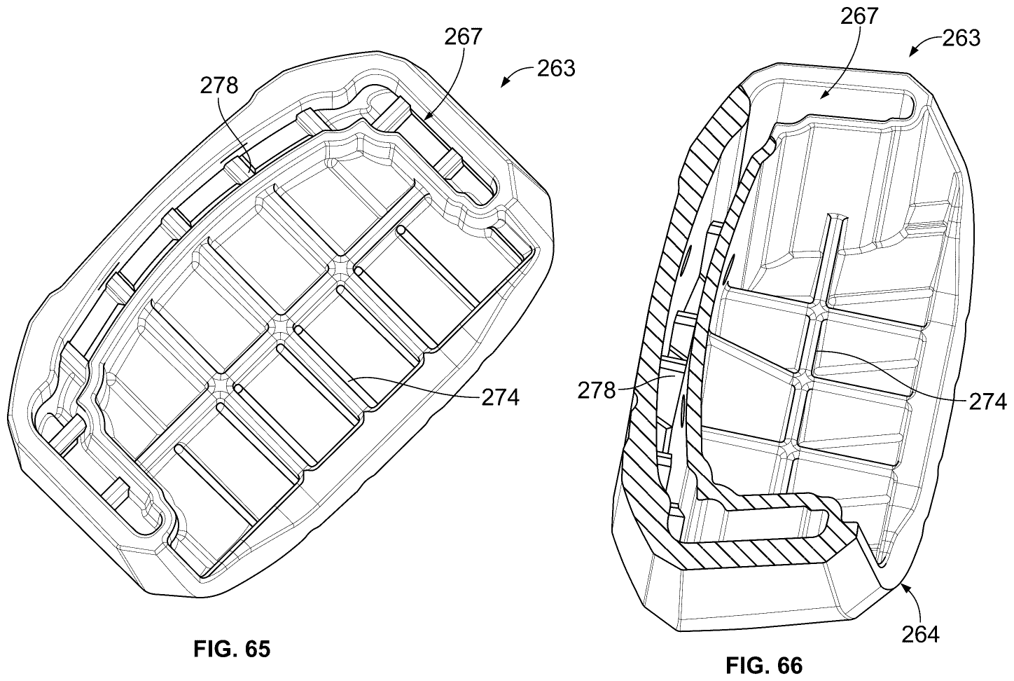

With reference to FIGS. 55-67, the multi-position ladder 100 may include four feet assemblies 120. A first foot assembly 120a may extend from a bottom of the first outer rail 104a of the first ladder section 104, a second foot assembly 120b may extend from a bottom of the second outer rail 104b of the first ladder section 104, a third foot assembly 120c may extend from a bottom of the first outer rail 106a of the third ladder section 106, and a fourth foot assembly 120d may extend from a bottom of the second outer rail 106b of the third ladder section 106. In an illustrative configuration, all of the feet assemblies 120a, 120b, 120c, 120d have the same configuration.

In some approaches, an outwardly angled leg 260 may be defined at the bottom portion of each outer rail 104a, 104b, 106a, 106b, with the foot assembly at a distal end thereof, to increase the width of the base for extra stability. Flat braces 261 may extend adjacent end portions of the bottommost outer rung 101d to about midway through the leg 260 to provide further support to the leg 260 and transfer of load.

The foot assembly 120 includes a bottom portion of the respective outer rail (e.g., outer rail 104b, or the leg 260 of outer rail 104b), a foot component 263, and an inner plate 286. The foot component 263 defines a slot 267 that receives the plate 286 and bottom of the outer rail 104b. In an illustrative approach, the slot 267 is a C-shaped slot that corresponds to a C-shape of the outer rail 104b and a C-shape of the inner plate 286 so that they can be inserted into the slot 267.

More specifically, the foot component 263, in some approaches, has a body 263a that may be a single piece integrally formed from plastic. For instance, in a non-limiting embodiment, the material of the foot component 263 is polyvinyl chloride. The foot component 263 includes a base portion 264 having a lower side 264a and an upper side 264b, a first side 264c, a second side 264d opposite the first side 264c, a third side 264e, and a fourth side 264f opposite the third side 264e. The lower side 264a may include treading 265. In the illustrated embodiment, the treading 265 is defined by alternating ridges and grooves extending between the third side 264e and the fourth side 264f (or extending across a width of the lower side 264a). Other configurations of treading 265 are also possible.

The foot component 263 may also include an extension portion 266 extending upwardly from the base portion 264 for receiving the rail 104b. The C-shaped slot 267 is defined at least in part by the extension portion 266. In one approach, the extension portion 266 includes a first outer web portion 268 extending upwardly from the base portion 264 from the third side 264e, a first outer flange portion 269a extending upwardly from the base portion 264 from the first side 264c, and a second outer flange portion 269b extending upwardly from the base portion 264 from the second side 264d. The first outer web portion 268, first outer flange portion 269a, and second outer flange portion 269b may define a C-shape. An inner web portion 270 may also be present, spaced inwardly from the outer web portion 268 and extending upwardly from the base portion 264, as well as a first inner flange portion 271a and a second inner flange portion 271b extending upwardly from the base portion 264 and spaced inwardly from the first outer flange portion 269a and the second outer flange portion 269b. Distal ends of the first outer flange portion 269a and the first inner flange portion 271a may curve towards one another to form a continuous integral connection between the first outer flange portion 269a and the first inner flange portion 271a, while distal ends of the second outer flange portion 269b and the second inner flange portion 271b may curve towards one another to form a continuous integral connection between the second outer flange portion 269b and the second inner flange portion 271b, so that the slot 267 with a closed C-shape is defined between the web portions 268, 270 and flange portions 269a, 269b, 271a, 271b.

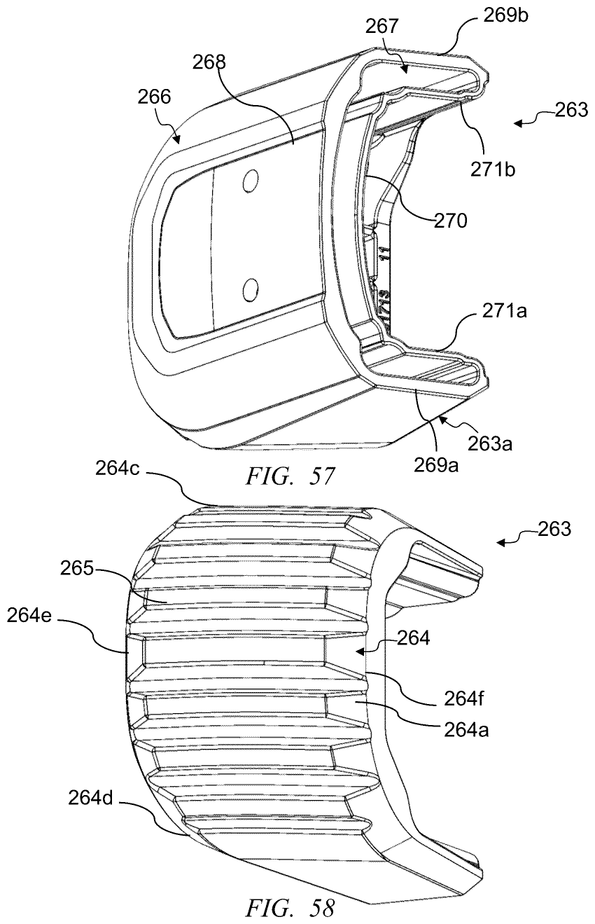

As shown in FIG. 57, the outer and inner web portions 268, 270 may have a slight outward curvature to correspond to curvature of the rail 104b.

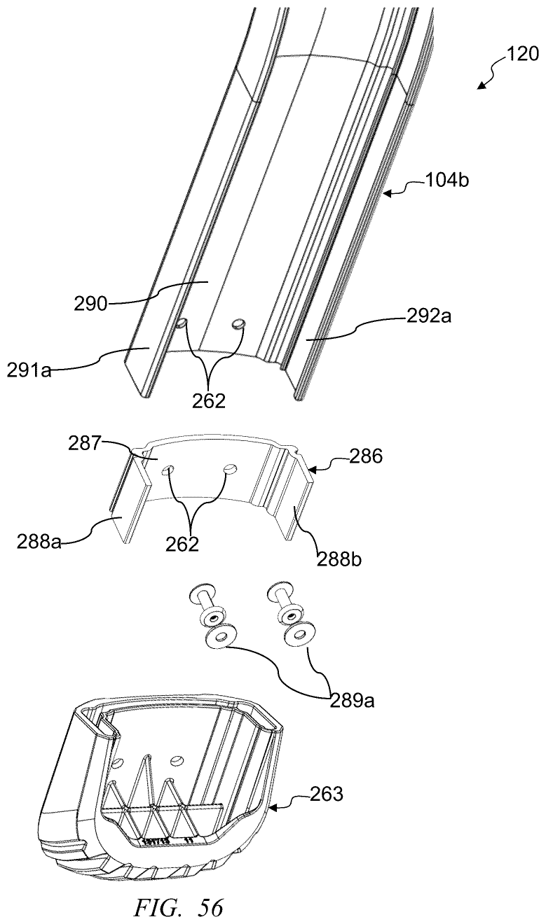

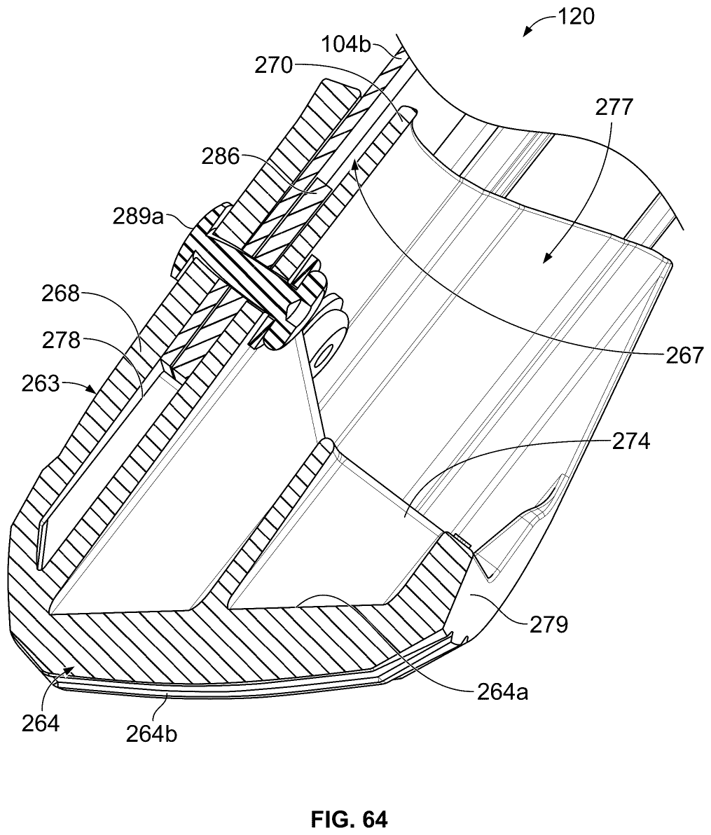

The plate 286 may be sized and shaped to be inserted within the slot 267 of the foot component 263 (see, e.g., FIGS. 56 and 64). The plate 286 helps to support the connection between the rail 104b and the foot component 263 and may be formed from a metal such as aluminum. For instance, in an illustrative configuration, the plate 286 may have a C-shape that is slightly smaller than the rail 104b so that it fits snugly within the rail 104b when both components are received in the slot 267. The plate 286 may have a web portion 287, a first flange portion 288a extending from one end of the web portion 287, and a second flange portion 288b extending from an opposite end of the web portion 287, the first flange portion 288a and the second flange portion 288b facing one another.

The foot component 263, the plate 286, and the rail 104b are typically fixedly coupled together. In one approach, one or more holes are present in each of the foot component 263, the plate 286, and the rail 104b. For instance, in one configuration, the plate 286 includes two holes 289 spaced across a width of the web portion 287, the foot component includes two holes 272 spaced across a width of the inner web portion 270 and two holes 273 spaced across a width of the outer web portion 268 and aligned with the two holes 272 of the inner web portion 270, and the rail 104b also includes two holes 262 in the main web 290 of the rail 104b. The rail 104b and the plate 286 are inserted into the slot 267 in a position in which the holes 262 of the rail 104b and the holes 289 of the plate 286 align with the holes 273, 272 of the foot component 263 so that fasteners 289a can extend through each of the holes.

In an illustrative approach, the bottom side 264a of the foot component 263 may be curved. For instance, the bottom side 264a may have at least one curvature extending substantially from one side of the bottom side 264a to the opposite side of the bottom side 264a. For instance, the bottom side 264a may define a curvature from the first side 264c to the second side 264d, and/or a curvature from the third side 264e to the fourth side 264f. In illustrative approaches, the bottom side 264a defines two different curvatures. For instance, as shown, the bottom side 264a may define a first curvature 275 extending from the first side 264c to the second side 264d, and a second curvature 276 extending from the third side 264e to the fourth side 264f.

In some approaches, the first and second curvatures 275, 276 may have about the same curvature. In other approaches, the first and second curvatures 275, 276 may be different. In the illustrated approach, for example, the first curvature 275 and the second curvature 276 are both generally symmetrical around centerlines of the bottom side 264a. For instance, each curvature may curve downward from one side to a centerline and then back upward from the centerline to the opposite side, defining a partial spherical profile. Due to the curvatures, the treading 265 may appear to curve upwards towards the extension portion 266 and may be visible from one or more sides when the foot component 263 is assembled on the ladder 100 and standing on the ground.

In some approaches, the radii of curvature of the first and second curvatures 275, 276 may be different. For instance, as shown, the second curvature 276, the curvature from the third side 264e (which may be an outer side of the foot component 263 when assembled on the ladder 100) to the fourth side 264f (which may be an inner side of the foot component 263 when assembled on the ladder 100), may have a larger radius of curvature compared to the first curvature 275 which extends from the first side 264c (which may be a front side of the foot component 263 when assembled on the ladder 100) to the second side 264d (which may be a rear side of the foot component 263 when assembled on the ladder 100. The first curvature 275 may have a smaller radius to provide maximum adhesion from front to back in all of the different ladder modes. The second curvature 286 may have a larger radius because it need only provide maximum adhesion from left to right, which is the same in every ladder mode.

The exact radii of curvature of the first and second curvatures 275, 276 may depend, in different approaches, on the dimensions of the foot component 263 (e.g., the lengths of the sides 264c, 264d, 264e, 264f).

Advantageously, the multiple curvatures of the footpads described herein mitigate stability issues that commonly occur with ladders. For instance, even when ladders are used on a relatively flat ground, ladders tend to exhibit wobbliness. A footpad with multiple slight curvatures, however, permits the footpad to adapt precisely to the specific points of an uneven surface, reducing wobble and rendering the ladder more stable during use.

In some illustrative configurations, the foot component 263 may also have a plurality of ribs 274 that extend upwardly from the base 264 into a partial cavity 277 of the foot component 263 defined by the base 264, the inner web portion 270, and the inner flange portions 271a, 271b. The ribs 274 may form a network (e.g., a grid) of ribs connected to lower portions of the inner web portion 270, and the inner flange portions 271a, 271b to provide support for the shape of foot component 263 and provide resistance to deformation of the foot over time. The ribs 274 may also be connected to a short upstanding wall 279 extending upwardly from the fourth or inner side 264f of the base 264. The ribs 274 may have varying heights and angles.

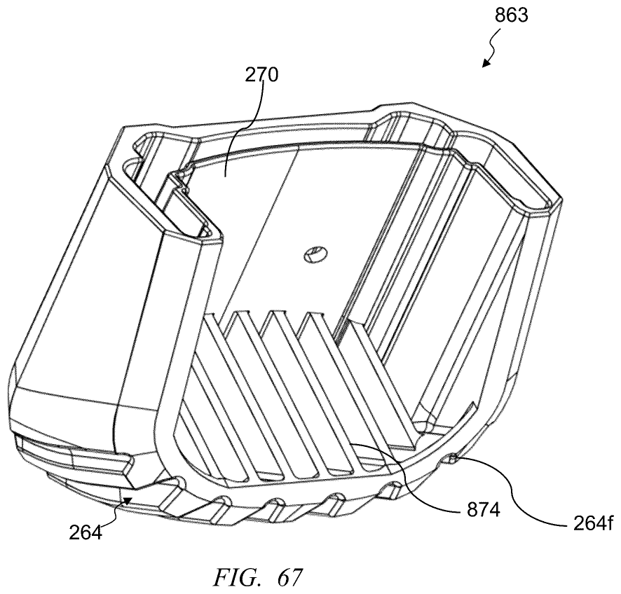

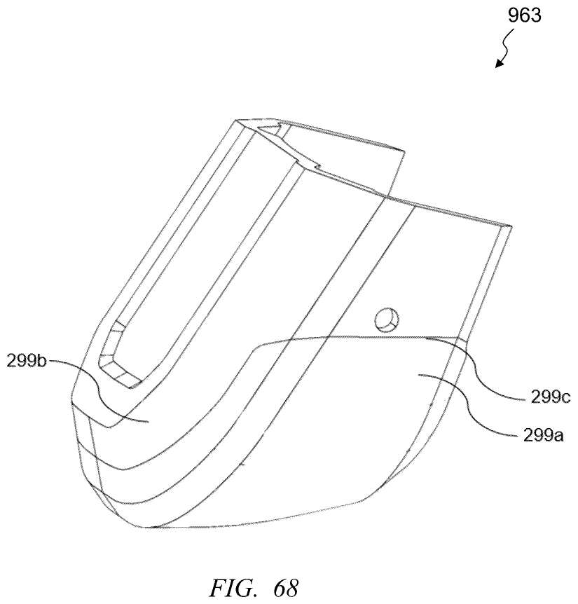

As shown in FIG. 67, in another embodiment the ribs may be longitudinal ribs 874 in rows extending upwardly from the base 264 and have an angled configuration with a lower end engaging the fourth or inner side 264f of the base 264 and a higher end engaging the inner web portion 270.

The foot component 263 may also include one or more ribs 278 inside the slot 267, as shown in FIGS. 64-66. Some of the ribs 278 may extend about halfway up the slot 267 from a bottom of the slot. In some approaches, the rail 104b and plate 286 are seated on the top of one or more of the ribs 278. The ribs 278 reinforce the shape of the slot 267. In various examples, there are three or more, or five or more ribs 278 spaced in the slot 267. The ribs 278 may have varying heights.

The foot component, in some approaches, may also have a two-piece configuration formed from a 2-shot molding process, as shown in FIG. 68. The foot component 963 includes a lower portion 299a formed from one material and an upper portion 299b formed from another material. The line defined at 299c may be the boundary between the lower portions 299a and the upper portion 299b. For instance, in one approach, the lower portion 299a is formed from polyvinyl chloride and the upper portion 299b is formed from polypropylene. Other plastics may also be suitable. In one approach, the lower portion 299a is an elastomer for grip and slip-resistance and the upper portion 299b is a harder or more durable plastic to support the load transfer between the rail and the foot that usually occurs at the upper portion 299b where the fasteners are positioned. While FIG. 68 does not show a C-shaped slot 267 as in the previous embodiment, it will be appreciated that the foot component 963 may also be formed with this feature.

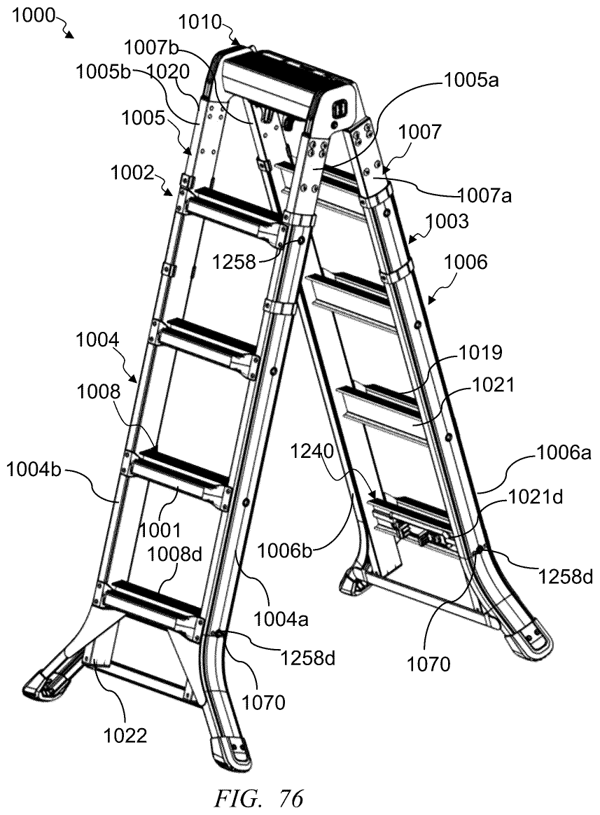

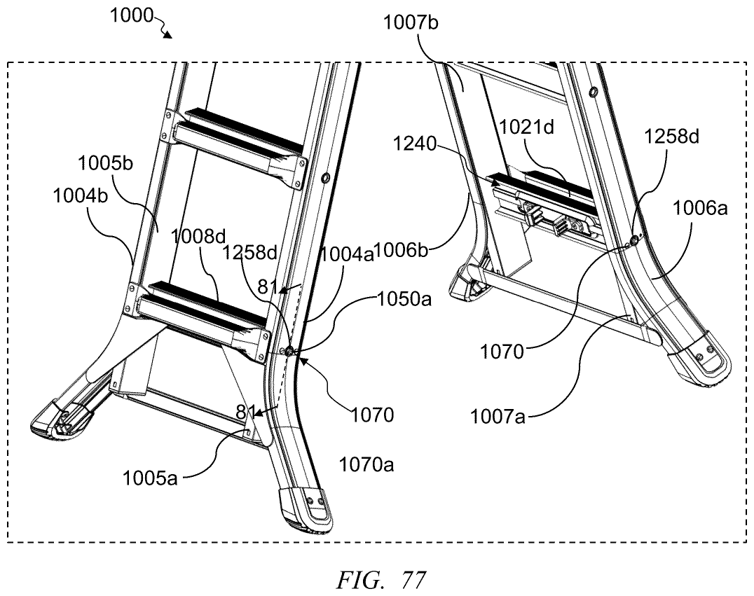

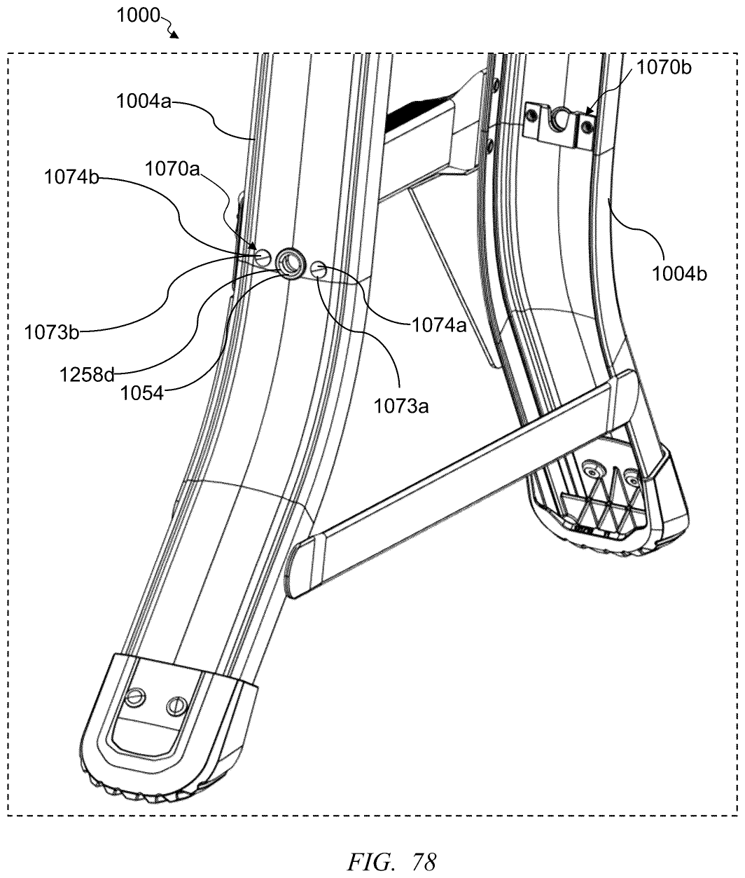

With reference to FIGS. 76 and 77, another embodiment of a multi-position ladder 1000 is shown. The multi-position ladder 1000 is similar to the ladders previously described and shares many of the same features. More specifically, the reference numerals for features that the ladder 1000 shares with ladder 100 retain the same last two digits (or three digits for larger numbers) as in the earlier embodiment but are prefixed to be at least 1000. In addition, it will be appreciated that the ladder 1000 may have any of the features of the previously described ladders. Further, while a specific implementation of a multi-position ladder is illustrated, it will be appreciated by those skilled in the art that many of the components and features may also be used on a variety of configurations and on different types of ladder known in the art, including but not limited to stepladders and straight ladders, extension ladders, etc.

Advantageously, the ladder 1000 includes one or more stops 1070 for limiting linear movement of portions of the ladder relative to other portions. By one approach, the stops 1070 limit movement of the outer ladder sections 1004, 1006 and respective inner ladder sections 1005, 1007 relative to one another. These stops 1070 are typically positioned to stop the movement of the inner ladder section 1005, 1007 relative to the outer ladder section 1004, 1006 as it slides into the maximum contracted position within the outer ladder section 1004, 1006.

In one illustrative configuration, the placement of the stops 1070 is based on a lowermost intended position of the inner rail section. In this manner, the stops 1070 are aligned with or carefully coordinated with the placement of the bottommost or lowest locking holes 1258d in the outer ladder section 1004, 1006 that correspond to the maximum contracted or lowermost intended position. This ensures that the inner ladder section 1005, 1007 is automatically positioned to align with and lock securely into the locking holes 1258d at the precise moment it is stopped by the stops. This feature is particularly beneficial, as it prevents the inner ladder section 1005, 1007 from sliding past the bottommost locking holes 1258d and potentially being lowered all the way to the ground, disassembled in some manner, and/or causing injury. Indeed, unsecured ladder elements can pose a serious safety risk, as it might lead the user to mistakenly believe the ladder is securely locked when it is not, resulting in the user attempting to climb an unlocked ladder. By integrating the stops 1070 and coordinating their placement with the locking mechanism, the ladder 1000 provides enhanced safety and ease of use, reducing the likelihood of accidents or improper operation.

The illustrated ladder 1000 includes a first “outer” ladder section 1004 and a second “inner” ladder section 1005 that may together define a front section 1002 of the ladder 1000 and a third “outer” ladder section 1006 and a fourth “inner” ladder section 1007 that may together define a rear section 1003 of the ladder 1000. Though sections 1002 and 1003 are referred to herein as “front” and “rear” sections, it will be appreciated that the ladder 1000 may also be used in an opposite orientation, with section 1003 facing the front and section 1002 facing the rear.

In some approaches, the ladder 1000 includes a lockable hinge assembly 1010 coupled to the second ladder section 1005 and the fourth ladder section 1007 and extending therebetween. The lockable hinge assembly 1010 permits rotation of the front section 1002 relative to the rear section 1003 to change the angle of the ladder 1000 to various positions, such as contracted straight, stepladder, or extended straight.

The first outer ladder section 1004 may include a first outer rail 1004a and a second outer rail 1004b spaced from one another, and one or more outer rungs or steps 1001 coupled to and extending between the first outer rail 1004a and the second outer rail 1004b. The second inner ladder section 1005 may include a first inner rail 1005a and a second inner rail 1005b spaced from one another, and one or more inner rungs or steps 1008 coupled to and extending between the first rail 1005a and the second rail 1005b. In some approaches, the second inner ladder section 1005 is contained at least in part within the first outer ladder section 1004 such that the second inner ladder section 1005 is slidable within the first outer ladder section 1004 to change a length or height of the front section 1002 of the ladder 1000 (i.e., extend or contract the front ladder section 1002). For instance, the first inner rail 1005a and the second inner rail 1005b of the second inner ladder section 1005 may be positioned at least in part within the first outer rail 1004a and the second rail 1004b of the first outer ladder section 1004, respectively.

The front section 1002 may include a rail lock assembly 1240 to permit a user to selectively secure ladder portions together. By one approach, the rail lock assembly may be leveraged to lock and unlock the first outer ladder section 1004 and the second inner ladder section 1005 relative to one another. In this manner, the rail lock assembly 1240 may be used to respectively inhibit or permit linear movement of the first outer ladder section 1004 and the second inner ladder section 1005 relative to one another. In some approaches, the rail lock assembly 1240 is included adjacent or within a bottommost or lowest rung 1008d of the second inner ladder section 1005.

In some configurations, the rail lock assembly 1240 is configured to selectively engage and disengage a pin engagement mechanism such as a recess, depression, bumper, abutment, and/or locking pin hole 1258 spaced along the first and second outer rails 1004a, 1004b of the first outer ladder section 1004 to adjust the height of the front section 1002. The rail lock assembly 1240 may be the same as the rail lock assembly 240 described above with respect to ladder 100, having a pinch lock 1047 with two handles 1047a, 1047b to actuate the lock and respective locking pins 1050a, 1050b mechanically coupled to the pinch lock 1047 that simultaneously engage or disengage respective locking pin holes 1058 in the first and second outer rails 1004a, 1004b.

Generally, the second inner ladder section 1005 and the first outer ladder section 1004 may be linearly moved relative to one another between a maximum contracted position in which the second inner ladder section 1005 is drawn substantially into the first outer ladder section 1004 with the rail lock assembly 1240 engaging the bottommost locking pin holes 1258d on the first outer rails 1004a, 1004b, and a maximum extended position in which the second inner ladder section 1005 is drawn substantially out of the first outer ladder section 1004 with the rail lock assembly 1240 engaging the topmost locking pin holes 1258 on the first outer rails 1004a, 1004b. In the maximum contracted position, a top end portion 1020 of the second inner rails 1005a, 1005b may protrude out from the first outer rails 1004, 1004b. In addition, a bottom end portion 1022 of the second inner rails 1005a, 1005b may not extend all the way to a bottom of the outer rails 1004a, 1004b and may be spaced from or raised above the ground when the ladder 1000 is standing on the ground in the maximum contracted position.

As shown, the outer rungs 1001 are typically configured to be positioned in front of the inner rungs 1008 when portions of the second inner ladder section 1005 are retracted within the first outer ladder section 1004. In some approaches, the outer rungs 1001 are attached to front surfaces of the first and second outer rails 1004a, 1004b and extend entirely in front of the outer rails 1004a, 1004b to allow room for the inner rungs 1008 to extend behind the outer rungs 1001 within the profile of the first and second outer rails 1004, 1004b.

It will be appreciated that the rear section 1003 may have substantially the same configuration and functionality as the front section 1002 with respect to the third outer ladder section 1006, fourth inner ladder section 1007, third outer rails 1006a, 1006b, fourth inner rails 1007a, 1007b, outer rungs 1019, inner rungs 1021, and rail lock assembly 1240.

As noted above, the front section 1002 of the ladder 1000 may include a limiter or a stop 1070. The stop 1070 is positioned to halt movement of the second inner ladder section 1005 with respect to the first outer ladder section 1004 when the second inner ladder section 1005 is being moved into the maximum contracted position. Specifically, as noted above, the stop 1070 is positioned to prevent further movement of the second inner ladder section 1005 towards the bottom of the first outer ladder section 1007 precisely when the rail lock assembly 1240 within the bottommost inner rung 1008d is aligned to engage the bottommost locking pin holes 1258d of the first outer rails 1004a, 1004b, corresponding to the maximum contracted position. The stop 1070 thus helps register and direct the rail lock assembly 1240 to the bottommost locking pin holes 1258d so that a user cannot incidentally move the second inner ladder section 1005 past the bottommost locking pin holes 1258d to the ground to an unsafe, unlocked position.

Generally, the stop 1070 may include a projection or other abutting geometry that functions to stop relative movement between the first outer ladder section 1004 and the first inner ladder section 1005 at a specific relative position in which the rail lock assembly 1240 aligns with the bottommost engagement geometry, such as locking pin holes 1258d. A first stop 1070a may be associated with the first outer rail 1004a or first inner rail 1005a to limit relative movement between the first outer rail 1004a and the first inner rail 1005a while a second stop 1070b may be associated with the second outer rail 1004b or second inner rail 1005b to limit relative movement between the second outer rail 1004b and the second inner rail 1004b. While only the stops 1070a, 1070b on the front section 1002 of the ladder 1000 are specifically described below, it will be appreciated that the same description applies to stops that may be present on the rear section 1003 of the ladder 1000. For instance, stops 1070 on the rear section 1003 may be positioned to prevent further movement of the fourth inner ladder section 1007 in a first direction towards the bottom of the third outer ladder section 1006 precisely when the rail lock assembly 1240 within the bottommost inner rung 1021d of the fourth inner ladder section 1007 is aligned to engage the bottommost locking pin holes 1258d of the third outer rails 1006a, 1006b, corresponding to the maximum contracted position.

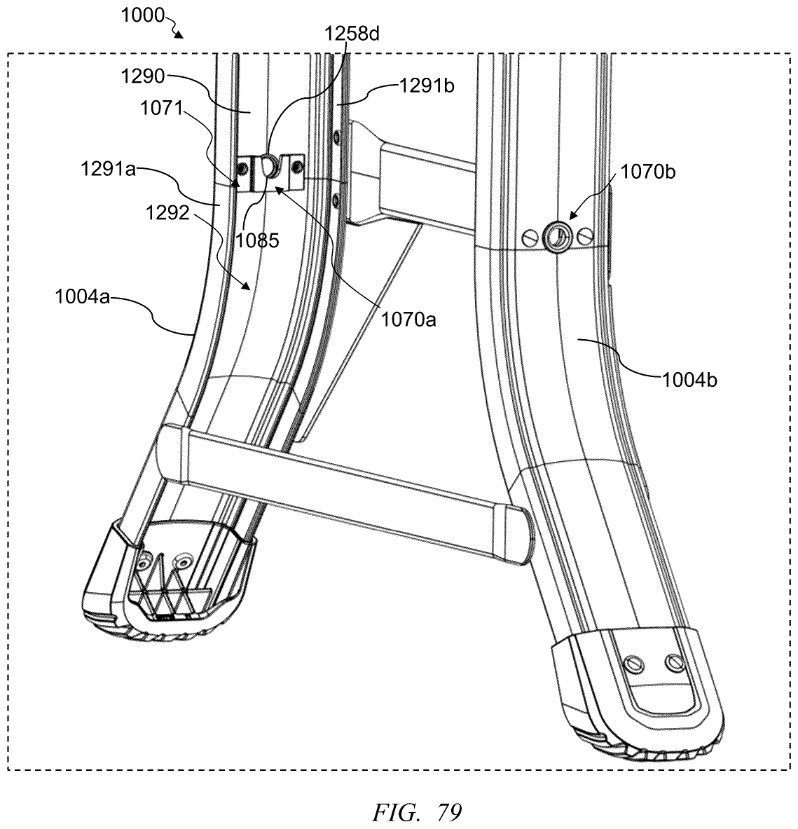

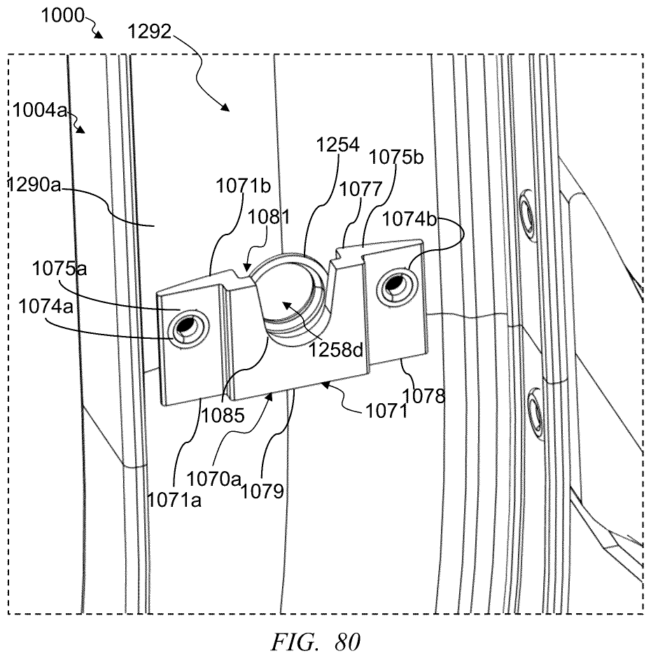

With reference to FIGS. 77-81, in the non-limiting, illustrated configuration, first and second stops 1070a, 1070b are located adjacent the bottommost locking pin holes 1258d on the respective first and second outer rails 1004a, 1004b. As shown, the first and second outer rails 1004a, 1004b may be a generally C-shaped rail having a main web 1290, a first flange 1291a extending from one end of the main web 1290 and a second flange 1291b extending from an opposite end of the main web 1290 so that the first flange 1291a and the second flange 1291b generally face one another, defining a C-shaped channel 1292 between the main web 1290, first flange 1291a, and second flange 1291b. Sets of locking pin holes 1258 for adjusting the position of the second inner ladder section 1005 with respect to the first outer ladder section 1004 may be spaced along the respective main webs 1290 of the first and second outer rails 1004a, 1004b to be engaged by the rail lock assembly 1240.

The first stop 1070 may include a main body 1071 disposed on an inner surface 1090a of the main web 1290 of the first outer rail 1004a, projecting inwardly into the channel 1292. As shown, the body 1071 of the first stop 1070 may be fastened to the first outer rail 1004a. For instance, the body 1071 may include one or more holes for fasteners to extend through the body 1071 and through corresponding holes in the rail to couple the body 1071 to the first outer rail 1004a. For instance, as illustrated, there may be two holes 1073a, 1073b in the web 1290 of the first outer rail 1004a (e.g., on opposite sides of the bottommost locking pin hole 1258d) and two corresponding holes 1076a, 1076b in the body 1071 of the first stop 1070 to receive fasteners 1074a, 1074b to couple the body 1071 to the first outer rail 1004a. Other amounts and configurations of the holes and fasteners are possible. In other approaches, the body 1071 may be formed integrally with the first outer rail 1004a or may be welded.

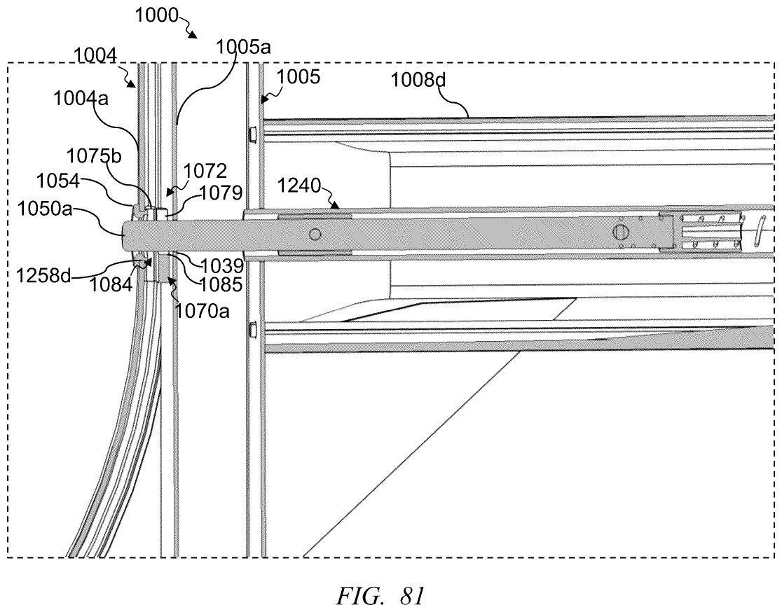

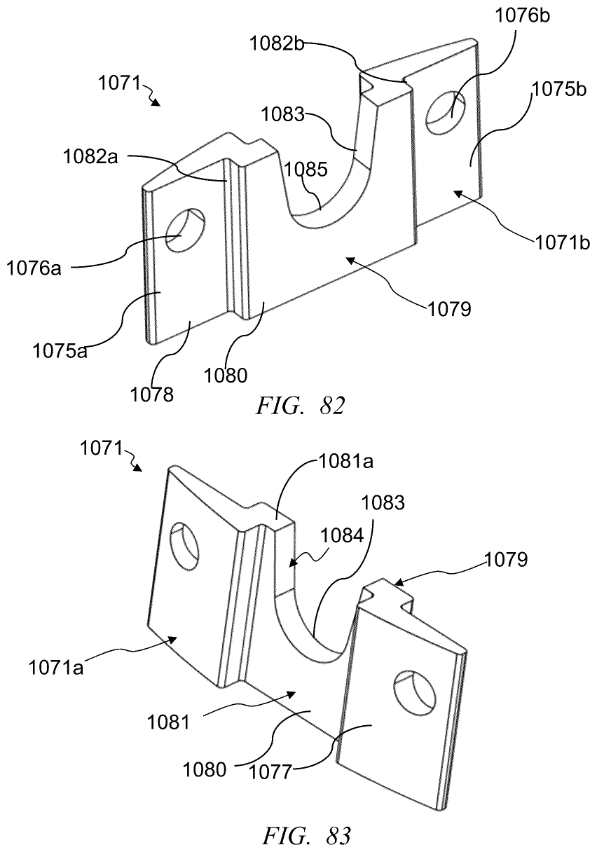

Specifically, the body 1071 may extend into the channel 1292 within a small vertical space or gap 1072 between the first inner rail 1005a and the inner surface 1090a of the main web 1290 of the first outer rail 1004a. More specifically, as shown in FIG. 81, the first inner rail 1005a may have a box-shaped profile that is disposed within and moveable within the channel 1292 of the first outer rail 1004a. The space 1072 is defined between the outermost web of the first inner rail 1005a and the inner surface 1090a of the main web 1290 of the first outer rail 1004a. At the position of the bottommost rung 1008d containing the rail lock assembly 1240 (i.e. the “locking rung”), the locking pin 1050a extends through the bottommost rung 1008d, the first inner rail 1005a, and a hole 1039 in the outermost web of the first inner rail 1005a. It then extends from the hole 1039 into the space 1072 between the first inner rail 1005a and the inner surface 1090a of the first outer rail 1004a. In some configurations, the locking pin 1050a extends into the space 1072 when the user is moving the first inner rail 1005a relative to the first outer rail 1004a. For instance, as described above with respect to rail lock assembly 240, the locking pin 1050a may be outwardly biased in the direction of the first outer rail 1004a. This biasing causes the locking pin 105a to extend within the space 1072. Thus, when the first inner section 1005 is moved relative to the first outer section 1004 into the maximum contracted position, the locking pin 1050a extending within the space 1072 during this movement is positioned to abut and be stopped by the body 1071 of the stop 1070 which also extends into the space 1072. In some approaches, the locking pin 1050a still extends into the space 1072 even when the handles 1047a, 1047b of the pinch lock 1047 are squeezed to move the locking pin 1050a in the opposite direction against the bias, so that the locking pin 1050a is still stopped by the stop 1070 even when the handles 1047a, 1047b are actuated.

As illustrated, the body 1071 of the stop 1070 may define a projecting ledge 1085 directly underneath the locking pin hole 1248d that projects into the space 1072. Specifically, the projecting ledge 1085 is positioned to abut the locking pin 1050a when the first inner section 1005 is moved relative to the first outer section 1004 into the maximum contracted position and to thereby halt movement of the first inner section 1005 relative to the first outer section 1004 beyond the maximum contracted position. When stopped by the projecting ledge 1085, the locking pin 1050a is exactly in position to be driven into the bottommost locking pin hole 1248d. In this manner, the stop both serves to guide the locking pin 1050a into the locking pin hole 1248d and to prevent movement of the first inner section 1005 beyond the maximum contracted position. The first inner section 1005 is thus safely locked in the maximum contracted position and cannot be mistakenly lowered to the ground, preventing the user from climbing the ladder 1000 in an unsafe, unlocked state.

In the non-limiting, illustrated configuration, the body 1071 of the stop 1070 may include, for example, a first side 1071a that extends away from the first outer rail 1004a and a second side 1071b that faces the first outer rail 1004a. The body 1071 may include a first flange portion 1075a and a second flange portion 1075b that are spaced from one another. The first and second flange portions 1075a, 1075b may be dimensioned to seat fairly flush against the inner surface 1090a of the main web 1290 of the first outer rail 1004, conforming to a shape thereof. The first and second flange portions 1075a, 1075b may include respective first and second holes 1076a, 1076b for receiving the fasteners 1074a, 1074b to couple the body 1071 to the first outer rail 1004a. The first and second flange portions 1075a, 1075b may have a first side 1077 that is flush with the first outer rail 1004a and a second opposing side 1078 facing away from the first outer rail 1004a.

A projection 1079 may extend from and between the first and second flange portions 1075a, 1075b on the second side 1078 of the first and second flange portions 1075a, 1075b. The projection 1079 may project from the first and second flange portions 1075a further inwardly into the space 1072 between the rails 1004a, 1005a. The projection 1079 is defined by a wall 1080 extending between the first and second flange portions 1075a, 1075b from the second side 1078 of the first and second flange portions 1075a, 1075b. The wall 1080 defines first and second steps 1082a, 1082b respectively between the wall 1080 and the first flange 1075a and between the wall 1080 and the second flange 1075b.

In this configuration, the wall 1080 is recessed from the second side 1071b of the body 107a, defining a recess 1081 or space between the wall 1080 and the inner surface 1090a of the first outer rail 1004a. In some approaches, the recess 1081 provides some space or clearance for the locking pin hole 1258d or for a bushing 1254 (e.g., like bushing 254 described above) extending within the locking pin hole 1258d. The recess 1081 entirely separates the first and second flange portions 1075a, 1075b.

As shown, the wall 1080 defining the projection 1079 includes a generally U-shaped cut out 1083 extending downwardly from a top 1081a of the wall 1080. The cut out 1083 is generally aligned with the bottommost locking pin hole 1258d, so that a continuous passage 1084 is defined through the cut out 1083 and the recess 1081 for the locking pin 1050a to extend through to the locking pin hole 1258d. The bottom of the U of the cut out 1083 defines the ledge 1085, which has a curvature generally corresponding to and aligned with a curvature of the bottom of the locking pin hole 1258d. When moving the inner ladder section 1005 is moved relative to the outer ladder section 1004 to the maximum contracted position, the locking pin 1050a passes through the top 1081a of the cut out 1083 and into the cut out 1083. The ledge 1085 may stop the locking pin 1050a and help drive it through the continuous passage 1084 and into the locking pin hole 1258d.

It will be appreciated that the second stop 1070b on the second outer rail 1004b may have the same configuration and functionality as described above for the first stop 1070a, and that engagement of the stops 1070a, 1070b and bottommost locking pin holes 1258d on each of the outer rails 1004a, 1004b by the rail lock assembly 1240 happens substantially simultaneously to halt motion of the second inner ladder section 1005 and first outer ladder section 1004 relative to one another beyond the maximum contracted position.

There may be other configurations of the engagement geometry or stops 1070a, 1070b besides the illustrated configuration. For instance, in one approach, a bushing 1254 of the bottommost locking pin hole 1258d may be formed to include a projection that projects inwardly into the space 1072 between the first inner and outer rails 1004a, 1005a (and the same configuration on the second inner and outer rails 1004b, 1005b). For example, a bottom of the bushing 1254 may project inwardly into the space 1072 to create the ledge 1085 which stops the locking pin 1050a and drives the locking pin 1050a into the locking pin hole 1258d. In some approaches, the bushing 1254 is formed of a metal such as steel.

In addition, while the above-described stops are positioned near the bottom of the ladder 1000 at the bottommost locking pin hole 1248d, other positioning of the stops is possible. For instance, in one configuration, there may be stops 1070a, 1070b projecting from top portions of the first and second inner rails 1005a, 1005b abut the top terminal ends of the first and second outer rails 1004a, 1004b to prevent further movement of the first and second inner rails 1005a, 1005b into the first and second outer rails 1004a, 1004b when the inner ladder section 1005 and the outer ladder section 1004 are in the maximum contracted position. In this configuration, the stops 1070a, 1070b are specifically positioned on the first and second inner rails 1005a, 1005b so that they abut the top terminal ends of the first and second outer rails 1004a, 1004b precisely when the locking pins 1050a, 1050b are aligned with the bottommost locking holes 1248d corresponding to the maximum contracted position. In one example, the stops 1070a, 1070b are brackets extending about the first and second inner rails 1005a, 1005b that abut the top terminal ends of the first and second outer rails 1004a, 1004b.

In other configurations, abutting geometry defining the stops may be positioned anywhere on the inner rails and the respective outer rails (e.g., top, middle, bottom) as long as the abutting geometry is not blocking the vertical movement of the locking pins 1050a, 1050b as the inner and outer ladder sections 1005, 1004 are moved relative to one another, and as long as the positioning of the abutting geometry is coordinated with the locking so that the abutting between the inner rails and the respective outer rails occurs exactly when the locking pins 1050a, 1050b are aligned with the bottommost locking holes 1248d corresponding to the maximum contracted position. To position the abutting geometry at any position of the inner rails 1005a, 1005b and the respective outer rails 1004a, 1004b, the inner rail may include a first projection and the respective outer rail may include a second projection positioned to engage and stop the first projection when the inner section 1005 and outer section 1004 are moved to the maximum contracted position.

Generally, the stops described herein may be metal components, formed, for example, from steel or aluminum. In some approaches, the stops are formed from a hard plastic, such as, for example, polyoxymethylene. In other approaches, the stops may be formed from or include rubber or other soft, elastic materials, or coatings to reduce the impression of impact or noise.

The present disclosure further relates to multi-position ladders and one or more ladder accessories for use therewith, such as, e.g., braces, top step modifications, polymer extensions for use with the top step, and ladder feet. The multi-position ladder accessories described herein are typically used to help increase the usability, and in some instances the safety, of the multi-position ladder. The term “top step” is used herein to describe the step that is the uppermost step when the multi-position ladder is in the step ladder configuration, though in the straight or extended straight configuration (as described below) this step is centrally located among the steps.

Generally speaking, pursuant to these various embodiments and systems described herein which may be used to provide accessories for a multi-position ladder. The multi-position ladder includes elements or sections that can be rearranged to be used in various modes or configurations, for instance, as explained above. The various modes or configurations permit the selective movement of the sections relative to one another and then the locking or securement of these sections for use of the multi-position ladder. More particularly, the multi-position ladder may include a front section and a rear section. In addition, in some configurations the front and rear sections may themselves have constituent elements, such as, e.g., corresponding inner and outer sections that may be movable relative to one another. For example, the multi-position ladder may be used in a stepladder mode or configuration. In the stepladder mode, the front section and rear section are disposed in an A-frame shape. The multi-position ladder can have the inner sections of both the front and rear section extended from or retracted within outer sections to change the height of the multi-position ladder depending on the use required.

Further, the multi-position ladder may be used in a straight or extended straight mode or configuration. In these modes, the rear section is typically rotated away from the front section and rotated until the rear section is substantially in line or parallel with the front section. In one embodiment, the rotation occurs about the top step (which, as noted above, becomes centrally disposed in this configuration).

In a further aspect, the rotation is typically possible after engaging a lock mechanism to unlock the front section from a specific position with respect to the rear section. In one illustrative configuration, the lock mechanism may include a pinch lock, such as the pinch locks described herein. Depending on the various elements and their arrangement, the pinch lock may be disposed generally adjacent a front section side of the top step and/or extend downwardly generally below the top step.

Additionally, the multi-position ladder may be used in an uneven, or stair, mode. In the uneven mode or configuration, the rear section is typically rotated outward from the front section, but typically less than substantially in line or parallel as used in the straight or extended straight mode. In this way, the rear section can be placed on an elevated surface, such as a stair, while keeping the front section capable of being used. When the multi-position ladder is disposed in an L-shape, the multi-position ladder is typically considered in a stair mode or configuration.

The multi-position ladder may also be used in a leaning mode or configuration. In the leaning mode, the front section and the rear section are rotated to be close together so that the sections are substantially parallel to one another. In some embodiments, the leaning configuration includes a front section abutting the rear section. In this way, the multi-position ladder may be used in circumstances similar to those used in a straight or extended straight mode but for those requiring less elevation or climbing height. These configurations permit a user to change elevations while the ladder is leaning against a surface, such as a wall.

In one configuration, the multi-position ladder includes a front section including a front inner section at least partially disposed within a front outer section and a rear section including a rear inner section at least partially disposed within a rear outer section. The front inner section includes a first inner front rail, a second inner front rail, and a plurality of inner front rungs extending therebetween and the rear inner section includes a first inner rear rail, a second inner rear rail, and a plurality of inner rear rungs extending therebetween. The front outer section includes a first outer front rail, a second outer front rail, and a plurality of outer front rungs extending therebetween and the rear outer section includes a first outer rear rail, a second outer rear rail, and a plurality of outer rear rungs extending therebetween. The multi-position ladder further includes a top step coupling the front section to the rear section. The top step includes a top pinch lock configured to permit the front section to rotate relative to the rear section. The multi-position ladder further may include a lower pinch lock disposed within a lowermost inner rung of each the first and the second inner sections, the pinch lock configured to permit the first and second inner sections to slide out of the first and second outer sections, respectively.

The inner rails of the first and second inner sections may be disposed substantially within the outer rails of the first and second outer sections, respectively. In this way, the inner rails may slide in and out of or relative to the outer rails as the inner sections are extended or retracted.

In one illustrative configuration, the ladder accessories may include one or more cup or storage members. These may retain one or more small items when the ladder is in certain configurations, such as, e.g., the straight or extended straight configuration. In addition, these may provide other additional benefits, such as strengthening or alignment of components.

By some approaches, the multi-position ladder includes one or more reinforcing elements such as brackets or braces that provide strengthening or rigidity to a multi-position ladder. For example, the multi-position ladder may connect two or more pieces of the multi-position ladder to permit the components thereof to be leveraged in a number of different configurations. In one illustrative approach, the multi-position ladder includes a strengthening brace coupled to portions of a rail, such as an outer rail section.

In one exemplary configuration, a first and second brace are coupled to outer surfaces of the outer section of a multi-position ladder. In addition, in some approaches, there may be first and second braces on both the front outer section and the rear outer section of the ladder. In this manner, the ladder may include first and second front braces and first and second rear braces coupled to outer surfaces of the respective front or rear outer sections.

In some configurations, the first and second front braces and the first and second rear braces are disposed adjacent to an uppermost or top end of the front outer section and the rear outer section. The first and second front braces and the first and second rear braces are configured to provide rigidity to the multi-position ladder.

In some configurations, the top step includes a trough disposed within the top step configured to retain items when placed therein.

In some embodiments, at least one pad is disposed on a surface of the top step or a surface of another element coupled to the top step. By some approaches, the one or more pads are configured to permit the multi-position ladder to be leaned against a surface. The one or more pads are leveraged to help protect the surfaces against which the multi-position ladder may abut. For example, when the multi-position ladder is in a leaning configuration such that a first section is parallel with a second section, the top step may be placed against or may abut a surface such as a wall surface. The pads on the top step may assist with protecting the surface. Though the pad may be one integral piece, it also may be formed of multiple discrete elements or pads.

In further configurations, a polymer or plastic extension member is coupled to a rear surface of the top step. The polymer or plastic extension member may be employed to increase the functionality of the top step. By one approach, the extension member permits the top step to have a variety of additional functionality with elements such as, e.g., holders, clips, and/or slots, among others. In one illustrative configuration, the extension member is configured to provide structure for coupling an accessory thereto. More particularly, in some embodiments, the plastic extension member includes a first slot and a second slot configured to receive a portion of an accessory to couple the accessory thereto.

In some embodiments, a cup member or storage cup is coupled to a lowermost inner surface of each rail of the first and the second outer section, the storage cup disposed below a lowermost outer rung. In some configurations, a foot is disposed on a lower end of each of the first and second outer front rails and each of the first and second outer rear rails. The foot includes a plastic shell coupled to the end of each outer rail, and a rubber cover disposed over the plastic shell.

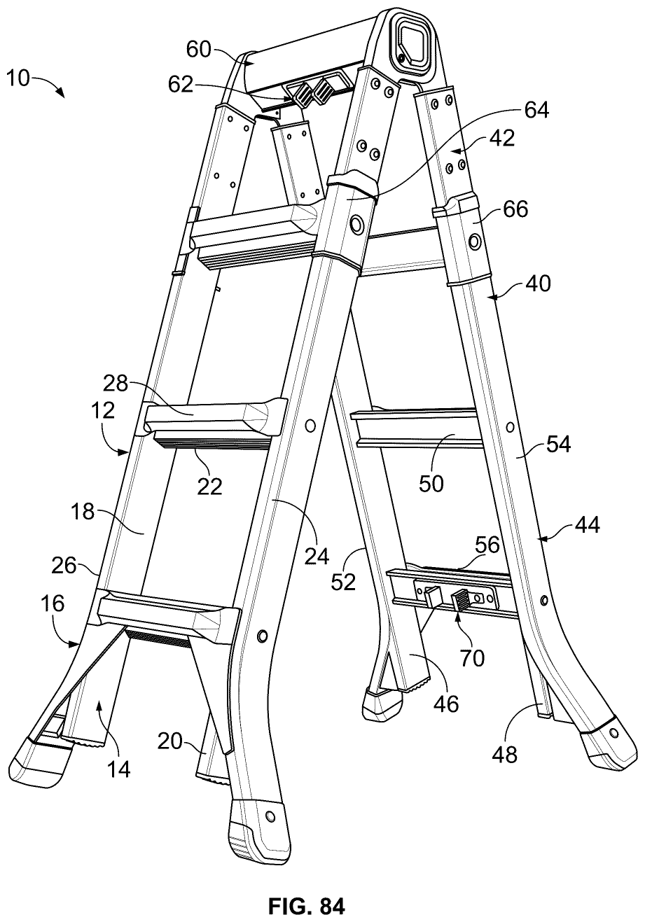

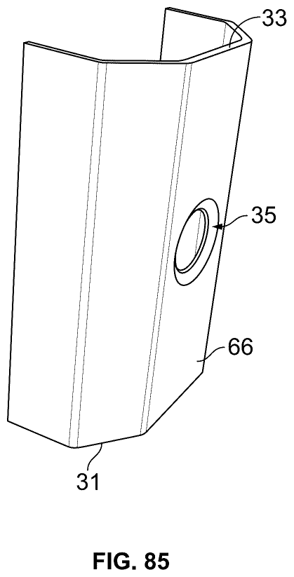

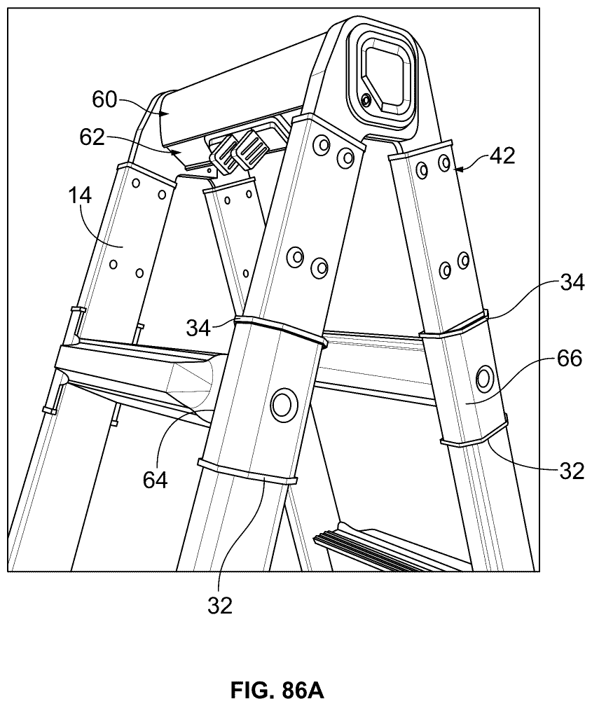

FIG. 84 illustrates a multi-position ladder 10 in an A-frame or stepladder configuration. The multi-position ladder 10 is movable at least from the stepladder configuration to a parallel leaning configuration, as described above. As shown, the multi-position ladder 10 includes a front section 12 including a front inner section 14 at least partially disposed within a front outer section 16. The multi-position ladder 10 also includes a rear section 40 including a rear inner section 42 at least partially disposed within a rear outer section 44. In this configuration, the front section 12 is typically adjacent the user's body when climbing and using the multi-position ladder 10. However, the user may also climb the rear section 40, in some configurations.

As shown, the front inner section 14 includes a first inner front rail 18, a second inner front rail 20, and a plurality of inner front rungs 22 extending therebetween. The rear inner section 42 includes a first inner rear rail 46, a second inner rear rail 48, and a plurality of inner rear rungs 50 extending therebetween. The front outer section 16 includes a first outer front rail 26, a second outer front rail 24, and a plurality of outer front rungs 28 extending therebetween. The rear outer section 44 includes a first outer rear rail 52, a second outer rear rail 54, and a plurality of outer rear rungs 56 extending therebetween,

The multi-position ladder 10 includes a top step 60 coupling the front section 12 to the rear section 40. in some embodiments, the top step 60 includes a top pinch lock 62 configured to permit the front section 12 and to rotate relative to the rear section 40. The top pinch lock 62 may be disposed to be generally accessible from the front section 12 side of the multi-position ladder 10. For instance, as shown, the pinch lock 62 may extend generally downwardly from and below the top step 60 and may be angled towards the front of the ladder.

A pinch lock, as described herein, may include one or more levers or handles that a user can pull, squeeze, or pinch together to permit a disengagement or engagement of portions of a ladder locking mechanism. In typical configurations, the pinch lock can be actuated with one hand.

In some embodiments, the multi-position ladder 10 also includes a lower pinch lock 70 to permit relative movement between the front section 12 and the rear section 40. For example, the ladder 10 may include a pinch lock 70 disposed within a lowermost inner rung 22 of the front inner section 14 and/or a pinch lock 70 disposed within a lowermost inner rung 50 the rear inner section 42. In use, the pinch lock 70 is configured to permit the inner sections 14, 42 to slide out of the respective outer sections 16, 44 and extend the climbable length of the multi-position ladder 10. In one embodiment, the lower pinch lock 70 on each inner section 14, 42 is actuatable independent of the other, permitting the adjustment of the length of either the front section 12 or the rear section 40 independent of one another. In this way, the front section 12 can be extended while the rear section 40 is not, and conversely the rear section 40 can be extended while the front section 12 is not. For instance, this may be done to achieve the uneven or stair mode described above.

In use, the top pinch lock 62 and lower pinch lock 70 are used to change the various lengths, configurations, and modes associated with the multi-position ladder 10. FIG. 3A illustrates an example of a ladder 100 with three pinch locks: one top pinch lock, i.e., lockable hinge assembly 110, and two lower pinch locks, i.e., rail lock assemblies 240. The top pinch lock, lockable hinge assembly 110, is disposed within the top rung 115, while the lower pinch locks, rail lock assemblies 240, are disposed in lowermost inner rungs 108d, 121d of the front and rear ladder sections 102, 103 respectively, as described above for ladder 100. The multi-position ladder 10 may be similarly configured, having one top pinch lock 62 in the top step 60 for engaging ladder hinges to permit relative movement between the front section 12 and the rear section 40, and having two lower pinch locks 70 within lowermost inner rungs for permitting the inner sections 14, 42 to slide out of the respective outer sections 16, 44 to change the climbable length of the ladder 10.

The top pinch lock 62 may have a similar or the same configuration as the sliding hinge lock assembly 113 of the lockable hinge assembly 110 described previously. In addition, the lower pinch locks 70 may have a similar or the same configuration as the rail lock assembly 240 described previously.

As noted above, the top pinch lock 62 is typically disposed to be accessible from the front section 12 side of the multi-position ladder 10. When the top pinch lock 62 is actuated by pinching the handles together, the rear section 40 can be moved relative to the front section 12. For instance, the rear section 40 may be moved towards the front section 12 to move the multi-position ladder 10 into the leaning mode described above, in which the rear and front sections 40, 12 are parallel and, in some configurations, abutting one another. In another example, the top pinch lock 62 may be actuated so that the rear section 40 may be rotated away from the front section 12. For instance, in some configurations, the rear section 40 can be rotated to be substantially in line with the front section 12 such that they are parallel but not generally adjacent one another, such as in the straight or extended straight modes In the straight or extended straight modes, for example, the rear section 40 may be substantially in line with the front section 12 such that the rear section 40 extends at an angle within 5-10° of the front section 12.

Further, to achieve certain lengths, configurations, and/or modes for the multi-position ladder 10, the lower pinch lock 70 may be utilized to extend the front inner section 14 and the rear inner section 42, independent from one another. For example, to achieve the uneven mode described above, either the front section 12 or the rear section 40 can be extended further than the other section. Additionally, to achieve the full length for the stepladder/A-frame mode and the extended straight mode, the front inner section 14 and rear section 40 may be extended by actuating the lower pinch lock 70 disposed on the lowermost inner rung of each section and sliding the front inner section 14 and rear inner section 42 respectively partially out from the front outer section 16 and the rear outer section 44. As the front inner section 14 and rear inner section 42 are extended respectively out from the front outer section 16 and the rear outer section 44, the lower pinch locks 70 move with the front inner section 14 and the rear inner section 42.

The top pinch lock 62 and the lower pinch lock 70 are typically actuated from an engaged, secure, locked, or unactuated position to a disengaged, unlocked, or actuated position. In the disengaged position, the components of the pinch lock are actuated and allow the various components of the multi-position ladder 10 to move relative to one another. In the engaged or unactuated position, the pinch locks do not permit movement of the various components of the multi-position ladder 10. In this way, the unactuated position includes the sections being secured relative to one another, ensuring the multi-position ladder 10 is safe to climb.

With reference to FIGS. 84-86C, in some embodiments, the multi-position ladder 10 (or other multi-position ladders described herein) further includes at least one brace coupled to outer surfaces of the ladder 10. For instance, in some approaches, at least one front brace 64 is coupled to at least one outer surface of the front outer section 16. In an illustrative embodiment, there are first and second front braces 64 coupled to outer surfaces of the front outer section 16. In some approaches, at least one rear brace 66 is coupled to at least one outer surface of the rear outer section 44. In an illustrative embodiment, there are first and second rear braces 66 coupled to outer surfaces of the rear outer section 44. The first and second front braces 64 and/or the first and second rear braces 66 may be disposed generally adjacent an uppermost end of the front outer section 16 and the rear outer section 44, respectively. For instance, the first and second front braces 64 and the first and second rear braces 66 may be disposed adjacent an uppermost outer rung 28, 56, respectively of the front outer section 16 and the rear outer section 44. The first and second front rear braces 64 and the first and second rear braces 66 may be configured to provide rigidity and stability to the multi-position ladder 10. For example, the first and second front braces 64 and the first and second rear braces 66 may prevent twisting or bending of the various sections of the multi-position ladder 10.

With reference to FIG. 85, an exemplary rear brace 66 is shown. The rear brace 66 includes an upper end 33, a lower end 31, and a coupling opening 35. The rear brace 66 may be coupled to the first outer rear rail 52 or the second outer rear rail 54 of the rear outer section 44 via one or more of rivets, mechanical fasteners, a friction fit between the elements, and/or adhesives. In some embodiments, the first and second outer rear rails 52, 54 include a corresponding protrusion which friction fits into the opening 35 to secure the coupling of the rear brace 66 to the first or second outer rear rail 52, 54. The front brace 64 may be configured similarly.

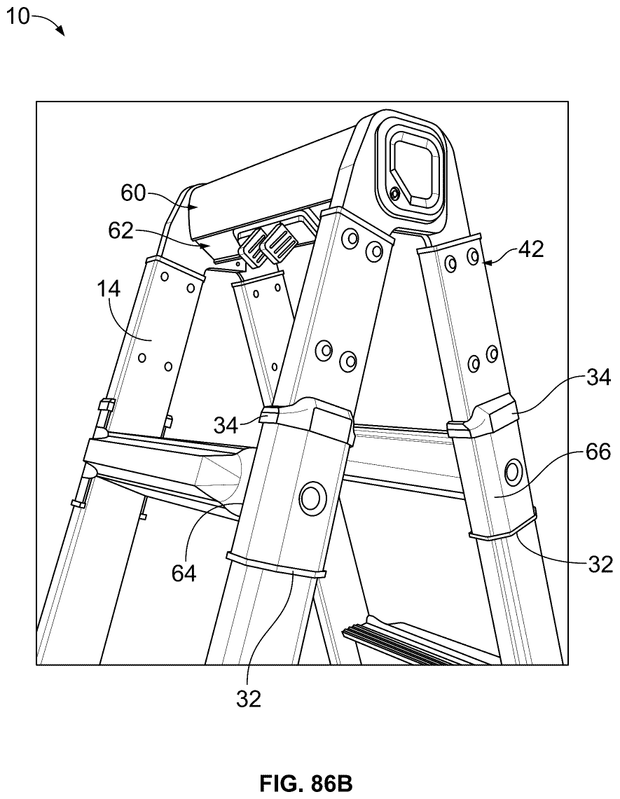

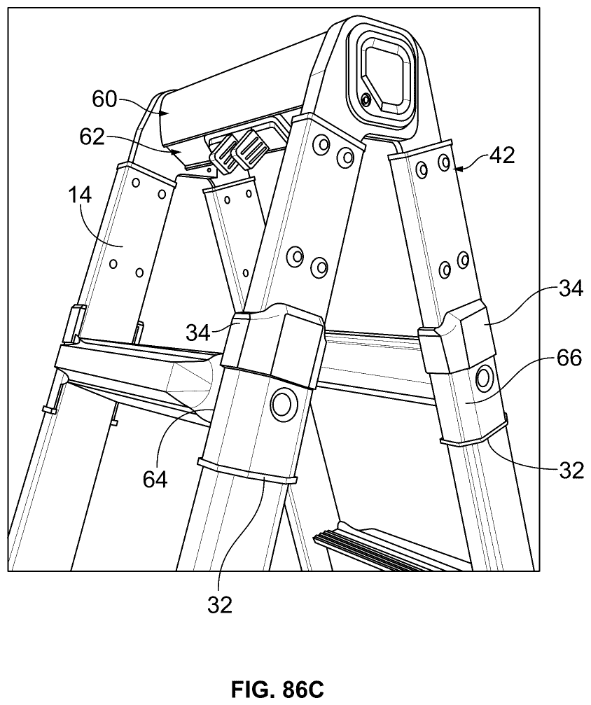

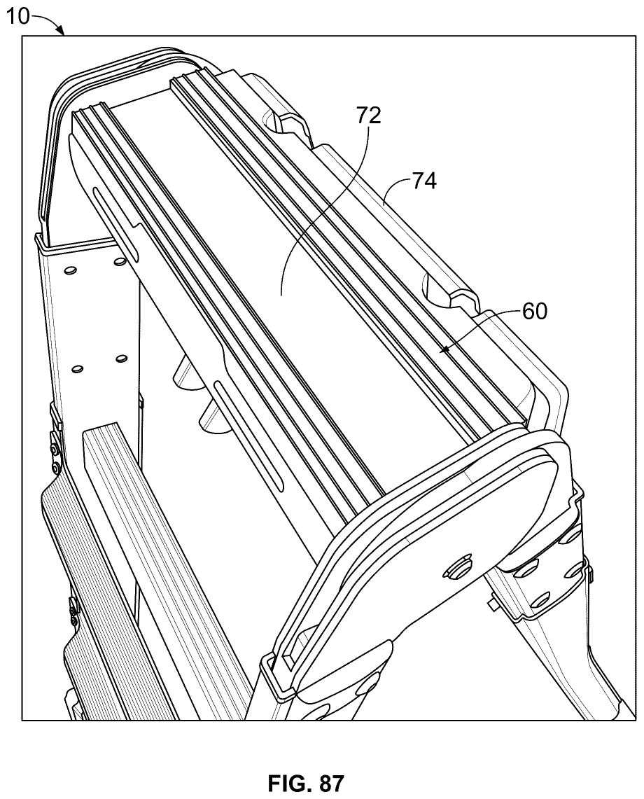

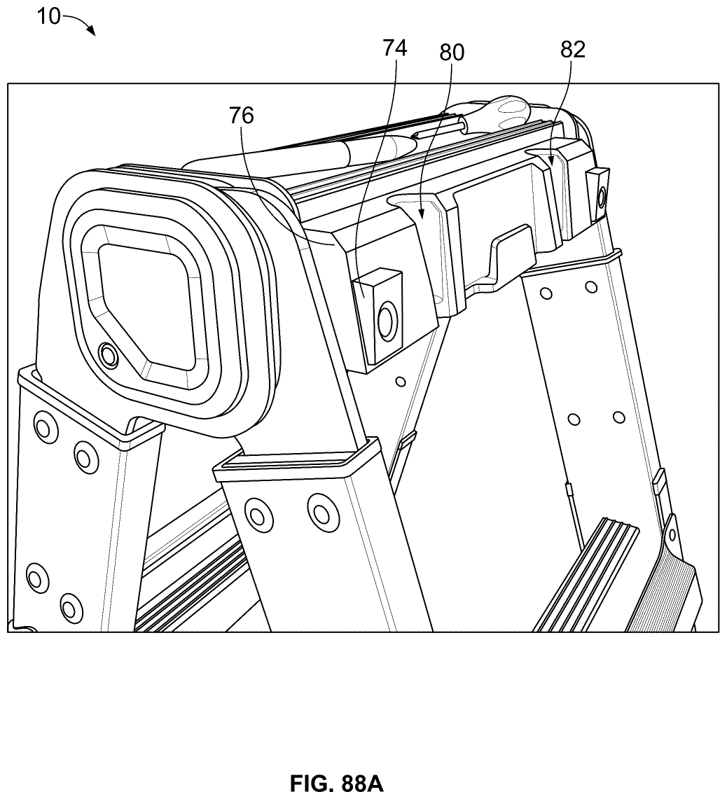

In some embodiments, such as those shown in FIGS. 86A to 86C, the first and second front braces 64 and the first and second rear braces 66 include upper caps 34 disposed adjacent the upper ends 33 of the braces. The first and second front braces 64 and the first and second rear braces 66 may further include lower caps 32 disposed adjacent the lower ends 31 of the braces. The upper caps 34 and the lower caps 32 may be coupled to the braces via one or more of a friction fit, rivets, mechanical fasteners, a friction fit between the geometry of the elements, and/or adhesives, among others. By one approach, the lower caps 32 and upper caps 34 at least partially cover the gaps between the inner rails and outer rails and between the braces 64, 66 and the outer rails of the multi-position ladder 10.

In this way, pinch points between the rails can be reduced or removed. This reduces the risk of a user getting their fingers, or a portion of their clothing, pressed or caught between portions of the ladder. Additionally, by at least partially covering the gap between the inner rails and the outer rails with the upper caps 34 and at least partially covering the gap between the braces 64, 66 and the outer rails with the lower caps 32, debris can be at least partially prevented from getting in between the rails and causing increased friction, grinding of the rails, binding, and corrosion.

Referring to FIG. 87, in some configurations, the multi-position ladder 10 includes a top step 60 having a trough 72 or recess disposed within a portion of the uppermost surface of the top step 60. The trough 72 is configured to retain items placed therein. The trough 72 may have various dimensions. For example, in one illustrative embodiment, the trough 72 may extend a full length of the top step 60 between the rails and approximately half of the rung width, measured as the width of the rung from the front section side to the rear section side. In this way, the remaining portion of the rung width can include treading, such as raised vanes running substantially parallel to the trough 72. While FIG. 4 depicts a trough in the top step, in other configurations, the top step may have other aspects such as, e.g., textured surfaces, dividers, openings, slots, among other features.

In some embodiments, the trough 72 includes a divider to divide the length of the trough 72, forming different and multiple compartments therein. In this way, each compartment or section of the trough 72 may include different features to increase the utility of the trough 72. For example, the trough 72, or the compartments formed thereof, may include a textured lower surface or a magnetized surface to reduce the movement of items placed in the trough 72 or the compartments thereof.

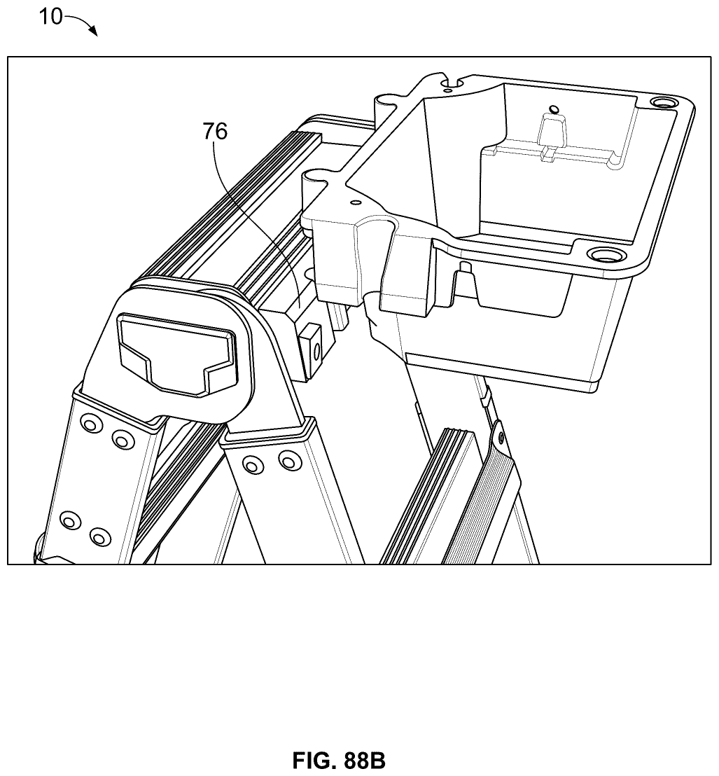

With reference to FIGS. 87-88B, the top step 60 also may include a pad 74 disposed on a surface of the top step 60 or adjacent the top step 60. The pad 74 is advantageous when the multi-position ladder 10 is leaned against a surface, for example in the leaning mode described above. In some embodiments, the pad 74 is disposed on the rear section side of the top step 60. The pad 74 may, in some approaches, have a wedge-shaped cross section. The pad 74 may be secured or coupled to the top step 60 via at least one of rivets, other mechanical fasteners, glue, a friction fit of the geometry, and/or other adhesives. When the multi-position ladder 10 is leaned against a surface, the pad 74 reduces scuffing, marring, and other potential physical damage to the surface.

In some approaches, the multi-position ladder 10 includes a polymer or plastic extension member 76. The plastic extension member 76 may be disposed on the rear section side of the top step 60 (and, thus, may be considered a rear extension). The plastic extension member 76 may, in some embodiments, include one or more slots, such as a first slot 80 and a second slot 82. These slots may be configured to receive a portion of an accessory to removably couple the accessory to the plastic extension member 76, and in turn, to the multi-position ladder 10. In some configurations, the pad 74 is disposed on a rear surface of the plastic extension member 76. In this way, the multi-position ladder 10 with the plastic extension member 76 can be used in the leaning mode. The plastic extension member 76 may include one or more depressions to receive one or more pads 74.

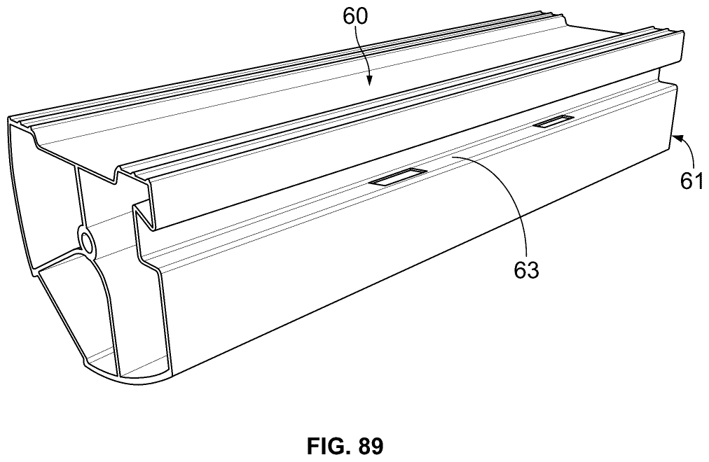

The plastic extension member 76 may be coupled to the top step 60 via rivets, mechanical fasteners, friction fit geometry, and/or adhesives. In one embodiment, as shown in FIG. 89, the plastic extension member 76 may be coupled to the top step 60 via corresponding geometry of the top step 60 and the plastic extension member 76. For instance, in one example, the top step 60 includes a rear surface 61 with an opening 63 (e.g., such as a slot) to receive a coupling portion of the plastic extension member 76. The opening 63 and the coupling portion of the plastic extension member 76 may have a dovetail engagement to secure and couple the plastic extension member 76 to the top step 60. In some approaches, the top step 60 may include one or more of any of the features described herein for top step 115 and plastic extension member 76 may include one or more of any of the features as described above for utility brackets 116 and 316.

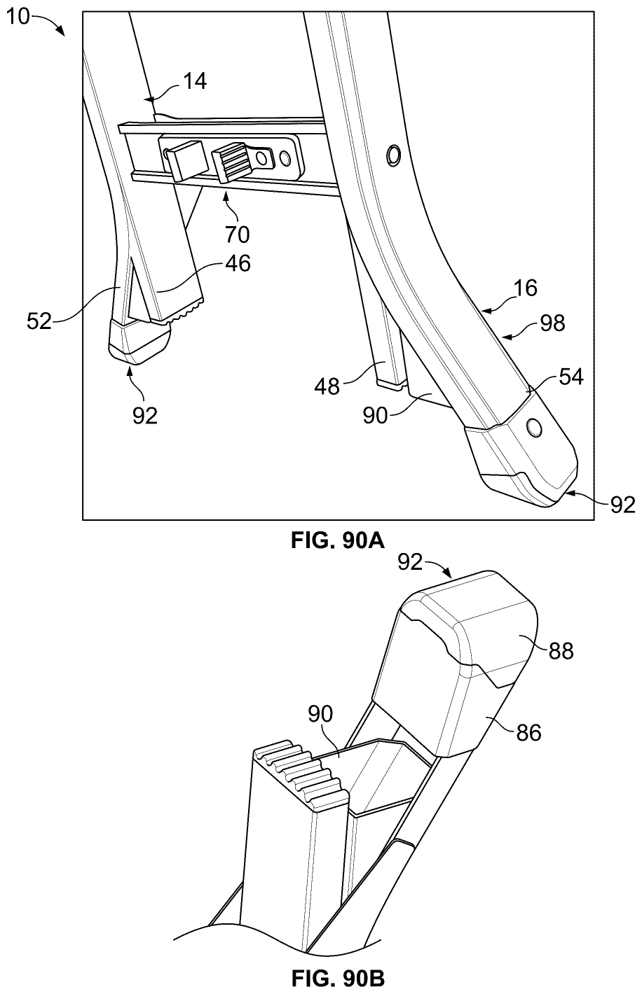

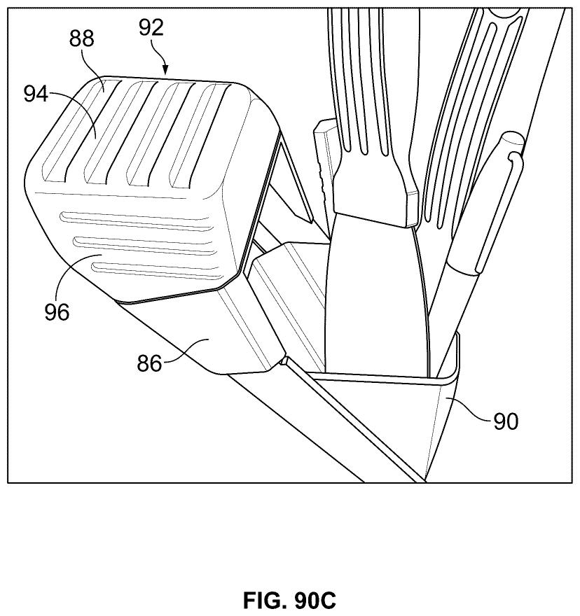

Referring to FIGS. 90A to 90C, the multi-position ladder 10 may include one or more storage cups 90 or storage members. A storage cup 90, in some configurations, may be coupled to a lowermost surface, such as a lowermost inner surface of each outer rail 52, 54 of the front outer section 16), just above the ladder feet 92. The storage cup 90 may be oriented on each outer rail 52, 54 so that it is upside down (i.e., with a mouth of the cup facing downward) when the feet 92 of the front outer section 16 are engaging the ground, as illustrated in FIG. 90A. Such storage cups 90 may also be positioned similarly on each outer rail of the rear outer section 44 (FIG. 84). With this upside down positioning, the storage cup 90 provides a place for a user to dispose various items while the multi-position ladder 10 is being used in the straight or extended straight modes. For instance, in the straight or extended straight modes, lowermost portions of the outer rails of the rear outer section 44 or of the front outer section 16 extend in an inverted position above the ground, defining a top portion of the ladder in these modes. When the rear outer section 44 or the front outer section 16 is in this inverted positioning, the respective storage cups 90 are consequently in an upright position and able to retain items, as illustrated in FIGS. 90B and 90C. Thus, extra storage space is provided at the top of the ladder in the straight or extended straight modes.

The storage cup 90, in some embodiments, may be formed from a plastic material and coupled to the outer rail via one or more of rivets, mechanical fasteners, friction fit geometry, and/or adhesives.

The storage cup 90, in some embodiments, includes a geometry that substantially corresponds to a gap between a lower end of an outer rail 52, 54 and a lower end of a corresponding inner rail 46, 48 of the inner section 14 when the inner rail 46, 48 is fully retracted with respect to the outer rail 52, 54. In this way, the storage cup 90 may be used to aid in properly seating and centering the inner rail 46, 48 with respect to the outer rail 52, 54 when the inner rail 46, 48 is fully retracted. The storage cup 90 may include a raised lip or edge to contact a portion of the inner rail 46, 48. These same configurations may be present on the rear outer section 44 (FIG. 84).

With reference to FIGS. 90A to 90C, the multi-position ladder 10 may include a plurality of feet 92 coupled to the lower ends 98 of the outer rails 52, 54 of the front outer section 16. While the feet 92 of the front outer section 16 are shown and described below, it will be appreciated that feet 92 of the rear outer section 44 (FIG. 84) may have the same or a similar configuration.

The feet 92 may, in some configurations, include a two-piece construction. For example, a plastic shell 86 may be coupled to the outer rail and a rubber cover 88 may be disposed over a lower or distal portion of the plastic shell 86. The feet 92 may be coupled to the outer rails 52, 54 via one or more of rivets, mechanical fasteners, or adhesives. As shown in FIG. 90C, the feet 92 may include a plurality of grooves or treading 94 and 96. For instance, the grooves 94, 96 may be disposed on the rubber covers 88 of the feet 92. The grooves 94 and 96 may be in the same or opposing directions. In one illustrative example, grooves 94 on a bottom of the rubber cover 88 are disposed in one direction, while grooves 96 on one or more outer side surfaces of the rubber cover 88 are disposed in a different direction. In some approaches, at least three surfaces, for instance, a bottom surface and two side outer surfaces of the feet 92 (or, more particularly, the rubber covers 88 of the feet 92), may include grooves 94 and/or 96.

The ladders, components, and/or accessories described herein may be formed of a variety of materials and using a variety of manufacturing techniques. Such materials may include, e.g., metals, plastics and other polymers, and/or composite materials. In addition, some portions of the ladder's components may be formed of one material and one or more other components or accessories may be formed of another similar, or entirely distinct material. In some configurations, the rails of the ladders may be formed of composite material such as fiberglass or fiberglass reinforced plastic (FRP) and may be manufactured via a pultrusion process. FRP materials may include various plastic resins, such as polyurethane or polyethylene, or may include various glass materials. It is contemplated that adjusting the FRP formula to use different material combinations may reduce material weight and/or cost. The rails may also be formed of a metal material such as aluminum or aluminum alloys and manufactured via an extrusion process. After extrusion or pultrusion, the ladder rails are typically cut to length. For box-shaped rails, a computerized numerical control (CNC) machine may machine or form one or more holes in the rails. For rails of other shapes, such as C-shaped or I-beam shaped rails, other tools such as a punch press may be leveraged to punch one or more holes into the rails.

The rungs of the ladders may be formed of composite materials such as fiberglass or carbon fiber. In some approaches, the rungs may also be formed of metal materials such as magnesium, magnesium alloys, aluminum, or aluminum alloys. The rungs may be manufactured, for example, via an extrusion process and cut to length. The rungs may take a variety of shapes and may be, for example, rounded, D-shaped, I-shaped or triangular. Further, the rungs may have a hollow or substantially hollow cross-section.

The rungs of a ladder may be attached to the rails in a variety of different manners. In one approach, the rungs and rails are forged together, such as by having the rungs being attached to the rails via a direct swage connection. In a direct swage connection, a rung is attached directly to the rails using a cold forming process, where a moving die shapes the rung around a hole that was pre-punched in the rail. Annealing operations may be used to soften the metal to prevent cracking. In other approaches, the rungs are attached to the rails via a rung-plate connection or welding, in addition to other attachment types. In a rung-plate connection, a rung is attached to a plate and the plate is attached to the rail via one or more rivets or other mechanical elements.

Other accessories and assemblies employed in the ladder, such as feet, locks, ropes, rope pullies, end caps, and/or knee braces may be made of materials such as rubber or plastics like polypropylene or any other suitable plastics. Plastic parts may be injection molded or insert molded. In some approaches, accessories and assemblies such as guide brackets, feet, knee braces, and/or locks, may be formed, extruded or stamped, from metal materials such as aluminum, aluminum alloys, or steel. Rubber feet may be riveted to a base of the ladder. Metal locks may be extruded and then cut to length. Rope pulleys may include extruded metal side portions and plastic round pulleys formed of injection molded plastic, with the side portions and pulley held together by a rivet. End caps may be riveted or snap fit to the ladder during assembly. Similarly, knee caps may be riveted to the ladder.

It will be understood that various changes in the details, materials, and arrangements of parts and components which have been described and illustrated above to explain the nature of the ladders and ladder components may be made by those skilled in the art within the principle and scope of the anchor device as expressed in the following claims. Furthermore, while various features have been described regarding a particular embodiment or a particular approach, the foregoing description and accompanying drawings is offered by way of illustration only and not as a limitation. Further, while embodiments have been shown and described, it will be apparent to those skilled in the art that modifications may be made to them without departing from the broader aspects of the technological contribution. The actual scope of the protection sought is defined in the following claims.

1. A multi-position ladder comprising:
a first ladder section having a first rail, a second rail, and at least one rung connecting the first and second rails;
a second ladder section having a third rail, a fourth rail, and at least one rung connecting the third and fourth rails;
a first hinge between the first rail and the third rail and a second hinge between the second rail and the fourth rail, the first hinge and the second hinge permitting relative rotation between the first ladder section and the second ladder section to change a position of the ladder; and
a step extending between the first hinge and the second hinge, the step comprising:
a metal housing comprising:
a top wall with treading defining a stepping surface, a bottom wall, a first side wall, and a second side wall opposite the first side wall;
a first open end, a second open end, and a channel extending through the housing between the first open end and the second open end; and
a dividing wall within the channel dividing the channel into a first compartment between the dividing wall and the first side wall and a second compartment between the dividing wall and the second side wall, the first and second compartments extending between the first open end and the second open end;
a hinge lock assembly in the second compartment actuatable between a first locked state in which relative rotation between the first ladder section and second ladder section is inhibited and a second unlocked state permitting relative rotation between the first ladder section and the second ladder section; and
an elongated bracket coupled to an exterior surface of the first side wall, the elongated bracket including a top surface with a plurality of compartments for holding items.

2. The multi-position ladder of claim 1, wherein the housing includes a plurality of bosses within the channel sized to receive fasteners to fasten the first open end of the housing to the first hinge and the second open end of the housing to the second hinge.

3. The multi-position ladder of claim 1, wherein a first pivot of the first hinge is coupled to the dividing wall at the first open end and a second pivot of the second hinge is coupled to the dividing wall at the second open end.

4. The multi-position ladder of claim 1, wherein the hinge lock assembly includes a first locking pin adjacent the first open end of the housing and a second locking pin adjacent the second open end of the housing, wherein the first locking pin and the second locking pin are contained at least in part within an elongated guide channel disposed in the second compartment.

5. The multi-position ladder of claim 1, wherein a portion of the second compartment extends below a bottom of the first compartment.

6. The multi-position ladder of claim 1, wherein the second side wall defines a curved exterior surface.

7. The multi-position ladder of claim 1, wherein the elongated bracket is plastic.

8. The multi-position ladder of claim 1, wherein the elongated bracket includes a rear surface coupled to the exterior surface of the first side wall, the rear surface including at least one recess, the at least one recess and the first side wall defining at least one slot therebetween for receiving a tool.

9. The multi-position ladder of claim 1, wherein the elongated bracket includes a front wall extending downwardly from the top surface, the front wall including at least one depression and a pad disposed at least in part within the depression.

10. A ladder rung comprising:
a central web extending from a first end of the rung to a second side of the rung, the central web defining first and second opposing surfaces that are substantially flat;
a first step integrally formed with and extending along a top edge of the central web at a non-perpendicular angle relative to the central web; and
a second step integrally formed with and extending along a bottom edge of the central web at a non-perpendicular angle relative to the central web,
wherein the central web bisects the first step and the second step, and
the first step and the second step comprise treading.

11. The ladder rung of claim 10, wherein the first step is defined in part by a rectangular plate having a first side edge extending from the first end of the rung to the second end of the rung and a second edge opposite the first edge extending from the first end of the rung to the second end of the rung, and wherein a first flange extends from the first edge towards the second step and a second flange extends from the second edge towards the second step.

12. The ladder rung of claim 11, wherein the first flange extends along an entirety of the first side edge and has a first protruding portion extending axially past the first side edge at the first side of the rung and a second protruding portion extending axially past the first side edge at the second side of the rung; and
the second flange extends along an entirety of the second side edge and has a third protruding portion extending axially past the second side edge at the first side of the rung and a fourth protruding portion extending axially past the second side edge at the second side of the rung.

13. The ladder rung of claim 11, wherein the central web has a first web end at the first end of the rung and a second web end at the second end of the rung, a first projection extending axially from the first web end and a second projection extending axially from the second web end.

14. The ladder rung of claim 13, wherein the first projection and the second projection extend axially past the first step and the second step.

15. A multi-position ladder with the ladder rung of claim 11, the multi-position ladder comprising:
a first ladder section having a first rail, a second rail, and a first plurality of first rungs extending between the first rail and the second rail;
a second ladder section having a third rail, a fourth rail, and a plurality of second rungs extending between the third rail and the fourth rail, wherein at least one of the plurality of second rungs comprises the ladder rung of claim 11;
a third ladder section having a fifth rail, a sixth rail, and a plurality of third rungs extending between the fifth rail and the sixth rail;
a fourth ladder section having a seventh rail, an eighth rail, and a plurality of fourth rungs extending between the seventh rail and the eighth rail, wherein at least one of the plurality of fourth rungs comprises another of the ladder rung of claim 11; and
at least one hinge between the second ladder section and the fourth ladder section permitting the first and second ladder sections to rotate relative to the third and fourth ladder sections,
wherein the first rail and the second rail are outer rails and the third rail and the fourth rail are inner rails, the third rail extending within the first rail and the fourth rail extending within the second rail such that the first section and the second section are slidable relative to one another to adjust a height of the ladder, and
wherein the fifth rail and the sixth rail are outer rails and the seventh rail and the eighth rail are inner rails, the seventh rail extending within the fifth rail and the eighth rail extending within the sixth rail such that the third section and the fourth section are slidable relative to one another to adjust a height of the ladder.

16. The multi-position ladder of claim 15, wherein a bottommost rung of the second ladder section comprises:
a first web extending from a first end of the bottommost rung to a second end of the bottommost rung;
a second web coplanar with the first web and extending from the first end of the bottommost rung to the second end of the bottommost rung;
a channel between the first web and the second web and protruding outwardly from the first web and the second web, the channel extending from the first end of the bottommost rung to the second end of the bottommost rung and housing a rail lock assembly to lock and unlock the second ladder section relative to the first ladder section;
a first step integrally formed with and extending along a top edge of the first web at a non-perpendicular angle relative to the first web; and
a second step integrally formed with and extending along a bottom edge of the second web at a non-perpendicular angle relative to the second web,
wherein the first web bisects the first step and the second web bisects the second step.

17. A ladder comprising:
a first ladder section and a second ladder section, each ladder section having first and second rails in parallel to one another and at least one rung connecting the first and second rails; and
a pivot assembly connecting the first and second ladder sections and permitting selective rotation of the second ladder section relative to the first ladder section to move the ladder between different positions, the different positions including at least a folded position of the ladder and a straight position of the ladder in which the first ladder section and the second ladder section are at an angle of about 180° relative to one another, the pivot assembly including:
a first hinge, the first hinge comprising:
a first fixed plate fixed to the first rail of the first ladder section,
a second fixed plate fixed to the first rail of the first ladder section,
a first rotational plate fixed to the first rail of the second ladder section, the first rotational plate positioned between the first fixed plate and the second fixed plate and rotatable relative to the first fixed plate and the second plate to move the ladder between the different positions,
a strengthening plate extending in part between the first fixed plate and the second fixed plate, wherein the strengthening plate includes a surface positioned to engage the rotational plate when the rotational plate is moved to the straight position of the ladder and to stop rotation of the rotational plate in a first direction, and to disengage the rotational plate when the rotational plate is rotated in a second direction and out of the straight position of the ladder.

18. The ladder of claim 17, wherein the rotational plate includes a rounded disc portion and a protrusion extending radially outwardly from the rounded disc portion, wherein the surface of the strengthening plate engages the protrusion when the rotational plate is moved to the straight position of the ladder.

19. The ladder of claim 17, wherein the first fixed plate includes a first recess and the second fixed plate includes a second recess, and the strengthening plate is fastened to the first recess and the second recess.

20. The ladder of claim 17, wherein the first fixed plate includes a first hinge portion through which a pivot of the first hinge extends and a first elongated portion extending from the first hinge portion sized to be inserted in the first rail, wherein the strengthening plate is positioned at an interface between the first hinge portion and the first elongated portion.

21-61. (canceled)
